(19) United States
(12) Patent Application Publication
(10) Pub. No.: US 2005/0192182 A1
(43) Pub. Date: Sep. 1, 2005

(54) Herbicidal mixtures based on substituted aryl ketones

(76) Inventors: Dieter Feucht, Monheim (DE); Peter Dahmen, Neuss (DE); Mark Wilhelm Drewes, Langenfeld (DE); Rolf Pontzen, Leichlingen (DE); Dorothee Hoischen, Dusseldorf (DE); Klaus-Helmut Muller, Dusseldorf (DE); Hans-Georg Schwarz, Langenfeld (DE); Stefan Herrmann, Langenfeld (DE); Kristian Kather, Langenfeld (DE); Otto Schallner, Monheim (DE); Toshio Goto, Tochigi (JP); Shinichi Shirakura, Tochigi (JP)

Correspondence Address: BAYER CROPSCIENCE LP;Patent Department, 100 BAYER ROAD, PITTSBURGH, PA, 15205-9741, US

(21) Appl. No.: 10/487,671

(22) PCT Filed: Aug. 19, 2002
(86) PCT No.: PCT/EP02/09243

§ 371 Date: Aug. 16, 2004

(30) Foreign Application Priority Data
Aug. 30, 2001 (DE) 101 42 333.0

(51) Int. Cl. A01N 43/60; A01N 35/00

(52) U.S. Cl. 504/136; 504/118

(57) ABSTRACT

The application relates to compositions comprising
a) at least one of the compounds of the formula (I) 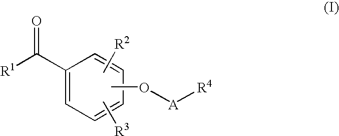
where A, R¹, R², R³ and R⁴ have the meaning given in the description and b) known herbicides as stated in the description and/or c) known safeners as stated in the description, and to their use for controlling undesirable vegetation.

The invention relates to novel herbicidal active compound combinations comprising, firstly, known substituted aryl ketones and, secondly, one or more known herbicidally active compounds and/or a compound which improves crop plant compatibility, which combinations can be used with particularly good results for controlling weeds in various crops of useful plants or else for controlling monocotyledonous and dicotyledonous weeds in the semi- and nonselective field.

Substituted aryl ketones are known as active herbicides (cf. DE-A-10001588, WO-A-99/10328; U.S. Pat. No. 6,207,618, WO-A-01/32636). However, the activity of these compounds is not always entirely satisfactory.

Active compound combinations based on substituted aryl ketones are likewise known (cf. WO-A-00/25584, WO-A-00/74488, WO-A-01/28341). However, the properties of these active compound combinations are likewise not entirely satisfactory.

Surprisingly, it has now been found that a number of active compounds from the group of the substituted aryl ketones, when used together with certain herbicidally active compounds, show synergistic effects with respect to the activity against weeds and/or, when used together with certain compounds which improve crop plant compatibility, can be used particularly advantageously as broadly active combination preparations for the selective control of monocotyledonous and dicotyledonous weeds in crops of useful plants, such as, for example, in cotton, barley, potatoes, corn, rice, soybeans, sunflowers, wheat and sugar cane, but also for controlling monocotyledonous and dicotyledonous weeds in the semi- and nonselective field.

The invention provides herbicidal compositions, characterized by an effective amount of an active compound combination comprising
(a) at least one substituted aryl ketone of the general formula (I) 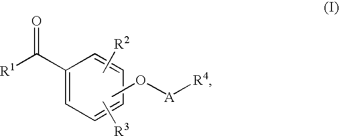
in which
A represents alkanediyl (alkylene) having 1 to 6 carbon atoms,
R¹ represents one of the groupings below 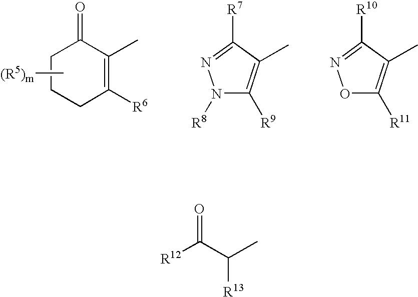
   where
   m represents the numbers 0 to 6,
   R⁵ represents halogen, represents in each case optionally cyano-, halogen- or C₁-C₄-alkoxy-substituted alkyl, alkoxycarbonyl or alkylthio having in each case 1 to 6 carbon atoms in the alkyl groups, or represents optionally halogen-, C₁-C₄-alkyl- or C₁-C₄-alkoxy-substituted phenyl, or—if m represents 2—optionally together with a second radical R⁵ also represents a carbonyl group (C═O) or alkanediyl (alkylene) having 2 to 6 carbon atoms,
   R⁶ represents hydroxyl, formyloxy, halogen, represents in each case. optionally cyano-, halogen- or C₁-C₄-alkoxy-substituted alkoxy, alkylthio, alkylsulfinyl, alkylsulfonyl, alkylcarbonyloxy, alkoxycarbonyloxy, alkylaminocarbonyloxy or alkylsulfonyloxy having in each case 1 to 6 carbon atoms in the alkyl groups, represents in each case optionally cyano- or halogen-substituted alkenyloxy or alkinyloxy having in each case 2 to 6 carbon atoms, or represents in each case optionally nitro-, cyano-, halogen, C₁-C₄-alkyl-, C₁-C₄-halogenoalkyl-, C₁-C₄-alkoxy- or C₁-C₄-halogenoalkoxy-substituted phenoxy, phenylthio, phenylsulfinyl, phenylsulfonyl, phenylcarbonyloxy, phenylcarbonylalkoxy, phenylsulfonyloxy, phenylalkoxy, phenylalkylthio, phenylalkylsulfinyl or phenylalkylsulfonyl having optionally 1 to 4 carbon atoms in the alkyl moiety,
   R⁷ represents hydrogen, cyano, carbamoyl, thiocarbamoyl, halogen, represents in each case optionally cyano-, halogen- or C₁-C₄-alkoxy-substituted alkyl, alkoxy, alkylthio, alkylsulfinyl, alkylsulfonyl or alkoxycarbonyl having in each case 1 to 6 carbon atoms in the alkyl groups, or represents optionally cyano-, halogen- or C₁-C₄-alkyl-substituted cycloalkyl having 3 to 6 carbon atoms,
   R⁸ represents hydrogen, represents optionally cyano-, halogen- or C₁-C₄-alkoxy-substituted alkyl having 1 to 6 carbon atoms, represents in each case optionally cyano- or halogen-substituted alkenyl or alkinyl having in each case 2 to 6 carbon atoms, represents in each case optionally cyano-, halogen- or C₁-C₄-alkyl-substituted cycloalkyl or cycloalkylalkyl having in each case 3 to 6 carbon atoms in the cycloalkyl group and optionally 1 to 4 carbon atoms in the alkyl moiety, or represents in each case optionally nitro-, cyano, halogen-, C₁-C₄-alkyl-, C₁-C₄-halogenoalkyl-, C₁-C₄-alkoxy- or C₁-C₄-halogenoalkoxy-substituted phenyl or phenyl-C₁-C₄-alkyl,
   R⁹ represents hydroxyl, formyloxy, represents in each case optionally cyano-, halogen- or C₁-C₄-alkoxy-substituted alkoxy, alkylcarbonyloxy, alkoxycarbonyloxy, alkylaminocarbonyloxy or alkylsulfonyloxy having in each case 1 to 6 carbon atoms in the alkyl groups, represents in each case optionally cyano- or halogen-substituted alkenyloxy or alkinyloxy having in each case 2 to 6 carbon atoms, represents in each case optionally nitro-, cyano-, halogen-, C₁-C₄-alkyl- or C₁-C₄-halogenoalkyl-substituted phenylalkoxy, phenylcarbonyloxy, phenylcarbonylalkoxy or phenylsulfonyloxy having optionally 1 to 4 carbon atoms in the alkyl moiety,
   R¹⁰ represents hydrogen, cyano, carbamoyl, thiocarbamoyl, halogen or represents in each case optionally cyano-, halogen- or C₁-C₄-alkoxy-substituted alkyl, alkylcarbonyl, alkoxy, alkoxycarbonyl, alkylthio alkylsulfinyl or alkylsulfonyl having in each case 1 to 6 carbon atoms in the alkyl groups,
   R¹¹ represents hydrogen, represents optionally cyano-, halogen- or C₁-C₄-alkoxy-substituted alkyl having 1 to 6 carbon atoms or represents optionally cyano-, halogen- or C₁-C₄-alkyl-substituted cycloalkyl having 3 to 6 carbon atoms,
   R¹² represents hydrogen, represents optionally cyano-, halogen- or C₁-C₄-alkoxy-substituted C₁-C₆-alkyl or represents optionally cyano-, halogen- or C₁-C₄-alkyl-substituted cycloalkyl having 3 to 8 carbon atoms, and
   R¹³ represents hydrogen, cyano, carbamoyl, halogen, or represents in each case optionally represents optionally cyano-, halogen- or C₁-C₄-alkoxy-substituted alkyl, alkoxy, alkoxycarbonyl, alkylthio, alkylsulfinyl or alkylsulfonyl having in each case 1 to 6 carbon atoms in the alkyl groups,
R² represents hydrogen, nitro, cyano, carboxyl, carbamoyl, thiocarbamoyl, halogen, or represents in each case optionally cyano-, halogen- or C₁-C₄-alkoxy-, C₁-C₄-alkylthio-, C₁-C₄-alkylsulfinyl- or C₁-C₄-alkylsulfonyl-substituted alkyl, alkoxy, alkylthio, alkylsulfinyl, alkylsulfonyl, alkylamino, dialkylamino or dialkylaminosulfonyl having in each case 1 to 6 carbon atoms in the alkyl groups,
R³ represents hydrogen, nitro, cyano, carboxyl, carbamoyl, thiocarbamoyl, halogen, or represents in each case optionally cyano-, halogen- or C₁-C₄-alkoxy-, C₁-C₄-alkylthio-, C₁-C₄-alkylsulfinyl- or C₁-C₄-alkylsulfonyl-substituted alkyl, alkoxy, alkylthio, alkylsulfinyl, alkylsulfonyl, alkylamino, dialkylamino or dialkylaminosulfonyl having in each case 1 to 6 carbon atoms in the alkyl groups, and
R⁴ represents an optionally substituted 4- to 12-membered saturated or unsaturated monocyclic or bicyclic heterocyclic grouping which contains 1 to 4 heteroatoms, up to 4 of which are nitrogen atoms, and optionally—alternatively or additionally—1 to 3 oxygen atoms, sulfur atoms, —SO— groups, —SO₂— groups, —CO— groups and/or —CS— groups,
   including all possible tautomeric forms of the compounds of the general formula (I) and the possible salts or acid or base adducts of the compounds of the general formula (I)-
   (“active compounds of group 1”)
      and
(b) one or more compounds from a second group of herbicides comprising the active compounds listed below:
4-(2-chloro-phenyl)-N-cyclohexyl-N-ethyl-4,5-dihydro-5-oxo-1H-tetrazole-1-carboxamide (fentrazamide), N-(4-fluoro-phenyl)-N-i-propyl-2-(5-trifluoromethyl-1,3,4-thiadiazol-2-yl-oxy)-acetamide (flufenacet), 2-chloro-N-(ethoxymethyl)-N-(2-ethyl-6-methyl-phenyl)-acetamide (acetochlor), 5-(2-chloro-4-trifluoromethyl-phenoxy)-2-nitro-benzoic acid sodium salt (acifluorfen-sodium), 2-chloro-6-nitro-3-phenoxy-benzeneamine (aclonifen), 2-chloro-N-(methoxymethyl)-N-(2,6-diethyl-phenyl)-acetamide (alachlor), N-ethyl-N′-i-propyl-6-methylthio-1,3,5-triazine-2,4-diamine (ametryn), 4-amino-N-(1,1-dimethyl-ethyl)-4,5-dihydro-3-(1-methyl-ethyl)-5-oxo-1H-1,2,4-triazole-1-carboxamide (amicarbazone), N-(4,6-dimethoxy-pyrimidin-2-yl)-N′-(N-methyl-N-methylsulfonyl-sulfamoyl)-urea (amidosulfuron), 1H-1,2,4-triazol-3-amine (amitrole), S-[2-[(4-chloro-phenyl)-(1-isopropyl)-amino]-2-oxo-ethyl]O,O-dimethyl phosphorodithioate (anilofos), 6-chloro-4-ethylamino-2-isopropylamino-1,3,5-triazine (atrazin), 2-[2,4-dichloro-5-(2-propinyloxy)-phenyl]-5,6,7,8-tetrahydro-1,2,4-triazolo-[4,3-a]-pyridin-3(2H)-one (azafenidin), N-(4,6-dimethoxy-pyriridin-2-yl)-N′-[1-methyl-4-(2-methyl-2H-tetrazol-5-yl)-1H-pyrazol-5-ylsulfonyl]-urea (azimsulfuron), N-benzyl-2-(4-fluoro-3-trifluoromethyl-phenoxy)-butanamide (beflubutamid), 4-chloro-2-oxo-3(2H)-benzothiazoleacetic acid (benazolin), N-butyl-N-ethyl-2,6-dinitro-4-trifluoromethyl-benzeneamine (benfluralin), 2,3-dihydro-3,3-dimethyl-5-benzofuranyl-ethanesulfonate (benfuresate), N-(4,6-dimethoxy-pyrimidin-2-yl)-N′-(2-methoxycarbonyl-phenylmethylsulfonyl)-urea (bensulfuron-methyl), S-[(4-chloro-phenyl)-methyl]diethylthiocarbamate (benthiocarb, thiobencarb), methyl 2-[2-[4-(3,6-dihydro-3-methyl-2,6-dioxo-4-trifluoromethyl-1(2H)-pyrimidinylphenoxymethyl]-5-ethyl-phenoxy-propanoate (benzfendizone), 3-(2-chloro-4-methylsulfonyl-benzoyl)-4-phenylthio-bicyclo-[3.2.1]-oct-3-en-2-one (benzobicyclon), 2-[[4-(2,4-dichloro-3-methyl-benzoyl)-1,3-dimethyl-1H-pyrazol-5-yl]-oxy]-1-(4-methyl-phenyl)-ethanone (benzofenap), ethyl N-benzoyl-N-(3,4-dichloro-phenyl)-DL-alaninate (benzoylprop-ethyl), 3-i-propyl-1H-2,1,3-benzo-thiadiazin-4(3H)-one (bentazon), methyl 5-(2,4-dichloro-phenoxy)-2-nitro-benzoate (bifenox), 2,6-bis-(4,6-dimethoxy-pyrimidin-2-yl-oxy)-benzoic acid sodium salt (bispyribac-sodium), 5-bromo-6-methyl-3-(1-methyl-propyl)-2,4(1H,3H)-pyrimidinedione (bromacil), 2-bromo-3,3-dimethyl-N-(1-methyl-1-phenyl-ethyl)-butanamide (bromobutide), 3,5-dibromo-4-hydroxy-benzaldehyde O-(2,4-dinitro-phenyl)-oxime (bromofenoxim), 3,5-dibromo-4-hydroxy-benzonitrile (bromoxynil), N-butoxymethyl-2-chloro-N-(2,6-diethyl-phenyl)-acetamide (butachlor), [1,1-dimethyl-2-oxo-2-(2-propenyloxy)]-ethyl 2-chloro-5-(3,6-dihydro-3-methyl-2,6-dioxo-4-trifluoromethyl-1(2H)-pyrimidinyl)-benzoate (1butafenacil-allyl), O-ethyl O-(5-methyl-2-nitro-phenyl) N-s-butylphosphoramidothioate (butamifos), (Z)-2-chloro-N-[(2-butenyloxy)-methyl]-N-(2,6-diethyl-phenyl)-acetamide (butenachlor), 2-(1-ethoximino-propyl)-3-hydroxy-5-[2,4,6-trimethyl-3-(1-oxo-butyl)-phenyl]-2-cyclohexen-1-one (butroxydim), S-ethyl-bis-(2-methyl-propyl)-thiocarbamate (butylate), N,N-diethyl-3-(2,4,6-trimethyl-phenylsulfonyl)-1H-1,2,4-triazole-1-carboxamide (cafenstrole), 2-[1-[(3-chloro-2-propenyl)-oxy-imino]-propyl]-3-hydroxy-5-(tetrahydro-2H-pyran-4-yl)-2-cyclohexen-1-one (caloxydim, tepraloxydim), 2-(4-chloro-2-fluoro-5-(2-chloro-2-ethoxycarbonyl-ethyl)-phenyl)-4-difluoromethyl-5-methyl-2,4-dihydro-3H-1,2,4-triazol-3-one (carfentrazone-ethyl), 2,4-dichloro-1-(3-methoxy-4-nitro-phenoxy)-benzene (chlomethoxyfen), 3-amino-2,5-dichloro-benzoic acid (chloramben), N-(4-chloro-6-methoxy-pyrimidin-2-yl)-N′-(2-ethoxycarbonyl-phenylsulfonyl)-urea (chlorimuron-ethyl), 1,3,5-trichloro-2-(4-nitro-phenoxy)-benzene (chlornitrofen), N-(4-methoxy-6-methyl-1,3,5-triazin-2-yl)-N′-(2-chloro-phenylsulfonyl)-urea (chlorsulfuron), N′-(3-chloro-4-methyl-phenyl)-N,N-dimethyl-urea (chlortoluron), ethyl 2-chloro-3-[2-chloro-5-(1,3,4,5,6,7-hexahydro-1,3-dioxo-2H-isoindol-2-yl)-phenyl]-2-propanoate (cinidon-ethyl), exo-1-methyl-4-isopropyl-2-(2-methyl-phenyl-methoxy)-7-oxabicyclo-[2.2.1]-heptane (cinmethylin), N-(4,6-dimethoxy-1,3,5-triazin-2-yl)-N′-(2-(2-methoxy-ethoxy)-phenylsulfonyl)-urea (cinosulfuron), 2-[1-[2-(4-chloro-phenoxy)-propoxyaminobutyl]-5-(tetrahydro-2H-thiopyran-3-yl)-1,3-cyclohexanedione (clefoxydim), (E,E)-(+)-2-[1-[[(3-chloro-2-propenyl)-oxy]-imino]-propyl]-3-hydroxy-2-cyclohexen-1-one (clethodim), (R)-(2-propinyl) 2-[4-(5-chloro-3-fluoro-pyridin-2-yl-oxy)-phenoxy-propanoate (clodinafop-propargyl), 2-[(2-chloro-phenyl)-methyl-4,4dimethyl-3-isoxazolidinone (clomazone), 2-(2,4-dichloro-3-methyl-phenoxy)-N-phenyl-propanamide (clomeprop), 3,6-dichloro-pyridine-2-carboxylic acid (clopyralid), methyl 3-chloro-2-[(5-ethoxy-7-fluoro[1,2,4]triazolo[1,5-c]pyrimidin-2-yl-sulfonyl)-amino]-benzoate (cloransulam-methyl), N-[(2-chlorophenyl)-methyl]-N′-(1-methyl-1-phenyl-ethyl)-urea (cumyluron), 2-chloro-4-ethylamino-6-(1-cyano-1-methyl-ethylamino)-1,3,5-triazine (cyanazine), N-(4,6-dimethoxy-pyrimidin-2-yl)-N′-(2-cyclopropylcarbonyl-phenylsulfonyl)-urea (cyclosulfamuron), 2-(1-ethoximinobutyl)-3-hydroxy-5-(tetrahydro-2H-thiopyran-3-yl)-2-cyclohexen-1-one (cycloxydim), (R)-2-butyl [4-(4-cyano-2-fluoro-phenoxy)-phenoxy]-propanoate (cyhalofop-butyl), 2,4-dichloro-phenoxyacetic acid (2,4-D), 3,6-dichloro-2-methoxy-benzoic acid (dicamba), (R)-2-(2,4-Dichloro-phenoxy)-propanoic acid (dichlorprop-P), methyl 2-[4-(2,4-dichloro-phenoxy)-phenoxy]-propanoate (diclofop-methyl), N-(2,6-dichloro-phenyl)-5-ethoxy-7-fluoro-[1,2,4]-triazolo-[1,5-c]-pyrimidine-2-sulfonamide (diclosulam), ethyl N-(chloroacetyl)-N-2,6-(diethyl-phenyl)-glycinate (diethatyl-ethyl), 1,2-dimethyl-3,5-diphenyl-1H-pyrazolium methylsulfate (difenzoquat), N-(2,4-difluoro-phenyl)-2-(3-trifluoromethyl-phenoxy)-pyridine-3-carboxamide (diflufenican), 2-[1-[(3,5-difluoro-phenyl)-amino-carbonyl-hydrazono]-ethyl]-pyridine-3-carboxylic acid (diflufenzopyr), S-(1-methyl-1-phenyl-ethyl)-1-piperidine carbothioate (dimepiperate), 2-chloro-N-(2,6-dimethyl-phenyl)-N-(2-methoxy-ethyl)-acetamide (dimethachlor), N-(1,2-dimethyl-propyl)-N′-ethyl-6-methylthio-1,3,5-triazine-2,4-diamine (dimethametryn), (S-)2-chloro-N-(2,4-dimethyl-3-thienyl)-N-(2-methoxy-1-methyl-ethyl)-acetamide (S-) (dimethenamid), 2-amino-4-(1-fluoro-1-methyl-ethyl)-6-(1-methyl-2-(3,5-dimethyl-phenoxy)-ethylamino)-1,3,5-triazine (dimexyflam), N3,N3-diethyl-2,4-dinitro-6-trifluoromethyl-1,3-diamino-benzene (dinitramine), 6,7-dihydro-dipyrido[1,2-a:2′,1′-c]pyrazinediium (diquat), S,S-dimethyl-2-difluoromethyl-4-i-butyl-6-trifluoromethyl-pyridine-3,5-dicarbothioate (dithiopyr), N′-(3,4-dichloro-phenyl)-N,N-dimethyl-urea (diuron), N-(4-methyl-phenyl)-N′-(1-methyl-1-phenyl-ethyl)-urea (dymron, daimuron, dimuron), S-ethyl dipropylthiocarbamate (EPTC), S-(phenylmethyl)-N-ethyl-N-(1,2-dimethyl-propyl)-thiocarbamate (esprocarb), N-ethyl-N-(2-methyl-2-propenyl)-2,6-dinitro-4-trifluoromethyl-benzeneamine (ethalfluralin), (S)-(2-ethoxy-1-methyl -2-oxoethyl) 2-chloro-5-(2-chloro-4-trifluoromethyl-phenoxy)-benzoate (ethoxyfen), N-(4,6-dimethoxy-pyrimidin-2-yl)-N′-(2-ethoxy-phenoxysulfonyl)-urea (ethoxysulfuron), N-(2,3-dichloro-phenyl)-4-ethoxymethoxy-benzamide (etobenzanid), (R)-ethyl-2-[4-(6-chloro-benzoxazol-2-yl-oxy)-phenoxy]-propanoate (fenoxaprop-(P)-ethyl), isopropyl N-benzoyl-N-(3-chloro-4-fluro-phenyl)-DL-alaninate (flamprop-isopropyl), isopropyl N-benzoyl-N-(3-chloro-4-fluro-phenyl)-L-alaninate (flamprop-isopropyl-L), methyl N-benzoyl-N-(3-chloro-4-fluoro-phenoxy)-DL-alaninate (flamprop-methyl), N-(2,6-difluoro-phenyl)-8-fluoro-5-methoxy-[1,2,4]-triazolo-[1,5-c]-pyrimidine-2-sulfonamide (florasulam), butyl (R)-2-[4-(5-trifluoromethyl-pyridin-2-yl-oxy)-phenoxy]-propanoate (fluazifop, -butyl, -P-butyl), i-propyl 5-(4-bromo-1-methyl-5-trifluoromethyl-1H-pyrazol-3-yl)-2-chloro-4-fluoro-benzoate (fluazolate), 4,5-dihydro-3-methoxy-4-methyl-5-oxo-N-[(2-trifluoromethoxy-phenyl)-sulfonyl]-1-H-1,2,4-triazole-1-carboxamide sodium salt (flucarbazone-sodium), ethyl [2-chloro-4-fluoro-5-(5-methyl-6-oxo4-trifluoromethyl-1(6H)-pyriazinyl)-phenoxy]-acetate (flufenpyr), N-(2,6difluoro-phenyl)-5-methyl-1,2,4-triazolo[ 1,5-a]-pyrimidine-2-sulfonamide (flumetsulam), pentyl [2-chloro-4-fluoro-5-(1,3,4,5,6,7-hexahydro-1,3-dioxo-2H-isoindol-2-yl)-phenoxy]-acetate (flumiclorac-pentyl), 2-[7-fluoro-3,4-dihydro-3-oxo-4-(2-propinyl)-2H-1,4-benzoxazin-6-yl]-4,5,6,7-tetrahydro-1H-isoindole-1,3-dione (flumioxazin), 2-[4-chloro-2-fluoro-5-[(1-methyl-2-propinyl)-oxy]-phenyl]-4,5,6,7-tetrahydro-1H-isoindole-1,3(2H)-dione (flumipropyn), 3-chloro-4-chloromethyl-1-(3-trifluoromethyl-phenyl)-2-pyrrolidinone (fluorochloridone), ethoxycarbonylmethyl 5-(2-chloro-4-trifluoromethyl-phenoxy)-2-nitro-benzoate (fluoroglycofen-ethyl), 1-(4-chloro-3-(2,2,3,3,3-pentafluoro-propoxymethyl)-phenyl)-5-phenyl-1H-1,2,4-triazol-3-carboxamide (flupoxam), 1-isopropyl-2-chloro-5-(3,6-dihydro-3-methyl-2,6-dioxo-4-trifluoromethyl-1(2H)-pyrimidyl)-benzoate (flupropacil), N-(4,6-dimethoxy-pyrimidin-2-yl)-N′-(3-methoxycarbonyl-6-trifluoromethyl-pyridin-2-yl-sulfonyl)-urea sodium salt (flupyrsulfuron-methyl-sodium), 9-hydroxy-9H-fluorene-9-carboxylic acid (flurenol), (4-amino-3,5-dichloro-6-fluoro-pyridin-2-yl-oxy)-acetic acid (-2-butoxy-1-methyl-ethyl ester, -1-methyl-heptyl ester) (fluroxypyr, -butoxypropyl, -meptyl), 5-methylamino-2-phenyl-4-(3-trifluoromethyl-phenyl)-3(2H)-furanone (flurtamone), methyl-[(2-chloro-4-fluoro-5-(tetrahydro-3-oxo-1H,3H-[1,3,4]-thiadiazolo-[3,4-a]-pyridazin-1-ylidene)-amino-phenyl]-thio-acetate (fluthiacet-methyl), 5-(2-chloro-4-trifluoromethyl-phenoxy)-N-methylsulfonyl-2-nitro-benzamide (fomesafen), 2-[[[[(4,6-dimethoxy-2-pyrimidinyl)-amino]-carbonyl]-amino]-sulfonyl]-4-formylamino-N,N-dimethyl-benzamide (foramsulfuron), 2-amino-4-(hydroxymethylphosphinyl)-butanoic acid (-ammonium salt) (glufosinate (-ammonium)), N-phosphonomethyl-glycine (-isopropylammonium salt), (glyphosate, -isopropylammonium), methyl 3-chloro-5-[[[[(4,6-dimethoxy-2-pyrimidinyl)-amino]-carbonyl]-amino]-sulfonyl]-1-methyl-1H-pyrazole-4-carboxylate (halosulfuron-methyl), (R)-2-[4-(3-chloro-5-trifluoromethyl-pyridin-2-yl-oxy)-phenoxy]-propanoic acid (-methyl ester, -2-ethoxy-ethyl ester, -butyl ester) (haloxyfop, -methyl, -P-methyl, -ethoxyethyl, -butyl), 3-cyclohexyl-6-dimethylamino-1-methyl-1,3,5-triazine-2,4(1H,3H)-dione (hexazinone), N-(2,4-difluoro-phenyl-1,5-dihydro-N-i-propyl-5-oxo-1-[(tetrahydro-2H-pyran-2-yl)-methyl]-4H-1,2,4-triazole-4-carboxamide (HOK-201-cf. WO-A-98/38176/U.S. Pat. No. 6,077,814), methyl 2-(4,5-dihydro-4-methyl-4-isopropyl-5-oxo-1H-imidazol-2-yl)-4-methyl-benzoate (imazamethabenz-methyl), 2-(4,5-dihydro-4-methyl-4-isopropyl-5-oxo-1H-imidazol-2-yl)-5-methyl-pyridine-3-carboxylic acid (imazamethapyr), 2-(4,5-dihydro-4-methyl-4-isopropyl-5-oxo-1H-imidazol-2-yl)-5-methoxymethyl-pyridine-3-carboxylic acid (imazamox), 2-(4,5-dihydro-4-methyl-4-isopropyl-5-oxo-1H-imidazol-2-yl)-quinoline-3-carboxylic acid (imazaquin), 2-(4,5-dihydro-4-methyl-4-i-propyl-5-oxo-1H-imidazol-2-yl)-5-ethyl-pyridine-3-carboxylic acid (imazethapyr), N-(4,6-dimethoxy-pyrimidin-2-yl)-N′-(2-chloro-imidazo[1,2-a]-pyridin-3-yl-sulfonyl)-urea (imazosulfuron), 2-[2-(3-chloro-phenyl)-oxiranylmethyl]-2-ethyl-1H-indene-1,3(2H)-dione (indanofan), N-(4-methoxy-6-methyl-1,3,5-triazin-2-yl)-N′-(5-iodo-2-methoxycarbonyl-phenylsulfonyl)-urea sodium salt (iodosulfuron-methyl-soditim), 4-hydroxy-3,5-diiodo-benzonitrile (ioxynil), N,N-dimethyl-N′-(4-isopropyl-phenyl)-urea (isoproturon), N-(3-(1-ethyl-1-methyl-propyl)-isoxazol-5-yl)-2,6-dimethoxy-benzamide (isoxaben), (4-chloro-2-methylsulfonyl-phenyl)-(5-cyclopropyl-isoxazol-4-yl)-methanone (isoxachlortole), (5-cyclopropyl-isoxazol-4-yl)-(2-methylsulfonyl-4-trifluoromethyl-phenyl)-methanone (isoxaflutole), 2-[2-[4-[3,5-dichloro-2-pyridinyl)-oxy]-phenoxy]-1-oxo-propyl]-isoxazolidine (isoxapyrifop), 2-[(2,3-dihydro-5,8-dimethyl-1,1-dioxido-spiro[4H-1-benzothiopyran-4,2′-[1,3]-dioxolan]-6]yl)-carbonyl]-1,3-cyclohexanedione potassium salt (ketospiradox), (2-ethoxy-1-methyl-2-oxo-ethyl) 5-(2-chloro-4-trifluoromethyl-phenoxy)-2-nitro-benzoate (lactofen), N′-(3,4-dichloro-phenyl)-N-methoxy-N-methyl-urea (linuron), (4-chloro-2-methyl-phenoxy)-acetic acid (MCPA), 4-(4-chloro-2-methyl-phenoxy)-butyric acid (MCPB), 2-(4-chloro-2-methylphenoxy)-propionic acid (mecoprop), 2-(2-benzothiazolyloxy)-N-methyl-N-phenyl-acetamide (mefenacet), methyl 2-[[[[(4,6-dimethoxy-2-pyrimidinyl)-amino]-carbonyl]-amino]-sulfonyl]-4-[[(methylsulfonyl)-amino]methyl]-benzoate (mesosulfuron), 2-(4-methylsulfonyl-2-nitro-benzoyl)-1,3-cyclohexanedione (mesotrione), 4-amino-3-methyl-6-phenyl-1,2,4-triazin-5(4H)-one (metamitron), 2-chloro-N-(2,6-dimethyl-phenyl)-N-(1H-pyrazol-1-yl-methyl)-acetamide (metazachlor), N′-(4-(3,4-dihydro-2-methoxy-2,4,4-trimethyl-2H-1-benzopyran-7-yl-oxy)-phenyl)-N-methoxy-N-methyl-urea (metobenzuron), N′-(4-bromo-phenyl)-N-methoxy-N-methylurea (metobromuron), (S)-2-chloro-N-(2-ethyl-6-methyl-phenyl)-N-(2-methoxy-1-methyl-ethyl)-acet-amide (metolachlor, S-metolachlor), N-(2,6-dichloro-3-methyl-phenyl)-5,7-dimethoxy-1,2,4-triazolo[1,5-a]-pyrimidine-2-sulfonamide (metosulam), N′-(3-chloro-4-methoxy-phenyl)-N,N-dimethyl-urea (metoxuron), 4-amino-6-tert-butyl-3-methylthio-1,2,4-triazin-5(4H)-one (metribuzin), N-(4-methoxy-6-methyl-1,3,5-triazin-2-yl)-N′-(2-methoxycarbonyl-phenylsulfonyl)-urea (metsulfuron-methyl), S-ethyl hexahydro-1H-azepin-1-carbothioate (molinate), 2-(2-naphthyloxy)-N-phenyl-propanamide (naproanilide), N-butyl-N′-(3,4-dichloro-phenyl)-N-methyl-urea (neburon), N-(4,6-dimethoxy-pyrimidin-2-yl)-N′-(3-dimethylcarbamoyl-pyridin-2-yl-sulfonyl)-urea (nicosulfuron), 4-chloro-5-methylamino-2-(3-trifluoromethyl-phenyl)-3(2H)pyridazinone (norflurazon), 4-(7-chloro-2,4-dimethyl-5-benzofuranyl)-2,4-dihydro-2-methyl-5-trifluoromethyl-3H-1,2,4-triazole-3-thione (OK-701-cf. WO-A-97/09326/U.S. Pat. No. 5,759,958), S-(2-chloro-benzyl) N,N-diethyl-thiocarbamate (orbencarb), 4-dipropylamino-3,5-dinitro-benzenesulfonamide (oryzalin), 3-[2,4-dichloro-5-(2-propinyloxy)-phenyl]-5-(t-butyl)-1,3,4-oxadiazol-2(3H)-one (oxadiargyl), 3-[2,4-dichloro-5-(1-methyl-ethoxy)-phenyl]-5-(t-butyl)-1,3,4-oxadiazol-2(3H)-one (oxadiazon), N-(4,6-dimethyl-pyrimidin-2-yl)-N′-(2-oxetan-3-yl-oxycarbonyl-phenylsulfonyl)-urea (oxasulfuron), 3-[1-(3,5-dichloro-phenyl)-1-i-propyl]-2,3-dihydro-6-methyl-5-phenyl-4H-1,3-oxazin-4-one (oxaziclomefone), 2-chloro-1-(3-ethoxy-4-nitro-phenoxy)-4-trifluoromethyl-benzene (oxyfluorfen), 1,1′-dimethyl-4,4′-bipyridinium (paraquat), 1-amino-N-(1-ethyl-propyl)-3,4-dimethyl-2,6-dinitro-benzene (pendimethalin), 4-(t-butyl)-N-(1-ethyl-propyl)-2,6-dinitro-benzeneamine (pendralin), 2-(2,2-difluoro-ethoxy)-N-(5,8-dimethoxy-[1,2,4]-triazolo-[1,5-c]-pyrimidin-2-yl)-6-trifluoromethyl-benzenesulfonamide (penoxsulam), 3-(4-chloro-5-cyclopentyloxy-2-fluoro-phenyl)-5-(1-methyl-ethylidene)-2,4-oxazolidine-dione (pentoxazone), 2-chloro-N-(2-ethoxy-ethyl)-N-(2-methyl-1-phenyl-1-propenyl)-acetamide (pethoxamid), 4-amino-3,5,6-trichloro-pyridine-2-carboxylic acid (picloram), N-(4-fluoro-phenyl)-6-(3-trifluoromethyl-phenoxy)-pyridine-2-carboxamide (picolinafen), S-[2-(2-methyl-1-piperidinyl)-2-oxo-ethyl]O,O-dipropyl phosphorodithioate (piperophos), 2-chloro-N-(2,6-diethyl-phenyl)-N-(2-propoxy-ethyl)-acetamide (pretilachlor), N-(4,6-bis-difluoromethoxy-pyrimidin-2-yl)-N′-(2-methoxycarbonyl-phenylsulfonyl)-urea (primisulfuron-methyl), 1-chloro-N-[2-chloro-4-fluoro-5-[(6S,7aR)-6-fluoro-tetrahydro-1,3-dioxo-1H-pyrrolo[1,2-c]imidazol-2(3H)-yl]-phenyl]-methanesulfonamide (profluazol), 2-[1-[[2-(4-chlorophenoxy)-propoxy]-imino]-butyl]-3-hydroxy-5-(tetrahydro-2H-thiopyran-3-yl)-2-cyclohexene-1-one (profoxydim), 2-chloro-N-isopropyl-N-phenyl-acetamide (propachlor), N-(3,4-dichloro-phenyl)-propanamide (propanil), (R)-[2-[[(1-methyl-ethylidene)-amino]-oxy]-ethyl]2-[4-(6-chloro-2-quinoxalinyloxy)-phenoxy]-propanoate (propaquizafop), 2-chloro-N-(2-ethyl-6-methyl-phenyl)-N-[(1-methyl-ethoxy)-methyl]-acetamide (propisochlor), methyl 2-[[[(4,5-dihydro-4-methyl-5-oxo-3-propoxy-1H-1,2,4-triazol-1-yl)-carbonyl]-amino]-sulfonyl]-benzoate sodium salt (propoxycarbazone-sodium), S-phenylmethyl-N,N-dipropyl-thiocarbamate (prosulfocarb), N-(4-methoxy-6-methyl-1,3,5-triazin-2-yl)-N′-(2-(3,3,3-trifluoro-propyl)-phenylsulfonyl)-urea (prosulfuron), ethyl [2-chloro-5-(4-chloro-5-difluoromethoxy-1-methyl-1H-pyrazol-3-yl)-4-fluoro-phenoxy]-acetate (pyraflufen-ethyl), 1-(3-chloro-4,5,6,7-tetrahydro-pyrazolo[1,5-a]pyridin-2-yl)-5-(methyl-2- propinylamino)-1H-pyrazole-4-carbonitrile (pyraclonil, pyrazogyl), 4-(2,4-dichloro-benzoyl)-1,3-dimethyl-5-(4-methyl-phenylsulfonyloxy)-pyrazole (pyrazolate), 4-(2,4-dichloro-benzoyl)-1,3-dimethyl-5-(phenylcarbonylmethoxy)-pyrazole (pyrazoxyfen), N-(4,6-dimethoxy-pyrimidin-2-yl)-N′-(4-ethoxycarbonyl-methyl-pyrazol-5-yl-sulfonyl)-urea (pyrazosulfuron-ethyl), diphenylmethanone O-[2,6-bis-(4,6-dimethoxy-pyrimidin-2-yl-oxy)-benzoyl]-oxime (pyribenzoxim), O-[3-(1,1-dimethyl-ethyl)-phenyl](6-methoxy-2-pyridinyl)-methylthiocarbamate (pyributicarb), 6-chloro-3-phenyl-4-pyridazinol (pyridafol), O-(6-chloro-3-phenyl-pyridazin-4-yl) S-octyl-thiocarbonate (pyridate), 6-chloro-3-phenyl-pyridazin-4-ol (pyridatol), 7-[(4,6-dimethoxy-2-pyrimidinyl)-thio]-3-methyl-1(3H)-isobenzofuranone (pyriftalid), methyl 2-(4,6-dimethoxy-pyrimidin-2-yl-oxy)-benzoate (pyriminobac-methyl), 2-chloro-6-(4,6-dimethoxy-pyrimidin-2-ylthio)-benzoic acid sodium salt (pyrithiobac-sodium), 3,7-dichloro-quinoline-8-carboxylic acid (quinchlorac), 7-chloro-3-methyl- quinoline-8-carboxylic acid (quinmerac), 2-amino-3-chloro-1,4-naphthalenedione (quinoclaamine), 2-[4-(6-chloro-2-quinoxalinyloxy)-phenoxy]-propanoic acid (-ethyl ester, -tetrahydro-2-furanyl-methyl ester) (quizalofop, -ethyl, -P-ethyl, -P-tefuryl), N-(4,6-dimethoxy-pyrimidin-2-yl)-N′-(3-ethylsulfonyl-pyridin-2-yl-sulfonyl)-urea (rimsulfuron), 2-(1-ethoximinobutyl)-5-(2-ethylthiopropyl)-3-hydroxy-2-cyclohexen-1-one (sethoxydim), 6-chloro-2,4-bis-ethylamino-1,3,5-triazine (simazine), 2-(2-chloro-4-methylsulfonyl-benzoyl)-cyclohexane-1,3-dione (sulcotrione), 2-(2,4-dichloro-5-methylsulfonylamino-phenyl)-4-difluoromethyl-5-methyl-2,4-dihydro-3H-1,2,4-triazol-3-one (sulfentrazone), methyl 2-[[[[(4,6-dimethyl-2-pyrimidinyl)-amino]-carbonyl]-amino]-sulfonyl]-benzoate (sulfometuron-methyl), N-phosphonomethyl-glycine-trimethylsulfonium (sulfosate), N-(4,6-dimethoxy-pyrimidin-2-yl)-N′-(2-ethylsulfonyl-imidazo[1,2-a]pyridine-3-sulfonamide (sulfosulfuron), 6-chloro-4-ethylamino-2-tert-butylamino-1,3,5-triazine (terbuthylazine), 2-tert-butylamino-4-ethylamino-6-methylthio-1,3,5-triazine (terbutryn), 2-chloro-N-(2,6-dimethyl-phenyl)-N-(3-methoxy-2-thienyl-methyl)-acetamide (thenylchlor), methyl 2-difluoromethyl-5-(4,5-dihydro-thiazol-2-yl)-4(2- methyl-propyl)-6-trifluoromethyl-pyridine-3-carboxylate (thiazopyr), 6-(6,7-dihydro-6,6-dimethyl-3H,5H-pyrrolo[2, 1-e]-1,2,4-thiadiazol-3-ylideneamino)-7-fluoro-4(2- propinyl)-2H-1,4-benzoxazin-3(4H)-one (thidiazimin), N-(4-methoxy-6-methyl-1,3,5-triazin-2-yl)-N′-(2-methoxycarbonyl-thien-3-yl-sulfonyl)-urea (thifensulfuron-methyl), S-(phenylmethyl)-bis-(1-methyl-propyl)-carbamothioate (tiocarbazil), 2-(ethoximino-propyl)-3-hydroxy-5-(2,4,6-trimethyl-phenyl)-2-cyclohexen-1-one (tralkoxydim), S-(2,3,3-trichloro-2-propenyl) diisopropylcarbamothioate (triallate), N-(4-methoxy-6-methyl-1,3,5-triazin-2-yl)-N′-[2-(2-chloro-ethoxy)-phenylsulfonyl]-urea (triasulfuron), N-methyl-N-(4-methoxy-6-methyl-1,3,5-triazin-2-yl)-N′-(2-methoxycarbonyl-phenylsulfonyl)-urea (tribenuron-methyl), (3,5,6-trichloro)-pyridin-2-yl-oxy-acetic acid (triclopyr), 2-(3,5-dichloro-phenyl)-2-(2,2,2-trichloro-ethyl)- oxirane (tridiphane), N-[[(4,6-dimethoxy-2-pyrimidinyl)-amino]-carbonyl]-3-(2,2,2-trifluoro-ethoxy)-2-pyridinesulfonamide sodium salt (trifloxysulfuron), 1-amino-2,6-dinitro-N,N-dipropyl-4-trifluoromethyl-benzene (trifluralin), N-[4-dimethylamino-6-(2,2,2-trifluoro-ethoxy)-1,3,5-triazin-2-yl]-N′-(2-methoxycarbonyl-phenylsulfonyl)-urea (triflusulfuron-methyl), N-(4-methoxy-6-trifluoromethoxy-1,3,5-triazin-2-yl)-N′-(2-trifluoromethyl-phenylsulfonyl)-urea (tritosulfuron), N-[[(4,6-dimethoxy-2-pyrimidinyl)-amino]-carbonyl]-3-(N-methyl-N-methylsulfonyl-amino)-2-pyridinesulfonamide, (cf. WO-A-92/10660), 4-(4,5-dihydro-4-methyl-5-oxo-3-trifluoromethyl-1H-1,2,4-triazol-1-yl)-2-(ethylsulfonylamino)-5-fluoro-benzenecarbothioamide (HWH4991, cf. WO-A-95/30661), 2-chloro-N-[1-(2,6-dichloro-difluoromethyl-phenyl)-4-nitro-1H-pyrazol-5-yl]-propanecarboxamide (SLA5599, cf. EP-A-303153), [2-chloro-3-(4,5dihydro-3-isoxazolyl)-4-methylsulfonyl-phenyl]-(5-hydrox-1-methyl-1H-pyrazol-4-yl)-methanone (cf. WO-A-96/26206, WO-A-98/31681), [3-(4,5-dihydro-3-isoxazolyl)-2-methyl-4-methylsulfonyl-phenyl]-(5-hydrox-1-methyl-1H-pyrazol-4-yl)-methanone (cf. WO-A-96/26206, WO-A-98/31681), [3-[2-chloro-3-[(2,6-dioxo-cyclohexyl)-carbonyl]-6-ethylsulfonyl-phenyl]-5-isoxazolyl]-acetonitrile (cf. WO-A-01/28341), 2-[2-chloro-4-methylsulfonyl-3-[(2,2,2-trifluoro-ethoxy)-methyl]-benzoyl]-1,3-cyclohexanedione (cf. WO-A-01/28341), 2-[[5,8-dimethyl-1,1-dioxido-4-(2-pyrimidinyloxy)-3,4-dihydro-2H-thiochromen-6-yl]-carbonyl]-1,3-cyclohexanedione (cf. WO-A-01/28341)
(“active compounds of group 2”), and/or
(c) a compound which improves crop plant compatibility, from the group of compounds below:
4-dichloroacetyl-1-oxa-4-aza-spiro[4.5]-decane (AD-67), 1-dichloroacetyl-hexahydro-3,3,8a-trimethylpyrrolo[1,2-a]-pyrimidin-6(2H)-one (BAS-145138), 4-dichloroacetyl-3,4-dihydro-3-methyl-2H-1,4-benzoxazine (benoxacor), 1-methyl-hexyl 5-chloro-quinoxalin-8-oxy-acetate (cloquintocet-mexyl, α-(cyano-methoximino)-phenylacetonitrile (cyometrinil), 2,4-dichlorophenoxy acetic acid (2,4-D), 2,2-dichloro-N-(2-oxo-2-(2-propenylamino)-ethyl)-N-(2-propenyl)-acetamide (DKA-24), 2,2-dichloro-N,N-di-2-propenyl acetamide (dichlormid), N-(4-methyl-phenyl)-N′-(1-methyl-1-phenyl-ethyl)-urea (dymron), 4,6-dichloro-2-phenyl-pyrimidine (fenclorim), ethyl 1-(2,4-dichloro-phenyl)-5-trichloro-methyl-1H-1,2,4-triazole-3-carboxylate (fenchlorazol-ethyl), phenylmethyl 2-chloro-4-trifluoromethyl-thiazole-5-carboxylate (flurazole), 4-chloro-N-(1,3-dioxolan-2-yl-methoxy)-α-trifluoro-acetophenone oxime (fluxofenim), 3-dichloroacetyl-5-(2-furanyl)-2,2-dimethyl-oxazolidine (furilazole, MON-13900), ethyl-4,5-dihydro-5,5-diphenyl-3-isoxazolecarboxylate (isoxadifen-ethyl), (4-chloro-2-methyl-phenoxy)-acetic acid (MCPA), (+−)-2-(4-chloro-2-methylphenoxy)-propionic acid (mecoprop), diethyl 1-(2,4-dichloro-phenyl)-4,5-dihydro-5-methyl-1H-pyrazole-3,5-dicarboxylate (mefenpyr-diethyl), 2-dichloromethyl-2-methyl-1,3-dioxolane (MG-191), 1,8-naphthalic anhydride, α-(1,3-dioxolan-2-yl-methoximino)-phenylacetonitrile (oxabetrinil), 2,2-dichloro-N-(1,3-dioxolan-2-yl-methyl)-N-(2-propenyl)-acetamide (PPG-1292), 3-dichloroacetyl-2,2,5-trimethyl-oxazolidine (R-29148), N-cyclopropyl-4-[[(2-methoxy-5-methyl-benzoyl)-amino]-sulfonyl]-benzamide, N-[[(4-methoxy-acetylamino)-phenyl]-sulfonyl-2-methoxy-benzamide and N-[[(4-methyl-aminocarbonylamino)-phenyl]-sulfonyl-2-methoxy-benzamide (the latter each known from WO-A-99/66795)
4-(2-Chlorobenzoylaminosulfonyl)-N-propylbenzamide (WO 99/16744), N-(phenyl-sulfamoyl) benzamide derivatives of the formula (V) 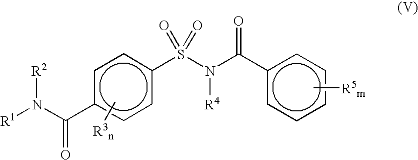
   in which
R¹ represents hydrogen, (C₁-C₆)-alkyl, (C₃-C₆)-cycloalkyl, (C₂-C₆)-alkenyl, (C₅-C₆)-cycloalkenyl, phenyl or 3- to 6-membered heterocyclyl having up to three heteroatoms from the group consisting of nitrogen, oxygen and sulfur, where the six last-mentioned radicals are optionally substituted by one or more identical or different substituents from the group consisting of halogen, (C₁-C₆)-alkoxy, (C₁-C₆)-haloalkoxy, (C₁-C₂)-alkylsulfinyl, (C₁-C₂)-alkylsulfonyl, (C₃-C₆)-cycloalkyl, (C₁-C₄)-alkoxycarbonyl, (C₁-C₄)-alkylcarbonyl and phenyl and, in the case of cyclic radicals, also (C₁-C₄)-alkyl and (C₁-C₄)-haloalkyl;
R² represents hydrogen, (C₁-C₆)-alkyl, (C₂-C₆)-alkenyl, (C₂-C₆)-alkinyl, where the three last-mentioned radicals are optionally substituted by one or more identical or different substituents from the group consisting of halogen, hydroxyl, (C₁-C₄)-alkyl, (C₁-C₄)-alkoxy and (C₁-C₄)-alkylthio;
R³ represents halogen, (C₁-C₄)-haloalkyl, (C₁-C₄)-haloalkoxy, nitro, (C₁-C₄)-alkyl, (C₁-C₄)-alkoxy, (C₁-C₄)-alkylsulfonyl, (C₁-C₄)-alkoxycarbonyl or (C ₁-C₄)-alkylcarbonyl;
R⁴ represents hydrogen or methyl;
R⁵ represents halogen; nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl or (C₁-C₄)-alkylcarbonyl;
n represents 0, 1 or 2 and
m represents 1 or 2,
   and their salts, in particular the sodium salts (known from WO-099/16744), 2-methoxy-N-[4-(2-methoxybenzoylsulfamoyl)phenyl]acetamide (DE-A1-19621522), N-acylsulfonamide derivatives of the formula (VI) 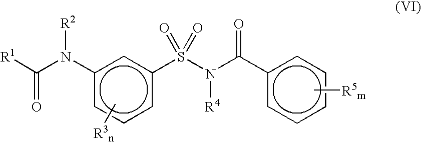
   in which
R¹ represents hydrogen, (C₁-C₆)-alkyl, (C₃-C₆)-Cycloalkyl, furanyl or thienyl, where each of the four last-mentioned radicals is unsubstituted or substituted by one or more substituents from the group consisting of halogen, (C₁-C₄)-alkyloxy, halogeno-(C₁-C₆)-alkoxy and (C₁-C₄)-alkylthio and, in the case of cyclic radicals, also (C₁-C₄)-alkyl and (C₁-C₄)-halogenoalkyl;
R² represents hydrogen or methyl;
R³ represents halogen, halogeno-(C₁-C₄)-alkyl, halogeno-(C₁-C₄)-alkoxy, (C₁-C₄)-alkyl, (C₁-C₄)-alkoxy, (C₁-C₄)-alkylsulfonyl, (C₁-C₄)-alkoxycarbonyl, (C₁-C₄)-alkylcarbonyl,
R⁴ represents hydrogen or methyl, R⁵ represents halogen, (C₁-C₄)-alkyl, halogeno-(C₁-C₄)-alkyl, halogeno (C₁-C₄)-alkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl, (C₁-C₄)-alkylcarbonyl,
n represents 0, 1 or 2 and
m represents 1 or 2,
and their alkali metal salts, in particular the sodium salts (known from DE-A1-19 621 522).
(“active compounds of group 3”).

The compounds involved in the active compound combinations according to the invention contain, if appropriate, one or more asymmetrically substituted carbon atoms and may therefore be present in different enantiomeric (R- or S-configured) and/or diastereomeric forms. The invention relates both to the possible combinations with individual enantiomeric and/or stereoisomeric forms and with mixtures of the stereo isomeric forms of the involved compounds possible in each case.

Preferred meanings of the groups listed above in connection with the formula (I) are defined below.
m preferably represents the numbers 0, 1, 2, 3 or 4.
A preferably represents alkanediyl (alkylene) having 1 to 3 carbon atoms.
R¹ preferably represents one of the groupings below 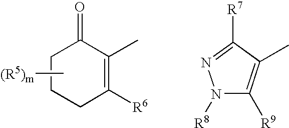
R² preferably represents hydrogen, nitro, cyano, carboxyl, carbamoyl, thiocarbamoyl, fluorine, chlorine, bromine, iodine, or represents in each case optionally cyano-, fluorine-, chlorine-, bromine-, C₁-C₃-alkoxy-, C₁-C₃-alkylthio-, C₁-C₃-alkylsulfinyl- or C₁-C₃-alkylsulfonyl-substituted alkyl, alkoxy, alkylthio, alkylsulfinyl, aikylsulfonyl, alkylamino, dialkylamino or dialkylaminosulfonyl having in each case 1 to 5 carbon atoms in the alkyl groups.
R³ preferably represents hydrogen, nitro, cyano, carboxyl, carbamoyl, thiocarbamoyl, fluorine, chlorine, bromine, iodine, or represents in each case optionally cyano-, fluorine-, chlorine-, bromine-, C₁-C₃-alkoxy-, C₁-C₃-alkylthio-, C₁-C₃-alkylsulfinyl- or C₁-C₃-alkylsulfonyl-substituted alkyl, alkoxy, alkylthio, alkylsulfinyl, alkylsulfonyl, alkylamino, dialkylamino or dialkylaminosulfonyl having in each case 1 to 5 carbon atoms in the alkyl groups.
R⁴ preferably represents one of the heterocyclic groupings below 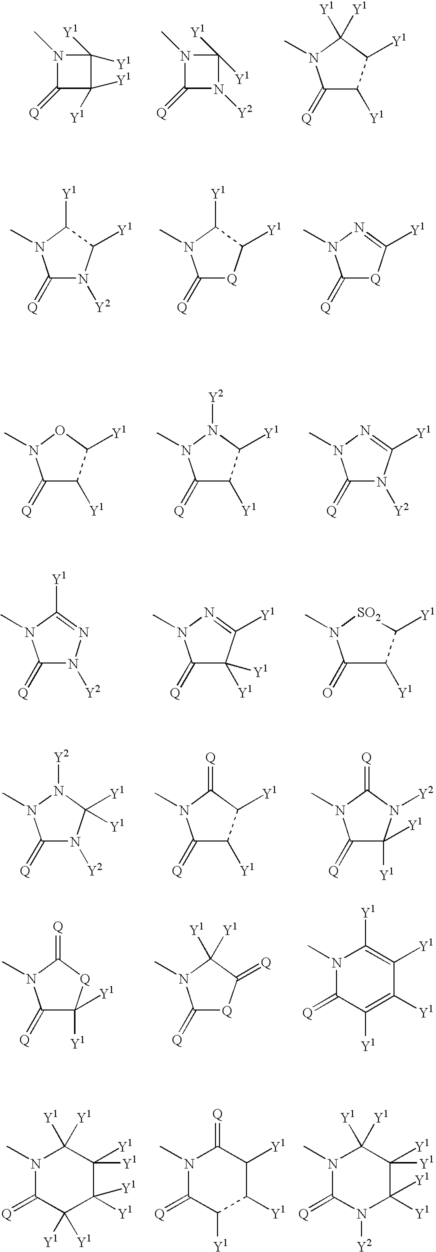 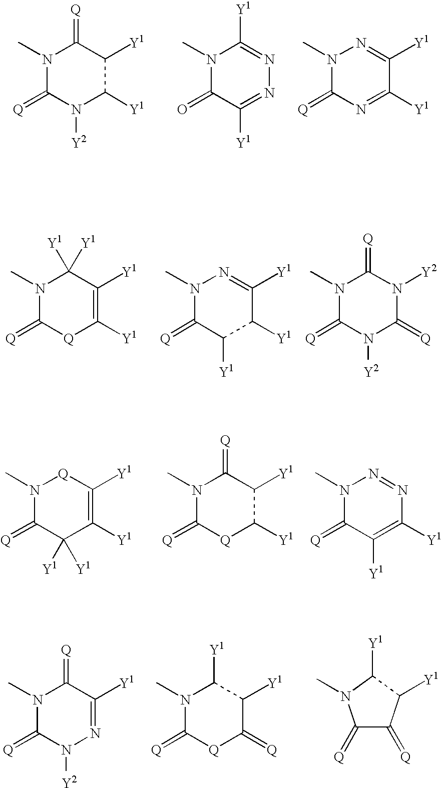 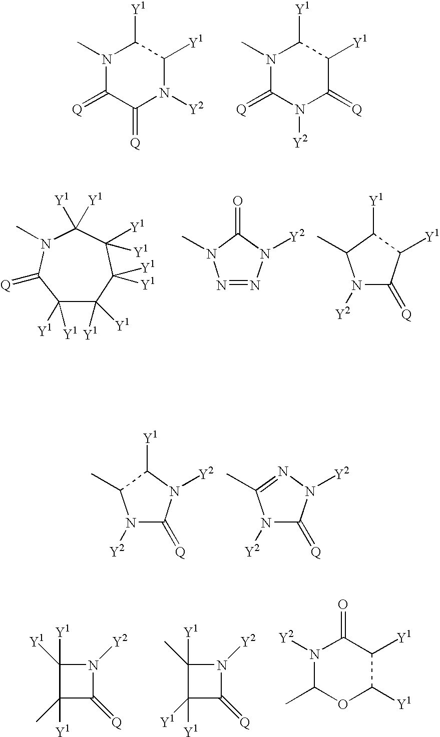
   where in each case the broken bond represents a single bond or a double bond, and each heterocyclic grouping preferably carries 1 to 3, particularly preferably 1 or 2 substituents,
   Q represents oxygen or sulfur,
   Y¹ represents hydrogen, hydroxyl, mercapto, cyano, fluorine, chlorine, bromine, iodine, represents in each case optionally cyano-, fluorine-, chlorine-, bromine-, C₁-C₃-alkoxy-, C₁-C₃-alkylthio-, C₁-C₃-alkylsulfinyl- and/or C₁-C₃-alkylsulfonyl-substituted alkyl, alkylcarbonyl, alkoxy, alkoxycarbonyl, alkylthio, alkylsulfinyl or alkylsulfonyl having in each case up to 5 carbon atoms in the alkyl groups, represents in each case optionally fluorine- or chlorine-substituted alkylamino or dialkylamino having in each case up to 5 carbon atoms in the alkyl groups, represents in each case optionally fluorine-, chlorine- and/or bromine-substituted alkenyl, alkinyl, alkenyloxy, alkenylthio or alkenylamino having in each case up to 5 carbon atoms in the alkenyl or alkinyl groups, represents in each case optionally fluorine-, chlorine- and/or bromine-substituted cycloalkyl, cycloalkyloxy, cycloalkylthio, cycloalkylamino, cycloalkylalkyl, cycloalkylalkoxy, cycloalkylalkylthio or cycloalkylalkylamino having in each case 3 to 6 carbon atoms in the cycloalkyl groups and optionally up to 3 carbon atoms in the alkyl moiety, or represents in each case optionally fluorine-, chlorine-, bromine-, iodine-, C₁-C₄-alkyl- or C₁-C₄-alkoxy-substituted phenyl, phenyloxy, phenylthio, phenylamino, benzyl, benzyloxy, benzylthio or benzylamino, represents pyrrolidino, piperidino or morpholino, or—if two adjacent radicals Y¹ and Y¹ are located at a double bond—together with the adjacent radical Y¹ also represents a benzo grouping, and
   Y² represents hydrogen, hydroxyl, amino, alkylideneamino having up to 4 carbon atoms, represents in each case optionally fluorine-, chlorine-, bromine- or C₁-C₃-alkoxy-substituted alkyl, alkoxy, alkylamino, dialkylamino or alkanoylamino having in each case up to 5 carbon atoms in the alkyl groups; represents in each case optionally fluorine-, chlorine- and/or bromine-substituted alkenyl, alkinyl or alkenyloxy having in each case up to 5 carbon atoms in the alkenyl or alkinyl groups; represents in each case optionally fluorine-, chlorine- and/or bromine-substituted cycloalkyl, cycloalkylalkyl or cycloalkylamino having in each case 3 to 6 carbon atoms in the cycloalkyl groups and optionally up to 3 carbon atoms in the alkyl moiety; or represents in each case optionally fluorine-, chlorine-, bromine-, iodine-, C₁-C₄-alkyl- and/or C₁-C₄-alkoxy-substituted phenyl or benzyl, or together with an adjacent radical Yl or y represents optionally halogen- or C₁-C₄-alkyl-substituted alkanediyl having 3 to 5 carbon atoms, where the individual radicals Y¹ and Y², if more than one of them, preferably up to three, are attached to the same heterocyclic groupings, can have identical or different meanings within the scope of the above definition.
R⁵ preferably represents fluorine, chlorine, bromine, represents in each case optionally cyano-, fluorine-, chlorine- or C₁-C₃-alkoxy-substituted alkyl, alkoxycarbonyl or alkylthio having in each case 1 to 5 carbon atoms in the alkyl groups, represents optionally fluorine-, chlorine-, bromine-, C₁-C₄-alkyl- or C₁-C₄-alkoxy-substituted phenyl, or optionally also—if m represents 2—together with a second radical R⁵ represents alkanediyl (alkylene) having 2 to 6 carbon atoms.
R⁶ preferably represents hydroxyl, formyloxy, or represents in each case optionally cyano-, fluorine-, chlorine- or C₁-C₃-alkoxy-substituted alkoxy, alkylthio, alkylsulfinyl, alkylsulfonyl, alkylcarbonyloxy, alkoxycarbonyloxy, alkylaminocarbonyloxy or alkylsulfonyloxy having in each case 1 to 5 carbon atoms in the alkyl groups, represents in each case optionally cyano-, fluorine-, chlorine- and/or bromine-substituted alkenyloxy or alkinyloxy having in each case 3 to 5 carbon atoms, or represents in each case optionally nitro-, cyano-, fluorine-, chlorine-, bromine-, or (in each case fluorine- and/or chlorine-substituted) C₁-C₄-alkyl- or C₁-C₄-alkoxy-substituted phenoxy, phenylthio, phenylsulfinyl, phenylsulfonyl, phenylcarbonyloxy, phenylcarbonylalkoxy, phenylsulfonyloxy, phenylalkoxy, phenylalkylthio, phenylalkylsulfinyl or phenylalkylsulfonyl having optionally 1 to 4 carbon atoms in the alkyl moiety.
R⁷ preferably represents hydrogen, cyano, carbamoyl, thiocarbamoyl, fluorine, chlorine, bromine, represents in each case optionally cyano-, fluorine-, chlorine-, bromine- or C₁-C₃-alkoxy-substituted alkyl, alkoxy, alkylthio, alkylsulfinyl, alkylsulfonyl or alkoxycarbonyl having in each case 1 to 5 carbon atoms in the alkyl groups, or represents optionally cyano-, fluorine-, chlorine, bromine- or C₁-C₃-alkyl-substituted cycloalkyl having 3 to 6 carbon atoms.
R⁸ preferably represents hydrogen, represents in each case optionally cyano-, fluorine-, chlorine- or C₁-C₃-alkoxy-substituted alkyl having 1 to 5 carbon atoms, represents in each case optionally cyano-, fluorine-, chlorine- and/or bromine-substituted alkenyl or alkinyl having in each case 3 to 5 carbon atoms, represents in each case optionally cyano-, fluorine-, chlorine-, bromine- or C₁-C₃-alkyl-substituted cycloalkyl or cycloalkylalkyl having in each case 3 to 6 carbon atoms in the cycloalkyl group and optionally 1 to 3 carbon atoms in the alkyl moiety, or represents in each case optionally nitro-, cyano-, fluorine-, chlorine-, bromine-, iodine-, or (in each case optionally fluorine- and/or chlorine-substituted) C₁-C₄-alkyl- or C₁-C₄-alkoxy-substituted phenyl or phenyl-C₁-C₄-alkyl.
R⁹ preferably represents hydroxyl, formyloxy, represents in each case optionally cyano-, fluorine-, chlorine- or C₁-C₃-alkoxy-substituted alkoxy, alkylcarbonyloxy, alkoxycarbonyloxy, alkylaminocarbonyloxy or alkylsulfonyloxy having in each case 1 to 5 carbon atoms in the alkyl groups, represents in each case optionally cyano-, fluorine-, chlorine- and/or bromine-substituted alkenyloxy or alkinyloxy having in each case 3 to 5 carbon atoms, or represents in each case optionally nitro-, cyano-, fluorine-, chlorine-, bromine-, iodine-, or (in each case optionally fluorine- and/or chlorine-substituted) C₁-C₄-alkyl- or C₁-C₄-alkoxy-substituted phenylalkoxy, phenylcarbonyloxy, phenylcarbonylalkoxy or phenylsulfonyloxy having optionally 1 to 3 carbon atoms in the alkyl moiety.
R¹⁰ preferably represents hydrogen, cyano, carbamoyl, thiocarbamoyl, fluorine, chlorine, bromine, or represents in each case optionally cyano-, fluorine-, chlorine- or C₁-C₃-alkoxy-substituted alkyl, alkylcarbonyl, alkoxy, alkoxycarbonyl, alkylthio, alkylsulfinyl or alkylsulfonyl having in each case 1 to 5 carbon atoms in the alkyl groups.
R¹¹ preferably represents hydrogen, represents optionally cyano-, fluorine-, chlorine- or C₁-C₃-alkoxy-substituted alkyl having 1 to 5 carbon atoms or represents optionally cyano-, fluorine-, chlorine-, bromine- or C₁-C₃-alkyl-substituted cycloalkyl having 3 to 6 carbon atoms.
R¹² preferably represents hydrogen, represents optionally cyano-, fluorine-, chlorine- or C₁-C₃-alkoxy-substituted alkyl having 1 to 5 carbon atoms or represents optionally cyano-, fluorine-, chlorine-, bromine- or C₁-C₃-alkyl-substituted cycloalkyl having 3 to 6 carbon atoms.
R¹³ preferably represents hydrogen, cyano, carbamoyl, fluorine, chlorine, bromine, or represents in each case optionally cyano-, fluorine-, chlorine- or C₁-C₃-alkoxy-substituted alkyl, alkoxy, alkoxycarbonyl, alkylthio, alkylsulfinyl or alkylsulfonyl having in each case 1 to 5 carbon atoms in the alkyl groups.
m particularly preferably represents the numbers 0, 1, 2 or 3.
A particularly preferably represents methylene, ethane-1,2-diyl (dimethylene), ethane-1,1-diyl, propane-1,2-diyl or propane-1,3-diyl (trimethylene).
R² particularly preferably represents hydrogen, nitro, cyano, carboxyl, carbamoyl, thiocarbamoyl, fluorine, chlorine, bromine, iodine, or represents in each case optionally fluorine-, chlorine-, methoxy-, ethoxy-, n- or i-propoxy-, methylthio-, ethylthio-, n- or i-propylthio-, methylsulfinyl-, ethylsulfinyl-, methylsulfonyl- or ethylsulfonyl-substituted methyl, ethyl, n- or i-propyl, n-, i-, s- or t-butyl, represents in each case optionally fluorine- and/or chlorine-, methoxy-, ethoxy-, n- or i-propoxy-substituted methoxy, ethoxy, n- or i-propoxy, represents in each case optionally fluorine- and/or chlorine-substituted methylthio, ethylthio, n- or i-propylthio, methylsulfinyl, ethylsulfinyl, n- or i-propylsulfinyl, methylsulfonyl, ethylsulfonyl, n- or i-propylsulfonyl, or represents methylamino, ethylamino, n- or i-propylamino, dimethylamino, diethylamino, dimethylaminosulfonyl or diethylamino-sulfonyl.
R³ particularly preferably represents hydrogen, nitro, cyano, carboxyl, carbamoyl, thiocarbamoyl, fluorine, chlorine, bromine, represents in each case optionally fluorine-, chlorine-, methoxy-, ethoxy-, n- or i-propoxy-, methylthio-, ethylthio-, n- or i-propylthio-, methylsulfinyl-, ethylsulfinyl-, methylsulfonyl- or ethylsulfonyl-substituted methyl, ethyl, n- or i-propyl, n-, i-, s- or t-butyl, represents in each case optionally fluorine- and/or chlorine-, methoxy-, ethoxy-, n- or i-propoxy-substituted methoxy, ethoxy, n- or i-propoxy, represents in each case optionally fluorine- and/or chlorine-substituted methylthio, ethylthio, n- or i-propylthio, methylsulfinyl, ethylsulfinyl, n- or i-propylsulfinyl, methylsulfonyl, ethylsulfonyl, n- or i-propylsulfonyl, or represents methylamino, ethylamino, n- or i-propylamino, dimethylamino, diethylamino, dimethylaminosulfonyl or diethylaminosulfonyl.
R⁴ particularly preferably represents one of the heterocyclic groupings below 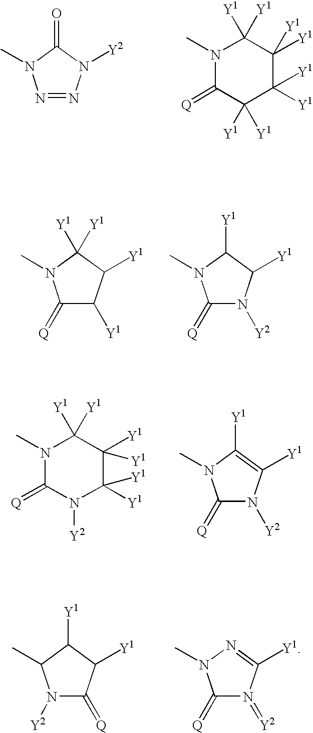
Q particularly preferably represents oxygen.
Y¹ particularly preferably represents hydrogen, hydroxyl, mercapto, cyano, fluorine, chlorine, bromine, iodine, represents in each case optionally fluorine-, chlorine- methoxy-, ethoxy-, n- or i-propoxy-, methylthio-, ethylthio-, n- or i-propylthio-, methylsulfinyl-, ethylsulfinyl-, methylsulfonyl- or ethylsulfonyl-substituted methyl, ethyl, -n- or i-propyl, n-, i-, s- or t-butyl, methoxy, ethoxy, n- or i-propoxy, n-, i-, s- or t-butoxy, methylthio, ethylthio, n- or i-propylthio, n-, i-, s- or t-butylthio, methylsulfinyl, ethylsulfinyl, n- or i-propylsulfinyl, methylsulfonyl, ethylsulfonyl, n- or i-propylsulfonyl, represents methylamino, ethylamino, n- or- i-propylamino, n-, i-, s- or t-butylamino, dimethylamino, diethylamino, di-n-propylamino or di-i-propylamino,
   represents in each case optionally fluorine- and/or chlorine-substituted ethenyl, propenyl, butenyl, ethinyl, propinyl, butinyl, propenyloxy, butenyloxy, propenylthio, butenylthio, propenylamino or butenylamino,
   represents in each case optionally fluorine- and/or chlorine-substituted cyclopropyl, cyclobutyl, cyclopentyl, cyclohexyl, cyclopropyloxy, cyclobutyloxy, cyclopentyloxy, cyclohexyloxy, cyclopropylthio, cyclobutylthio, cyclopentylthio, cyclohexylthio, cyclopropylamino, cyclobutylamino, cyclopentylamino,. cyclohexylamino, cyclopropylmethyl, cyclobutylmethyl, cyclopentylmethyl, cyclohexylmethyl, cyclopropylmethoxy, cyclobutylmethoxy, cyclopentylmethoxy, cyclohexylmethoxy, cyclopropylmethylthio, cyclobutylmethylthio, cyclopentylmethylthio, cyclohexylmethylthio, cyclopropylmethylamino, cyclobutylmethylamino, cyclopentylmethylamino or cyclohexylmethylamino,
   or represents in each case optionally fluorine-, chlorine-, methyl-, ethyl-, n- or i-propyl-, n-, i-, s- or t-butyl-, methoxy-, ethoxy-, n- or i-propoxy-substituted phenyl, phenyloxy, phenylthio, phenylamino, benzyl, benzyloxy, benzylthio or benzylamino, represents pyrrolidino, piperidino or morpholino, or—if two adjacent radicals Y¹ and Y¹ are located at a double bond—together with the adjacent radical Y¹ also represents a benzo grouping.
Y² particularly preferably represents hydrogen, hydroxyl, amino,
   represents in each case optionally fluorine- and/or chlorine-, methoxy- or ethoxy-substituted methyl, ethyl, n- or i-propyl, n-, i- or s-butyl, methoxy, ethoxy, n- or i-propoxy, methyl amino, ethyl amino or dimethylamino,
   represents in each case optionally fluorine- and/or chlorine-substituted ethenyl, propenyl, ethinyl, propinyl or propenyloxy,
   represents in each case optionally fluorine- and/or chlorine-substituted cyclopropyl, cyclobutyl, cyclopentyl, cyclohexyl, cyclopropylmethyl, cyclobutylmethyl, cyclopentylmethyl, cyclohexylmethyl,
   or represents in each case optionally fluorine-, chlorine-, methyl-, ethyl-, n- or i-propyl-, n-, i-, s- or t-butyl-, methoxy-, ethoxy-, n- or i-propoxy-substituted phenyl or benzyl, or together with an adjacent radical Y¹ or Y² represents in each case optionally methyl- and/or ethyl-substituted propane-1,3-diyl (trimethylene) or butane-1,4-diyl (tetramethylene).
R⁵ particularly preferably represents fluorine, chlorine, bromine, represents in each case optionally cyano-, fluorine-, chlorine-, methoxy- or ethoxy-substituted methyl, ethyl, n- or i-propyl, n-, i-, s- or t-butyl, methoxycarbonyl, ethoxycarbonyl, n- or i-propoxycarbonyl, methylthio, ethylthio, n- or i-propylthio, represents optionally fluorine-, chlorine-, methyl- or methoxy-substituted phenyl, or optionally also - if m represents 2- together with the second radical R⁵ represents ethane-1,2-diyl (dimethylene), propane-1,3-diyl (trimethylene) or butane-1,4-diyl (tetramethylene).
R⁶ particularly preferably represents hydroxyl, formyloxy, represents in each case optionally cyano-, fluorine-, chlorine-, methoxy- or ethoxy-substituted methoxy, ethoxy, n- or i-propoxy, methylthio, ethylthio, n- or i-propylthio, methylsulfinyl, ethylsulfinyl, methylsulfonyl, ethylsulfonyl, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, n- or i-propylsulfonyloxy, represents in each case optionally cyano-, fluorine-, chlorine- or bromine-substituted propenyloxy, butenyloxy, propinyloxy or butinyloxy, or represents in each case optionally nitro-, cyano-, fluorine-, chlorine-, bromine-, methyl-, ethyl-, n- or i-propyl-, n-, i-, s- or t-butyl-, trifluoromethyl-, methoxy-, ethoxy-, n- or i-propoxy-, difluoromethoxy- or trifluoromethoxy-substituted phenoxy, phenylthio, phenylsulfinyl, phenylsulfonyl, benzoyloxy, benzoylmethoxy, phenylsulfonyloxy, phenylmethoxy, phenylmethylthio, phenylmethylsulfinyl or phenylmethylsulfonyl.
R⁷ particularly preferably represents hydrogen, cyano, carbamoyl, thiocarbamoyl, fluorine, chlorine, bromine, represents in each case optionally cyano-, fluorine-, chlorine-, methoxy- or ethoxy-substituted methyl, ethyl, n- or i-propyl, methoxy, ethoxy, n- or i-propoxy, methylthio, ethylthio, n- or i-propylthio, methylsulfinyl, ethylsulfinyl, methylsulfonyl, ethylsulfonyl, methoxycarbonyl, ethoxycarbonyl, n- or i-propoxycarbonyl, or represents in each case optionally cyano-, fluorine-, chlorine, bromine-, methyl- or ethyl-substituted cyclopropyl, cyclobutyl, cyclopentyl or cyclohexyl.
R⁸ particularly preferably represents hydrogen, represents in each case optionally cyano-, fluorine-, chlorine-, bromine-, methoxy- or ethoxy-substituted methyl, ethyl, n- or i-propyl, n-, i-, s- or t-butyl, represents in each case optionally cyano-, fluorine-, chlorine- or bromine-substituted propenyl, butenyl, propinyl or butinyl, represents in each case optionally cyano-, fluorine-, chlorine-, bromine-, methyl- or ethyl-substituted cyclopropyl, cyclobutyl, cyclopentyl, cyclohexyl, cyclopropylmethyl, cyclobutylmethyl, cyclopentylmethyl or cyclohexylmethyl, or represents in each case optionally nitro-, cyano-, fluorine-, chlorine-, bromine- methyl-, ethyl-, n- or i-propyl-, n-, i-, s- or t-butyl-, trifluoromethyl-, methoxy-, ethoxy-, n- or propoxy-, difluoromethoxy- or trifluoromethoxy-substituted phenyl or benzyl.
R⁹ particularly preferably represents hydroxyl, formyloxy, represents in each case optionally cyano-, fluorine-, chlorine-, bromine-, methoxy-, ethoxy-, n- or i-propoxy-substituted methoxy, ethoxy, n- or i-propoxy, acetyloxy, propionyloxy, n or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, n- or i-propylsulfonyloxy, represents in each case optionally cyano-, fluorine-, chlorine- or bromine-substituted propenyloxy, butenyloxy, propinyloxy or butinyloxy, or represents in each case optionally nitro-, cyano-, fluorine-, chlorine-, bromine-, methyl-, ethyl-, n- or i-propyl-., n-, i-, s- or t-butyl-, trifluoromethyl-, methoxy-, ethoxy-, n- or i-propoxy-, difluoromethoxy- or trifluoromethoxy-substituted phenylmethoxy, benzoyloxy, benzoylmethoxy or phenylsulfonyloxy.
R¹⁰ particularly preferably represents hydrogen, cyano, carbamoyl, thiocarbamoyl, fluorine, chlorine, bromine, or represents in each case optionally cyano-, fluorine-, chlorine-, bromine-, methoxy- or ethoxy-substituted methyl, ethyl, n- or i-propyl, acetyl, propionyl, n- or i-butyroyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl or ethylsulfonyl.
R¹¹ particularly preferably represents hydrogen, represents in each case optionally cyano-, fluorine-, chlorine-, bromine-, methoxy- or ethoxy-substituted methyl, ethyl, n- or i-propyl, or represents in each case optionally cyano-, fluorine-, chlorine-, bromine-, methyl- or ethyl-substituted cyclopropyl.
R¹² particularly preferably represents hydrogen, represents in each case optionally cyano-, fluorine-, chlorine-, bromine-, methoxy- or ethoxy-substituted methyl, ethyl, n- or i-propyl, or represents in each case optionally cyano-, fluorine-, chlorine-, bromine-, methyl- or ethyl-substituted cyclopropyl.
R¹³ particularly preferably represents hydrogen, cyano, carbamoyl, fluorine, chlorine, bromine, or represents in each case optionally cyano-, fluorine-, chlorine-, bromine-, methoxy- or ethoxy-substituted methyl, ethyl, n- or i-propyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl or ethylsulfonyl.

A “group 1a” of compounds which is very particularly preferred as active compound components of group 1 are those compounds of the formula (I) in which
A represents methylene or dimethylene,
R¹ represents one of the groupings below 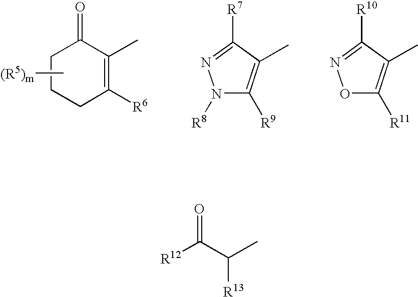
R² represents hydrogen, nitro, cyano, fluorine, chlorine, bromine, iodine, methyl, ethyl, drifluoromethyl, dichloromethyl, trichloromethyl, methoxymethyl, methylthiomethyl, methylsulfinylmethyl, methyl-sulfonylmethyl, methoxy, ethoxy, difluoromethoxy, trifluoromethoxy, methylthio, ethylthio, m ethylsulfinyl, ethylsulfinyl, methylsulfony, ethylsulfonyl or dimethylaminosulfonyl,
R³ represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl or dimethylaminosulfonyl,
R⁴ represents the heterocyclic grouping below 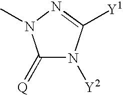
   in which
   Q represents oxygen or sulfur,
   Y¹ represents hydrogen, chlorine, bromine, iodine, represents in each case optionally fluorine-, chlorine-, methoxy-, ethoxy-, n- or i-propoxy-, methylthio-, ethylthio-, methylsulfinyl-, ethylsulfinyl-, methylsulfonyl- or ethylsulfonyl-substituted methyl, ethyl, n- or i-propyl, methoxy, ethoxy, n- or i-propoxy, methylthio, ethylthio, n- or i-propylthio, methylsulfinyl, ethylsulfinyl, n- or i-propylsulfinyl, methylsulfonyl, ethylsulfonyl, n- or i-propylsulfonyl, represents methylamino, ethylamino, n- or i-propylamino, dimethylamino or diethylamino, represents in each case optionally fluorine- and/or chlorine-substituted ethenyl, propenyl, ethinyl, propinyl, propenyloxy, propenylthio or propenylamino, represents in each case optionally fluorine- and/or chlorine-substituted cyclopropyl, cyclopropyloxy, cyclopropylamino, cyclopropylmethyl, cyclopropylmethoxy or cyclopropylmethylamino, or represents in each case optionally fluorine-, chlorine-, methyl-, ethyl-, n- or i-propyl-, methoxy-, ethoxy-, n- or i-propoxy-substituted phenyl, phenyloxy, phenylthio, phenylamino, benzyl, benzyloxy, benzylthio or benzylamino, and
   Y² represents hydrogen, amino, represents in each case optionally fluorine- and/or chlorine-, methoxy- or ethoxy-substituted methyl, ethyl, n- or i-propyl, methoxy, ethoxy, n- or i-propoxy, methylamino, ethylamino or dimethylamino, represents propenyl or propinyl, represents in each case optionally fluorine- and/or chlorine-substituted cyclopropyl, cyclobutyl or cyclopropylmethyl, or represents in each case optionally fluorine-, chlorine-, methyl, ethyl-, n- or i-propyl-, methoxy-, ethoxy-, n- or i-propoxy-substituted phenyl or benzyl, or together with the radical Y¹ represents in each case optionally methyl- and/or ethyl-substituted propane-1,3-diyl (trimethylene) or butane-1,4-diyl (tetramethylene),
m represents the numbers 0, 1 or 2,
R⁵ represents in each case optionally fluorine- or chlorine-substituted methyl, ethyl, n- or i-propyl, methoxycarbonyl, ethoxycarbonyl, methylthio, ethylthio, n- or i-propylthio, represents phenyl, or optionally also—if m represents 2—together with a second radical R⁵ represents ethane-1,2-diyl (dimethylene), propane-1,3-diyl (trimethylene) or butane-1,4-diyl (tetramethylene),
R⁶ represents hydroxyl, formyloxy, represents in each case optionally fluorine-, chlorine-, methoxy- or ethoxy-substituted methoxy, ethoxy, n- or i-propoxy, methylthio, ethylthio, n- or i-propylthio, methylsulfinyl, ethylsulfinyl, methylsulfonyl, ethylsulfonyl, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, n- or i-propylsulfonyloxy, represents propenyloxy or propinyloxy, or represents in each case optionally nitro-, cyano-, fluorine-, chlorine-, bromine-, methyl-, ethyl-, n- or i-propyl-, trifluoromethyl, methoxy-, ethoxy-, n- or i-propoxy-, difluoromethoxy- or trifluoromethoxy-substituted phenoxy, phenylthio, phenylsulfinyl, phenylsulfonyl, benzoyloxy, benzoylmethoxy, phenylsulfonyloxy, phenylmethoxy phenylmethylthio, phenylmethylsulfinyl or phenylmethylsulfonyl,
R⁷ represents hydrogen, cyano, fluorine, chlorine, bromine, represents in each case optionally fluorine-, chlorine-, methoxy- or ethoxy-substituted methyl, ethyl, n- or i-propyl, methoxy, ethoxy, n- or i-propoxy, methylthio, ethylthio, n- or i-propylthio, methylsulfinyl, ethylsulfinyl, n- or i-propylsulfinyl, methylsulfonyl, ethylsulfonyl, n- or i-propylsulfonyl, methoxycarbonyl, ethoxycarbonyl, n- or i-propoxycarbonyl,
R⁸ represents hydrogen, represents in each case optionally cyano-, fluorine-, chlorine-, methoxy- or ethoxy-substituted methyl, ethyl, n- or i-propyl, represents in each case optionally fluorine- or chlorine-substituted propenyl or propinyl, represents optionally fluorine-, chlorine-, bromine-, methyl- or ethyl-substituted cyclopropyl, or represents in each case optionally fluorine-, chlorine-, bromine-, methyl-, ethyl-, n- or i-propyl-, trifluoromethyl-, methoxy-, ethoxy-, n- or i-propoxy-, difluoromethoxy- or trifluoromethoxy-, substituted phenyl or benzyl,
R⁹ represents hydroxyl, formyloxy, represents in each case optionally cyano-, fluorine-, chlorine-, bromine-, methoxy-, ethoxy-, n- or i-propoxy-substituted methoxy, ethoxy, n- or i-propoxy, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, n- or i-propylsulfonyloxy, represents propenyloxy or propinyloxy, or represents in each case optionally nitro-, cyano-, fluorine-, chlorine-, bromine-, methyl-, ethyl-, n- or i-propyl-, trifluoromethyl-, methoxy-, ethoxy-, n- or i-propoxy-, difluoromethoxy- or trifluoromethoxy-substituted phenylmethoxy, benzoyloxy, benzoylmethoxy or phenylsulfonyloxy,
R¹⁰ represents hydrogen, cyano, fluorine, chlorine, bromine, or represents in each case optionally fluorine-, chlorine-, methoxy-, ethoxy-, n- or i-propoxy-substituted methyl, ethyl, n- or i-propyl, acetyl, propionyl, n- or i-butyroyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl or ethylsulfonyl,
R¹¹ represents hydrogen, represents in each case optionally fluorine-, chlorine-, bromine-, methoxy- or ethoxy-substituted methyl, ethyl, n- or i-propyl, or represents optionally fluorine-, chlorine-, bromine-, methyl- or ethyl-substituted cyclopropyl,
R¹² represents hydrogen, represents in each case optionally fluorine-, chlorine-, methoxy- or ethoxy-substituted methyl, ethyl, n- or i-propyl, or represents optionally fluorine-, chlorine-, bromine-, methyl- or ethyl-substituted cyclopropyl, and
R¹³ represents hydrogen, cyano, fluorine, chlorine, bromine, or represents in each case optionally fluorine-, chlorine-, bromine-, methoxy- or ethoxy-substituted methyl, ethyl,- n- or i-propyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, n- or i-propylsulfinyl, methylsulfonyl, ethylsulfonyl, n- or i-propylsulfonyl.

A “group 1b” of compounds which is very particularly preferred as active compound components of group 1 are those compounds of the formula (I), in which
A, R¹, R² and R³ have the meanings given above as being very particularly preferred for the compounds of “group 1a” and
R⁴ represents the heterocyclic grouping below, 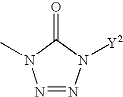
   in which
   Y² represents hydrogen, represents in each case optionally fluorine- and/or chlorine-, methoxy- or ethoxy-substituted methyl, ethyl, n- or i-propyl, represents ethenyl, propenyl or propinyl, represents in each case optionally fluorine- and/or chlorine-substituted cyclopropyl, cyclobutyl, cyclopentyl, cyclohexyl, cyclopropylmethyl, cyclopentylmethyl or cyclohexylmethyl, or represents in each case optionally fluorine-, chlorine-, methyl-, ethyl-, n- or i-propyl-, methoxy-, ethoxy-, n- or i-propoxy-substituted phenyl or benzyl.

A “group 1c” which is very particularly preferred as active compound components of group 1 are those compounds of the formula (I), in which
A, R¹, R² and R³ have the meanings given above as being very particularly preferred for the compounds of “group 1a” and
R⁴ represents the heterocyclic grouping below, 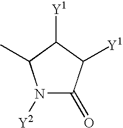
   in which
   Y¹ represents hydrogen or represents in each case optionally fluorine-, chlorine-, methoxy- or ethoxy-substituted methyl or ethyl and
   Y² represents hydrogen, represents in each case optionally fluorine- and/or chlorine-, methoxy- or ethoxy-substituted methyl, ethyl, n- or i-propyl, represents propenyl or propinyl, represents in each case optionally fluorine- and/or chlorine-substituted cyclopropyl, cyclobutyl, cyclopentyl, cyclohexyl, cyclopropylmethyl, cyclopentylmethyl or cyclohexylmethyl, or represents in each case optionally fluorine-, chlorine-, methyl-, ethyl-, methoxy- or ethoxy-substituted phenyl or benzyl.

A “group 1d” which is very particularly preferred as active compound components of group 1 are those compounds of the formula (I), in which
A, R¹, R² and R³ have the meanings given above as being very particularly preferred for the compounds of “group 1” and
R⁴ represents one of the heterocyclic groupings below, 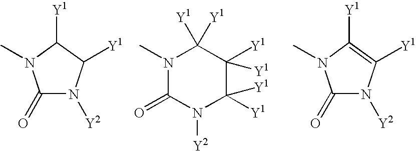
   in which
   Y¹ represents hydrogen, fluorine, chlorine, represents in each case optionally fluorine-, chlorine-, methoxy- or ethoxy-substituted methyl or ethyl, or—if two adjacent radicals Y¹ and Y¹ are located at a double bond—together with the adjacent radical Y¹ also represents a benzo grouping, and
   Y² represents hydrogen, represents in each case optionally fluorine- and/or chlorine-, methoxy- or ethoxy-substituted methyl, ethyl, n- or i-propyl, represents propenyl or propinyl, represents in each case optionally fluorine- and/or chlorine-substituted cyclopropyl, cyclobutyl, cyclopentyl, cyclohexyl, cyclopropylmethyl, cyclopentylmethyl or cyclohexylmethyl, or represents in each case optionally fluorine-, chlorine-, methyl-, ethyl-, methoxy- or ethoxy-substituted phenyl or benzyl, or together with an adjacent radical Y¹ represents in each case optionally methyl- and/or ethyl-substituted propane-1,3-diyl (trimethylene) or butane-1,4-diyl (tetramethylene),
   where the individual radicals Y¹ and Y², if a plurality of these radicals is attached to the same heterocyclic groupings, may have identical or different meanings within the scope of the above definition. T

he compounds of the general formulae (I-A) to (I-C) are particularly emphasized as active compound components of group 1:

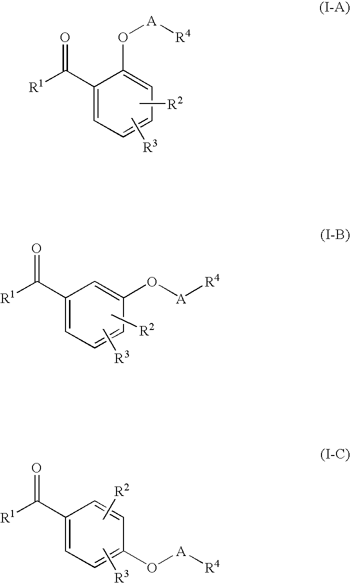

Here, A, R¹, R², R³ and R⁴ each preferably have the meanings given above as being preferred, particularly preferred or very particularly preferred.

Compounds of the general formulae (I-A1) to (I-A4), of the general formulae (I-B1) to (I-B4) and of the general formulae (I-C1) to (I-C4) are furthermore very particularly emphasized as active compound components of group 1:

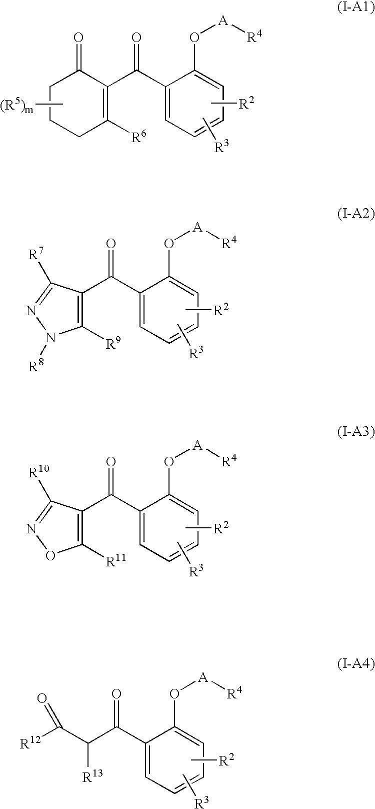

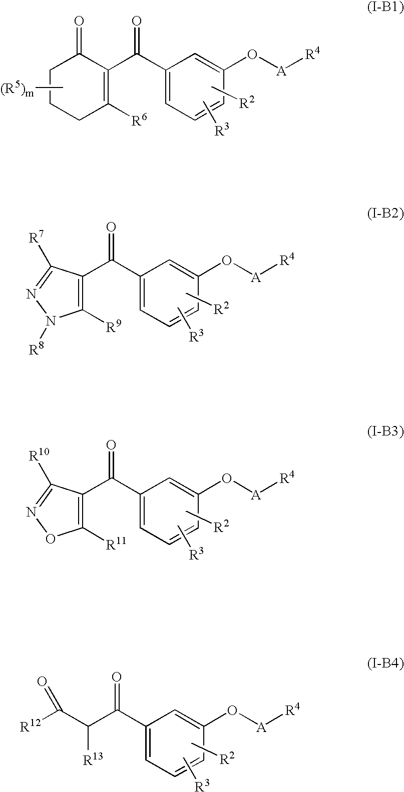

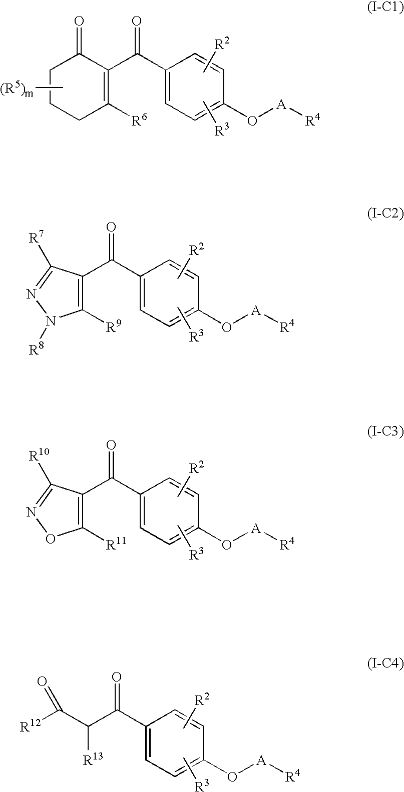

Here, m, A, R², R³, R⁴, R⁵, R⁶, R⁷, R⁸, R⁹, R¹⁰, R¹¹, R¹² and R¹³ each preferably have the meanings given above as being preferred, particularly preferred or very particularly preferred.

Examples of the compounds of the formula (I) which are very particularly preferred as active compound components according to the invention are listed in Table 1 below.

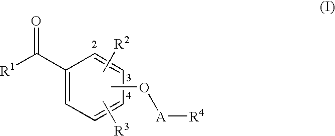

Table 1: Examples of the active compound components of the formula (I)

TABLE 1
Examples of the active compound components of the formula (I)

| | | (position) | (position) | (position) |
|---|---|---|---|---|
| Example No. | R¹ | R² | R³ | —O—A—R⁴ |
| I-1 | 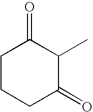 | (2) NO₂ | (4) CH₃ | 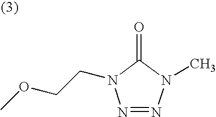 |
| I-2 | 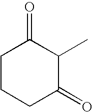 | (2) Cl | (4) Cl | 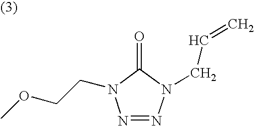 |
| I-3 | 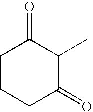 | (2) Br | (4) CH₃ | 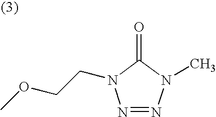 |
| I-4 | 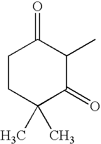 | (2) Cl | (4) Cl | 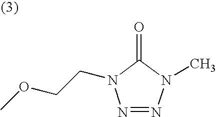 |
| I-5 | 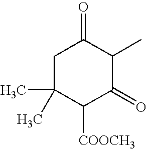 | (2) Cl | (4) Cl | 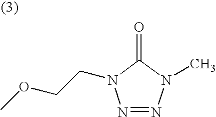 |
| I-6 | 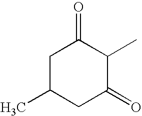 | (2) Cl | (4) Cl | 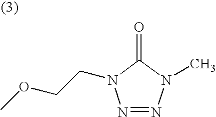 |
| I-7 | 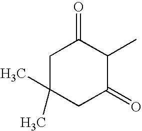 | (2) Cl | (4) Cl | 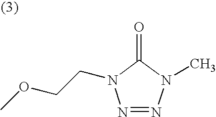 |
| I-8 | 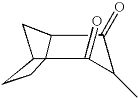 | (2) Br | (4) Br | 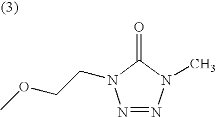 |
| I-9 | 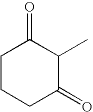 | (2) Br | (4) CN | 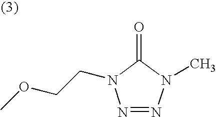 |
| I-10 | 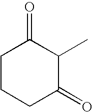 | (2) Cl | (4) CH₃ | 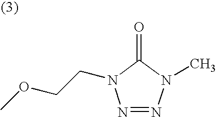 |
| I-11 | 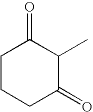 | (2) Cl | (4) SO₂CH₃ | 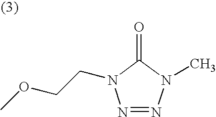 |
| I-12 | 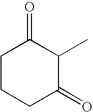 | (2) Cl | (4) Br | 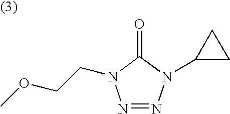 |
| I-13 | 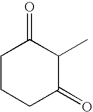 | (2) Br | (4) Br | 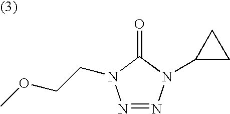 |
| I-14 | 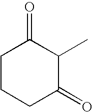 | (2) CH₃ | (4) Br | 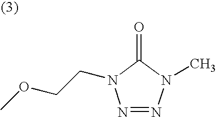 |
| I-15 | 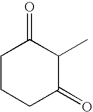 | (2) Cl | (4) SCH₃ | 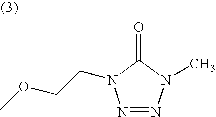 |
| I-16 | 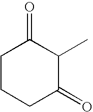 | (2) Cl | (4) Cl | 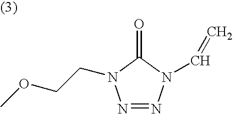 |
| I-17 | 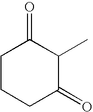 | (2) Cl | (4) Cl | 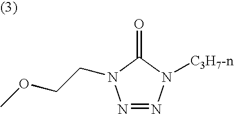 |
| I-18 | 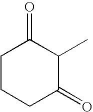 | (2) Cl | (4) Cl | 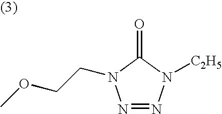 |
| I-19 | 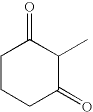 | (2) CH₃ | (4) Cl | 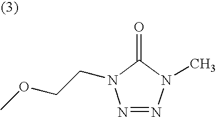 |
| I-20 | 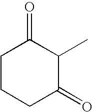 | (2) Cl | (4) Cl | 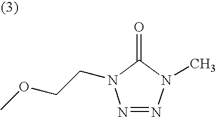 |
| I-21 | 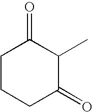 | (2) Br | (4) Br | 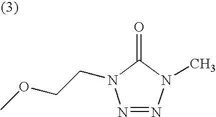 |
| I-22 | 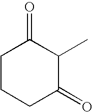 | (2) Cl | (4) Cl | 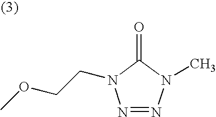 |
| I-23 | 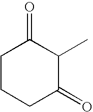 | (2) Cl | (4) 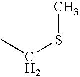 | 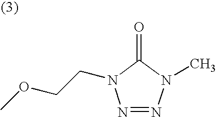 |
| I-24 | 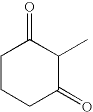 | (2) SCH₃ | (4) CH₃ | 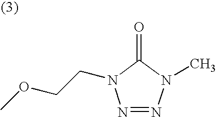 |
| I-25 | 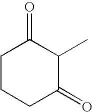 | (2) Cl | (4) 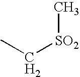 | 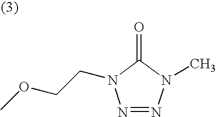 |
| I-26 | 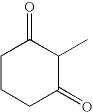 | (2) CH₃ | (4) SO₂CH₃ | 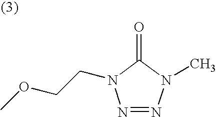 |
| I-27 | 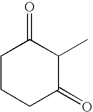 | (2) CN | (4) CH₃ | 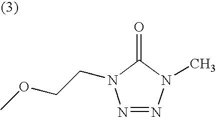 |
| I-28 | 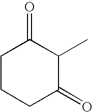 | (2) NO₂ | (4) 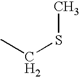 | 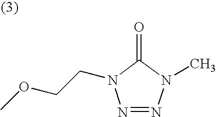 |
| I-29 | 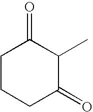 | (2) NO₂ | (4) 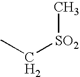 | 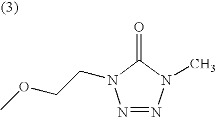 |
| I-30 | 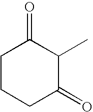 | (2) Br | (4) Cl | 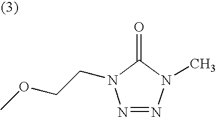 |
| I-31 | 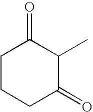 | (2) Br | (4) Br | 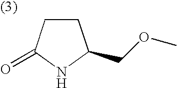 |
| I-32 | 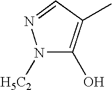 | (2) Br | (4) Br | 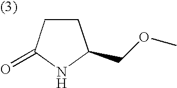 |
| I-33 | 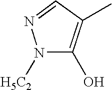 | (2) Cl | (4) Cl | 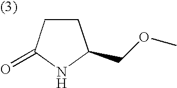 |
| I-34 | 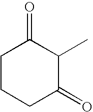 | (2) Cl | (4) Cl | 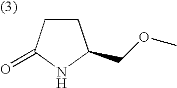 |
| I-35 | 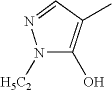 | (2) CH₃ | (4) Br | 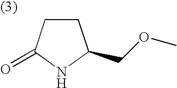 |
| I-36 | 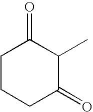 | (2) Br | (4) Br | 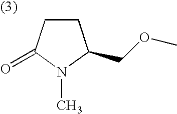 |
| I-37 | 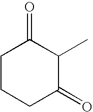 | (2) Cl | (4) Cl | 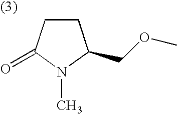 |
| I-38 | 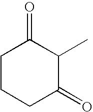 | (2) Cl | (4) Cl | 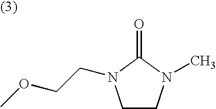 |
| I-39 | 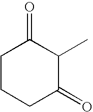 | (2) Br | (4) Br | 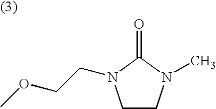 |
| I-40 | 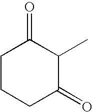 | (2) Cl | (4) SO₂CH₃ | 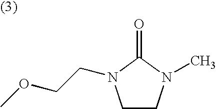 |
| I-41 | 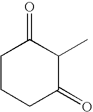 | (2) Cl | (4) Cl | 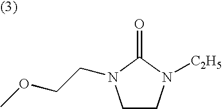 |
| I-42 | 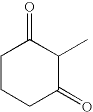 | (2) Br | (4) Br | 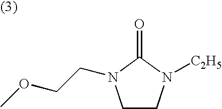 |
| I-43 | 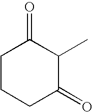 | (2) Cl | (4) SO₂CH₃ | 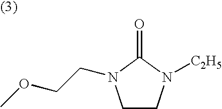 |
| I-44 | 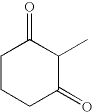 | (2) Cl | (4) Cl | 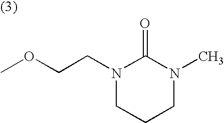 |
| I-45 | 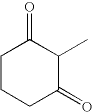 | (2) Br | (4) Br | 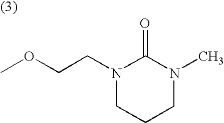 |
| I-46 | 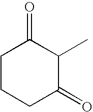 | (2) Cl | (4) SO₂CH₃ | 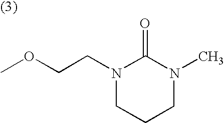 |
| I-47 | 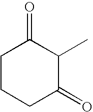 | (2) Cl | (4) Cl | 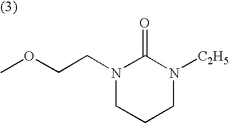 |
| I-48 | 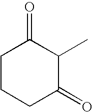 | (2) Br | (4) Br | 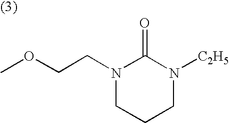 |
| I-49 | 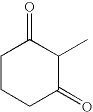 | (2) Cl | (4) SO₂CH₃ | 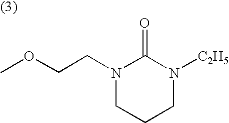 |
| I-50 | 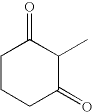 | (2) CL | (4) Cl | 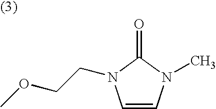 |
| I-51 | 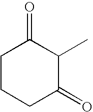 | (2) Br | (4) Br | 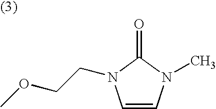 |
| I-52 | 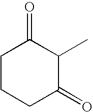 | (2) Cl | (4) SO₂CH₃ | 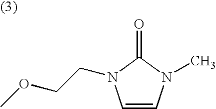 |
| I-53 | 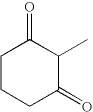 | (2) Cl | (4) Cl | 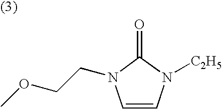 |
| I-54 | 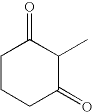 | (2) Br | (4) Br | 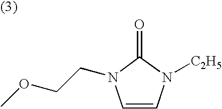 |
| I-55 | 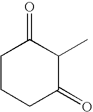 | (2) Cl | (4) SO₂CH₃ | 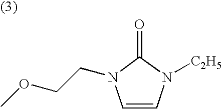 |
| I-56 | 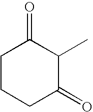 | (2) Cl | (4) Cl | 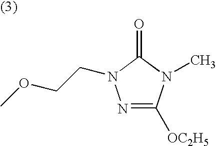 |
| I-57 | 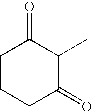 | (2) Cl | (4) Cl | 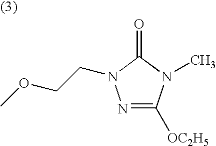 |
| I-58 | 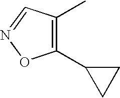 | (2) Cl | (4) Cl | 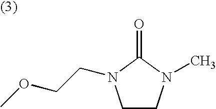 |
| I-59 | 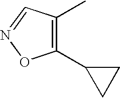 | (2) Cl | (4) Cl | 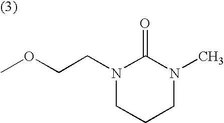 |
| I-60 | 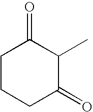 | (2) Br | (4) Br | 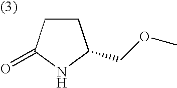 |
| I-61 | 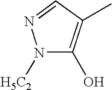 | (2) Br | (4) Br | 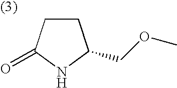 |
| I-62 | 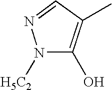 | (2) Cl | (4) Cl | 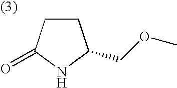 |
| I-63 | 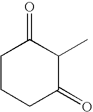 | (2) Cl | (4) Cl | 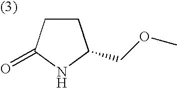 |
| I-64 | 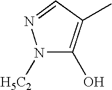 | (2) CH₃ | (4) Br | 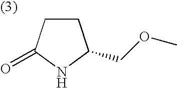 |
| I-65 | 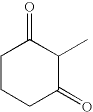 | (2) Br | (4) Br | 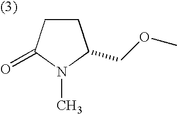 |
| I-66 | 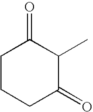 | (2) Cl | (4) Cl | 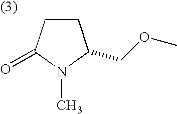 |
| I-67 | 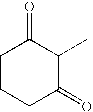 | (2) Br | (4) Br | 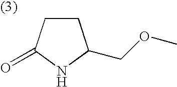 |
| I-68 | 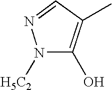 | (2) Br | (4) Br | 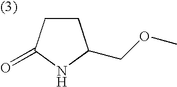 |
| I-69 | 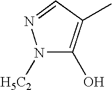 | (2) Cl | (4) Cl | 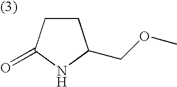 |
| I-70 | 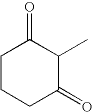 | (2) Cl | (4) Cl | 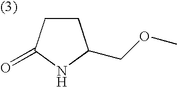 |
| I-71 | 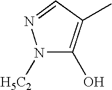 | (2) Br | (4) Br | 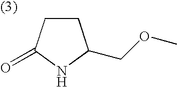 |
| I-72 | 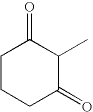 | (2) Br | (4) Br | 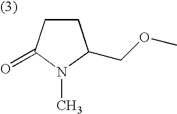 |
| I-73 | 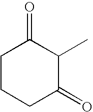 | (2) Cl | (4) Cl | 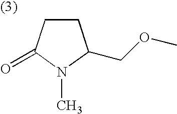 |
| I-74 | 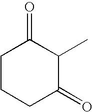 | (2) Cl | (4) Cl | 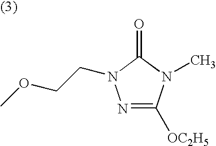 |
| I-75 | 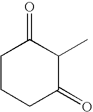 | (2) Cl | (4) Cl | 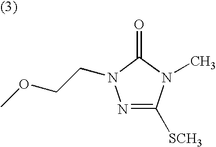 |
| I-76 | 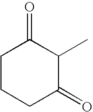 | (2) Cl | (4) Cl | 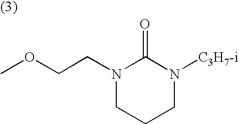 |
| I-77 | 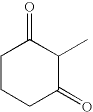 | (2) Br | (4) Br | 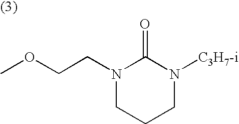 |
| I-78 | 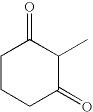 | (2) Cl | (4) SO₂CH₃ | 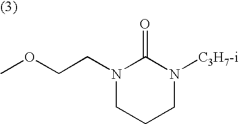 |
| I-79 | 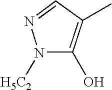 | (2) Cl | (4) Cl | 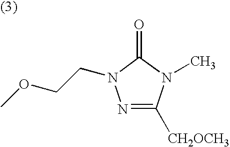 |
| I-80 | 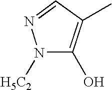 | (2) CH₃ | (4) Cl | 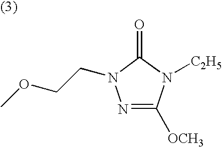 |
| I-81 | 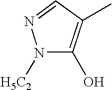 | (2) CH₃ | (4) Cl | 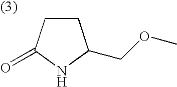 |
| I-82 | 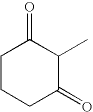 | (2) Cl | (4) Cl | 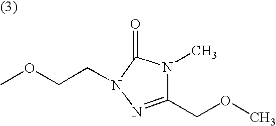 |

In each case, only one of the possible keto-enol tautomers is shown.

The compound 3-[2,4-dibromo-3-[2-(4-methyl-5-oxo-5-dihydro-1H-tetrazol-1-yl)-ethoxy]-benzoyl]-bicyclo[3.2.1]octane-2,4-dione (Example I-8 in Table 1) is particularly emphasized as mixing component of the formula (I).

The compound 2-[2,4dibromo-3-[2-(4-methyl-5-oxo-4,5-dihydro-1H-tetrazol-1-yl)-ethoxy]-benzoyl]-1,3cyclohexanedione (Example I-21 in Table 1) is likewise particularly emphasized as mixing component of the formula (I).

The compound 2-[2-chloro-4-methylsulphonyl-3-[2-(4-methyl-5-oxo-4,5-dihydro-1H-tetrazol-1-yl)-ethoxy]-benzoyl]-1,3-cyclohexanedione (Example I-11 in Table 1) is likewise particularly emphasized as mixing component of the formula (I).

The compound 2-[2,4-dichloro-3-[2-(4-methyl-5-oxo-4,5-dihydro-1H-tetrazol-1-yl)-ethoxy]-benzoyl]-1,3-cyclohexanedione (Example I-22 in Table 1) is likewise particularly emphasized as mixing component of the formula (I).

The compound (5S)-5-[[2,6-dibromo-3-[(2,6-dioxo-1-cyclohexyl)-carbonyl]-phenoxy]-methyl]-2-pyrrolidinone (Example I-31 in Table 1) is likewise particularly emphasized as mixing component of the formula (I).

The compound (5S)-5-[[2,6-dibromo-3-[(1-ethyl-5-hydroxy-1H-pyrazol-4-yl)-carbonyl]-phenoxy]-methyl]-2-pyrrolidinone (Example I-32 in Table 1) is likewise particularly emphasized as mixing component of the formula (I).

The compound (5S)-5-[[2,6-dichloro-3-[(1-ethyl-5-hydroxy-1H-pyrazol-4-yl)-carbonyl]-phenoxy]-methyl]-2-pyrrolidinone (Example I-33 in Table 1) is likewise particularly emphasized as mixing component of the formula (I).

The compound (5S)-5-[[2,6-dichloro-3-[(2,6-dioxo-1-cyclohexyl)-carbonyl]-phenoxy]-methyl]-2-pyrrolidinone (Example I-34 in Table 1) is likewise particularly emphasized as mixing component of the formula (I).

The compound (5S)-5-[[6-bromo-3-[(1-ethyl-5-hydroxy-1H-pyrazol-4-yl)-carbonyl]-2-methyl-phenoxy]-methyl]-2-pyrrolidinone (Example I-35 in Table 1) is likewise particularly emphasized as mixing component of the formula (I).

The compound (5S)-5-[[2,6-dibromo-3-[(2,6-dioxo-1cyclohexyl)-carbonyl]-phenoxy]-methyl]-1-methyl-2-pyrrolidinone (Example I-36 in Table 1) is likewise particularly emphasized as mixing component of the formula (I).

The compound (5R)-5-[[2,6dibromo-3-[(2,6-dioxo-1-cyclohexyl)-carbonyl]-phenoxy]-methyl]-2-pyrrolidinone (Example I-60 in Table 1) is likewise particularly emphasized as mixing component of the formula (I).

The compound 2-[2-[2,6-dichloro-3-[(1-ethyl-5-hydroxy-1H-pyrazolyl)-carbonyl]-phenoxy]-ethyl]-5-methoxymethyl-4-methyl-2,4-dihydro-3H-1,2,4-triazol-3-one (Example 79 in Table 1) is likewise particularly emphasized as mixing component of the formula (I).

The compound 2-[2-[6-chloro-3-[(1-ethyl-5-hydroxy-1H-pyrazol-4-yl)-carbonyl]-2-methyl-phenoxy]-ethyl]-5-methoxymethyl-4-methyl-2,4-dihydro-3H-1,2,4-triazol-3-one (Example 80 in Table 1) is likewise particularly emphasized as mixing component of the formula (I).

The compound (5R/S)-5-[[6-chloro-3-[(1-ethyl-5-hydroxy-1H-pyrazol-4-yl)-carbonyl]-2-methyl-phenoxy]-methyl]-2-pyrrolidinone (Example I-81 in Table 1) is likewise particularly emphasized as mixing component of the formula (I).

The compounds of the formula (I) are described in the abovementioned patent applications for substituted aryl ketones.

According to their chemical structure, the active compounds of group 2 can be assigned to the following classes of active compounds:

amides (for example isoxaben, picolinafen, propanil), arylheterocycles (for example azafenidin, benzfendizone, butafenacil-allyl, carfentrazone-ethyl, cinidon-ethyl, fluazolate, flumiclorac-pentyl, flumioxazin, flupropacil, fluthiacet-methyl, oxadiazon, oxadiargyl, profluazol, pyraflufen-ethyl, pyridate, pyridafol, sulfentrazone, thidiazimin, 4-[4,5-dihydro-4-methyl-5-oxo-(3-trifluoromethyl)-1H-1,2,4-triazol-1-yl]-2-[(ethylsulfonyl)amino]-5-fluoro-benzenecarbothioamide), aryloxyphenoxypropionates (for example clodinafop-propargyl, cyhalofop-butyl, diclofop-methyl, fenoxaprop-P-ethyl, fluazifop-P-butyl, haloxyfop-R-methyl, quizalofop-P-ethyl), carboxylic acid derivatives (for example clopyralid, dicamba, fluroxypyr, picloram, triclopyr), benzothiadiazoles (for example bentazone), chloroacetamides (for example acetochlor, alachlor, butachlor, (S-) dimethenamid, metazachlor, metolachlor, pretilachlor, propachlor, propisochlor), cyclohexanediones (for example butroxydim, clefoxydim, cycloxydim, sethoxydim, tralkoxydim), dinitroanilines (for example benfluralin, ethalfluralin, oryzalin, pendimethalin, trifluralin), diphenyl ethers (for. example acifluorfen-sodium, aclonifen, bifenox, fluoroglycofen-ethyl, fomesafen, lactofen, oxyfluorfen), ureas (for example chlortoluron, diuron, isoproturon, linuron, metobromuron, metoxuron), imidazolinones (for example imazamethabenz-methyl, imazamox, imazaquin, imazethapyr), isoxazoles (for example isoxaflutole), nicotinanilides (for example diflufenican), nitriles (for example bromoxynil, ioxynil), organophosphorus compounds (for example anilofos, glufosinate-ammonium, glyphosate-isopropylammonium, sulfosate), oxyacetamides (for example flufenacet, mefenacet), phenoxycarboxylic acid derivatives (for example 2,4-D, dichlorprop-P, MCPA, MCPB, mecoprop), pyrazoles (for example pyrazolate, pyrazoxyfen), pyridazinones (for example norflurazon), pyridines (for example dithiopyr, thiazopyr), pyrimidinyl(thio)benzoates (for example bispyribac, pyribenzoxim, pyrithiobac, pyriminobac), sulfonylureas (for example amidosulfuron, azimsulfuron, bensulfuron- methyl, chlorimuron-ethyl, chlorsulfuron, cinosulfuron, cyclosulfamuron, ethoxysulfuron, flupyrsulfuron-methyl-sodium, foramsulfuron, iodosulfuron-methyl-sodium, imazosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, trifloxysulfuron, triflusulfuron-methyl, tritosulfuron), tetrazolinones (for example fentrazamide), thiocarbamates (for example butylate, dimepiperate, EFTC, esprocarb, molinate, orbencarb, prosulfocarb, triallate), triazines (for example ametryn, atrazine, cyanazine, dimexyflam, simazine, terbuthylazine, terbutryn), triazinones (for example hexazinone, metamitron, metribuzin), triazoles (for example amitrole), triazolinones (for example amicarbazone, flucarbazone-sodium, propoxycarbazone-sodium) triazolopyrimidines (for example cloransulam-methyl, diclosulam, florasulam, flumetsulam, metosulam), triketones (for example mesotrione, sulcotrione), uracils (for example bromacil).

Mixing components from the active compounds of group2 which are particularly emphasized are:

fentrazamide, flufenacet, acetochlor, alachlor, amicarbazone, amidosulfuron, anilofos, atrazine, azimsulfuron, benfuresate, bensulfuron-methyl, bentazone, benthiocarb (thiobencarb), benzobicyclon, benzofenap, bifenox, bispyribac-sodium, bromobutide, butachlor, butamifos, butenachlor, cafenstrole, carfentrazone-ethyl, chlomethoxyfen, chlornitrofen, cinmethylin, cinosulfuron, clefoxydim, clodinafop-propargyl, clomazone, clomeprop, cumyluron, cyanazine, cyclosulfamuron, cyhalofop-butyl, 2,4-D, dichlorprop-P, diethatyl-ethyl, dimepiperate, dimethametryn, dimethenamid, S-dimethenamid, dithiopyr, dymron, (daimuron, dimuron), esprocarb, ethoxysulfuron, etobenzanid, fenoxaprop-(P)-ethyl, fluazifop-P-butyl, flucarbazone-sodium, flumetsulam, halosulfuron-methyl, haloxyfop-P-methyl, HOK-201, imazamox, imazaquin, imazethapyr, imazosulfuron, indanofan, isoxaflutole, MCPA, mefenacet, mesosulfuron, mesotrione, metolachlor, S-metolachlor, metosulam, metsulfuron-methyl, metribuzin, molinate, naproanilide, nicosulfuron, OK-701, oxadiargyl, oxadiazon, oxaziclomefone, oxyfluorfen, pendimethalin, pentoxazone, piperophos, pretilachlor, profoxydim, propanil, propoxycarbazone-sodium, pyraclonil, pyrazolate, pyrazosulfuron-ethyl, pyrazoxyfen, pyribenzoxim, pyributicarb, pyriftalid, pyriminobac-methyl, qinclorac, quinoclamine, simazine, simetryn, sulcotrione, terbuthylazine, thenylchlor, thifensulfuron-methyl, tiocarbazil, tritosulfuron.

The compositions according to the invention preferably comprise one or two active compounds of group 1 and additionally 1, 2, 3 or 4 active compounds of group 2 and/or one active compound of group 3.

The compositions according to the invention particularly preferably comprise one active compound of group 1 and in addition 1, 2 or 3 active compounds of group 2 and/or one active compound of group 3.

The compositions according to the invention very particularly preferably comprise one active compound of group 1 and one or two active compounds of group 2 and/or one active compound of group 3.

Examples of combinations according to the invention of in each case one active compound of group 1 and additionally 1, 2 or 3 active compounds of group 2 and/or compound of group 3—are listed below in table 2. Here, the names of the active compounds of the formula (I) (active compounds of group 1) are in each case taken from table 1.

TABLE 2
Examples of combinations comprising one active compound
of group 1 and 1, 2 or 3 active compounds of group 2 and/or one
compound of group 3

| Active compound | |
|---|---|
| of group 1 | Active compounds of groups 2 and/or 3 |
| (I-11) | acetochlor |
| (I-11) | acetochlor + dichlormid |
| (I-11) | acetochlor + furilazole |
| (I-11) | acetochlor + R-29148 |
| (I-11) | alachlor |
| (I-11) | amicarbazone |
| (I-11) | amidosulfuron |
| (I-11) | anilofos |
| (I-11) | anilofos + 2,4-D |
| (I-11) | anilofos + propanil |
| (I-11) | anilofos + quinoclamine |
| (I-11) | atrazine |
| (I-11) | azimsulfuron |
| (I-11) | azimsulfuron + dymron |
| (I-11) | azimsulfuron + anilofos |
| (I-11) | azimsulfuron + benfuresate |
| (I-11) | azimsulfuron + bensulfuron |
| (I-11) | azimsulfuron + butachlor |
| (I-11) | azimsulfuron + cafenstrole |
| (I-11) | azimsulfuron + cyhalofop-butyl |
| (I-11) | azimsulfuron + dimepiperate |
| (I-11) | azimsulfuron + esprocarb |
| (I-11) | azimsulfuron + mefenacet |
| (I-11) | azimsulfuron + indanofan |
| (I-11) | azimsulfuron + oxaziclomefone |
| (I-11) | azimsulfuron + pretilachlor |
| (I-11) | azimsulfuron + thenylchlor |
| (I-11) | azimsulfuron + anilofos + dymron |
| (I-11) | azimsulfuron + benfuresate + dymron |
| (I-11) | azimsulfuron + bensulfuron + cafenstrole |
| (I-11) | azimsulfuron + bensulfuron + cyhalofop-butyl |
| (I-11) | azimsulfuron + bensulfuron + dymron |
| (I-11) | azimsulfuron + bensulfuron + dimethametryn |
| (I-11) | azimsulfuron + bensulfuron + indanofan |
| (I-11) | azimsulfuron + bensulfuron + pretilachlor |
| (I-11) | azimsulfuron + bensulfuron + thenylchlor |
| (I-11) | azimsulfuron + butachlor + dymron |
| (I-11) | azimsulfuron + cafenstrole + dymron |
| (I-11) | azimsulfuron + cyhalofop-butyl + dymron |
| (I-11) | azimsulfuron + mefenacet + dymron |
| (I-11) | azimsulfuron + oxaziclomefone + dymron |
| (I-11) | azimsulfuron + pretilachlor + dymron |
| (I-11) | benfuresate |
| (I-11) | bensulfuron-methyl |
| (I-11) | bensulfuron-methyl + dymron |
| (I-11) | bensulfuron-methyl + anilofos |
| (I-11) | bensulfuron-methyl + benfuresate |
| (I-11) | bensulfuron-methyl + butachlor |
| (I-11) | bensulfuron-methyl + cafenstrole |
| (I-11) | bensulfuron-methyl + cyhalofop-butyl |
| (I-11) | bensulfuron-methyl + dimepiperate |
| (I-11) | bensulfuron-methyl + dithiopyr |
| (I-11) | bensulfuron-methyl + esprocarb |
| (I-11) | bensulfuron-methyl + indanofan |
| (I-11) | bensulfuron-methyl + mefenacet |
| (I-11) | bensulfuron-methyl + metsulfuron-methyl |
| (I-11) | bensulfuron-methyl + molinate |
| (I-11) | bensulfuron-methyl + oxaziclomefone |
| (I-11) | bensulfuron-methyl + pretilachlor |
| (I-11) | bensulfuron-methyl + pyributicarb |
| (I-11) | bensulfuron-methyl + quinclorac |
| (I-11) | bensulfuron-methyl + thenylchlor |
| (I-11) | bensulfuron-methyl + anilofos + dymron |
| (I-11) | bensulfuron-methyl + benfuresate + dymron |
| (I-11) | bensulfuron-methyl + butachlor + dymron |
| (I-11) | bensulfuron-methyl + benfuresate + dimepiperate |
| (I-11) | bensulfuron-methyl + benfuresate + pretilachlor |
| (I-11) | bensulfuron-methyl + cafenstrole + dymron |
| (I-11) | bensulfuron-methyl + cafenstrole + cyhalofop-butyl |
| (I-11) | bensulfuron-methyl + cyhalofop-butyl + dymron |
| (I-11) | bensulfuron-methyl + cyhalofop-butyl + thenylchlor |
| (I-11) | bensulfuron-methyl + dithiopyr + quinclorac |
| (I-11) | bensulfuron-methyl + mefenacet + dymron |
| (I-11) | bensulfuron-methyl + mefenacet + benthiocarb |
| (I-11) | bensulfuron-methyl + mefenacet + molinate |
| (I-11) | bensulfuron-methyl + oxaziclomefone + dymron |
| (I-11) | bensulfuron-methyl + pretilachlor + dymron |
| (I-11) | bensulfuron-methyl + pyributicarb + dymron |
| (I-11) | bentazone |
| (I-11) | bentazone + quinclorac |
| (I-11) | benthiocarb (thiobencarb) |
| (I-11) | benthiocarb + chlornitrofen |
| (I-11) | benthiocarb + propanil |
| (I-11) | benthiocarb + simetryn |
| (I-11) | benzobicyclon |
| (I-11) | benzofenap |
| (I-11) | benzofenap + thenylchlor + cumyluron |
| (I-11) | bifenox |
| (I-11) | bifenox + pretilachlor |
| (I-11) | bifenox + thenylchlor |
| (I-11) | bispyribac-sodium |
| (I-11) | bispyribac-sodium + benthiocarb |
| (I-11) | bromobutide |
| (I-11) | bromobutide + pyrazoxyfen |
| (I-11) | bromobutide + benzofenap + pyributicarb |
| (I-11) | bromobutide + bifenox + pyrazolate |
| (I-11) | bromobutide + pyrazoxyfen + thenylchlor |
| (I-11) | butachlor |
| (I-11) | butachlor + chlomethoxyfen |
| (I-11) | butachlor + oxadiazon |
| (I-11) | butachlor + propanil |
| (I-11) | butachlor + pyrazolate |
| (I-11) | butamifos |
| (I-11) | butamifos + bromobutide |
| (I-11) | butenachlor |
| (I-11) | cafenstrole |
| (I-11) | cafenstrole + dymron |
| (I-11) | cafenstrole + cyhalofop-butyl + dymron |
| (I-11) | carfentrazone-ethyl |
| (I-11) | chlomethoxyfen |
| (I-11) | chlornitrofen |
| (I-11) | chlornitrofen + dymron |
| (I-11) | cinmethylin |
| (I-11) | cinmethylin + 2,4-D |
| (I-11) | cinosulfuron |
| (I-11) | cinosulfuron + dymron |
| (I-11) | cinosulfuron + anilofos |
| (I-11) | cinosulfuron + benfuresate |
| (I-11) | cinosulfuron + butachlor |
| (I-11) | cinosulfuron + cafenstrole + dymron |
| (I-11) | cinosulfuron + cyhalofop-butyl |
| (I-11) | cinosulfuron + dimepiperate |
| (I-11) | cinosulfuron + esprocarb |
| (I-11) | cinosulfuron + mefenacet |
| (I-11) | cinosulfuron + mefenacet + dymron |
| (I-11) | cinosulfuron + molinate |
| (I-11) | cinosulfuron + oxaziclomefone |
| (I-11) | cinosulfuron + pretilachlor |
| (I-11) | cinosulfuron + pretilachlor + dymron |
| (I-11) | cinosulfuron + pretilachlor + fenclorim |
| (I-11) | cinosulfuron + pretilachlor + quinclorac |
| (I-11) | cinosulfuron + pyriftalid |
| (I-11) | clefoxydim |
| (I-11) | clodinafop-propargyl |
| (I-11) | clodinafop-propargyl + cloquintocet-mexyl |
| (I-11) | clomazone |
| (I-11) | clomazone + propanil |
| (I-11) | clomeprop |
| (I-11) | clomeprop + pretilachlor |
| (I-11) | cumyluron |
| (I-11) | cyanazine |
| (I-11) | cyclosulfamuron |
| (I-11) | cyclosulfamuron + dymron |
| (I-11) | cyclosulfamuron + anilofos |
| (I-11) | cyclosulfamuron + benfuresate |
| (I-11) | cyclosulfamuron + butachlor |
| (I-11) | cyclosulfamuron + cafenstrole + dymron |
| (I-11) | cyclosulfamuron + cyhalofop-butyl |
| (I-11) | cyclosulfamuron + dimepiperate |
| (I-11) | cyclosulfamuron + esprocarb |
| (I-11) | cyclosulfamuron + mefenacet |
| (I-11) | cyclosulfamuron + mefenacet + dymron |
| (I-11) | cyclosulfamuron + oxaziclomefone |
| (I-11) | cyclosulfamuron + pentoxazone |
| (I-11) | cyclosulfamuron + pretilachlor |
| (I-11) | cyclosulfamuron + quinclorac |
| (I-11) | cyhalofop-butyl |
| (I-11) | cyhalofop-butyl + bentazone |
| (I-11) | 2,4-D |
| (I-11) | dichlorprop-P |
| (I-11) | diethatyl-ethyl |
| (I-11) | dimepiperate |
| (I-11) | dimethametryn |
| (I-11) | dimethametryn + piperophos |
| (I-11) | dimethenamid |
| (I-11) | S-dimethenamid |
| (I-11) | dithiopyr |
| (I-11) | dymron |
| (I-11) | esprocarb |
| (I-11) | ethoxysulfuron |
| (I-11) | ethoxysulfuron + dymron |
| (I-11) | ethoxysulfuron + anilofos |
| (I-11) | ethoxysulfuron + anilofos + dymron |
| (I-11) | ethoxysulfuron + benfuresate |
| (I-11) | ethoxysulfuron + anilofos + benfuresate |
| (I-11) | ethoxysulfuron + benfuresate + dymron |
| (I-11) | ethoxysulfuron + butachlor |
| (I-11) | ethoxysulfuron + cafenstrole |
| (I-11) | ethoxysulfuron + cafenstrole + dymron |
| (I-11) | ethoxysulfuron + cyhalofop-butyl |
| (I-11) | ethoxysulfuron + dimepiperate |
| (I-11) | ethoxysulfuron + esprocarb |
| (I-11) | ethoxysulfuron + mefenacet |
| (I-11) | ethoxysulfuron + mefenacet + dymron |
| (I-11) | ethoxysulfuron + oxaziclomefone |
| (I-11) | ethoxysulfuron + pretilachlor + dymron |
| (I-11) | ethoxysulfuron + pretilachlor + pyrazolate |
| (I-11) | etobenzanid |
| (I-11) | fenoxaprop-(P)-ethyl |
| (I-11) | fenoxaprop-(P)-ethyl + fenclorim |
| (I-11) | fenoxaprop-(P)-ethyl + isoxadifen-ethyl |
| (I-11) | fenoxaprop-(P)-ethyl + mefenpyr-diethyl |
| (I-11) | fentrazamide |
| (I-11) | fentrazamide + pentoxazone |
| (I-11) | fentrazamide + bromobutide |
| (I-11) | fentrazamide + benzofenap |
| (I-11) | fentrazamide + clomeprop |
| (I-11) | fentrazamide + dymron |
| (I-11) | fentrazamide + flufenacet |
| (I-11) | fentrazamide + oxaziclomefone |
| (I-11) | fentrazamide + propanil |
| (I-11) | fentrazamide + pyriminobac-methyl |
| (I-11) | fentrazamide + quinoclamine |
| (I-11) | fentrazamide + azimsulfuron |
| (I-11) | fentrazamide + azimsulfuron + dymron |
| (I-11) | fentrazamide + azimsulfuron + bensulfuron-methyl |
| (I-11) | fentrazamide + bensulfuron-methyl |
| (I-11) | fentrazamide + bensulfuron-methyl + dymron |
| (I-11) | fentrazamide + cinosulfuron |
| (I-11) | fentrazamide + cinosulfuron + dymron |
| (I-11) | fentrazamide + cyclosulfamuron |
| (I-11) | fentrazamide + cyclosulfamuron + dymron |
| (I-11) | fentrazamide + ethoxysulfuron |
| (I-11) | fentrazamide + ethoxysulfuron + dymron |
| (I-11) | fentrazamide + imazosulfuron |
| (I-11) | fentrazamide + imazosulfuron + dymron |
| (I-11) | fentrazamide + pyrazosulfuron-ethyl |
| (I-11) | fentrazamide + pyrazosulfuron-ethyl + dymron |
| (I-11) | fluazifop-P-butyl |
| (I-11) | flucarbazone-sodium |
| (I-11) | flucarbazone-sodium + fenclorim |
| (I-11) | flucarbazone-sodium + isoxadifen-ethyl |
| (I-11) | flucarbazone-sodium + mefenpyr-diethyl |
| (I-11) | flufenacet |
| (I-11) | flufenacet + 2,4-D |
| (I-11) | flufenacet + diflufenican |
| (I-11) | flufenacet + metosulam |
| (I-11) | flufenacet + propanil |
| (I-11) | flufenacet + dichlormid |
| (I-11) | flufenacet + furilazole |
| (I-11) | flufenacet + R-29148 |
| (I-11) | flufenacet + fenclorim |
| (I-11) | flufenacet + isoxadifen-ethyl |
| (I-11) | flufenacet + mefenpyr-diethyl |
| (I-11) | flumetsulam |
| (I-11) | halosulfuron-methyl |
| (I-11) | halosulfuron-methyl + cafenstrole + cyhalofop-butyl |
| (I-11) | halosulfuron-methyl + cafenstrole + dymron |
| (I-11) | halosulfuron-methyl + cyhalofop-butyl + dymron |
| (I-11) | haloxyfop-P-methyl |
| (I-11) | HOK-201 |
| (I-11) | imazamox |
| (I-11) | imazaquin |
| (I-11) | imazethapyr |
| (I-11) | imazosulfuron |
| (I-11) | imazosulfuron + dymron |
| (I-11) | imazosulfuron + anilofos |
| (I-11) | imazosulfuron + benfuresate |
| (I-11) | imazosulfuron + butachlor |
| (I-11) | imazosulfuron + cafenstrole + dymron |
| (I-11) | imazosulfuron + cyhalofop-butyl |
| (I-11) | imazosulfuron + dimepiperate |
| (I-11) | imazosulfuron + dimethametryn |
| (I-11) | imazosulfuron + dimethametryn + pretilachlor |
| (I-11) | imazosulfuron + esprocarb + dymron |
| (I-11) | imazosulfuron + etobenzanid + dymron |
| (I-11) | imazosulfuron + mefenacet + dymron |
| (I-11) | imazosulfuron + oxaziclomefone |
| (I-11) | imazosulfuron + pentoxazone + dymron |
| (I-11) | imazosulfuron + pretilachlor + dymron |
| (I-11) | imazosulfuron + pyributicarb + dymron |
| (I-11) | indanofan |
| (I-11) | isoxaflutole |
| (I-11) | MCPA |
| (I-11) | mefenacet |
| (I-11) | mefenacet + molinate |
| (I-11) | mefenacet + quinoclamine |
| (I-11) | mefenacet + bromobutide + naproanilide |
| (I-11) | mesosulfuron |
| (I-11) | mesosulfuron + dymron |
| (I-11) | mesosulfuron + anilofos |
| (I-11) | mesosulfuron + benfuresate |
| (I-11) | mesosulfuron + cafenstrole + dymron |
| (I-11) | mesosulfuron + cyhalofop-butyl |
| (I-11) | mesosulfuron + dimepiperate |
| (I-11) | mesosulfuron + esprocarb |
| (I-11) | mesosulfuron + mefenacet |
| (I-11) | mesosulfuron + mefenacet + dymron |
| (I-11) | mesosulfuron + oxaziclomefone |
| (I-11) | mesosulfuron + pretilachlor |
| (I-11) | mesosulfuron + pyributicarb |
| (I-11) | mesotrione |
| (I-11) | metolachlor |
| (I-11) | metolachlor + benoxacor |
| (I-11) | S-metolachlor |
| (I-11) | S-metolachlor + benoxacor |
| (I-11) | metosulam |
| (I-11) | metsulfuron-methyl |
| (I-11) | metribuzin |
| (I-11) | molinate |
| (I-11) | molinate + propanil |
| (I-11) | molinate + simetryn |
| (I-11) | naproanilide |
| (I-11) | nicosulfuron |
| (I-11) | OK-701 |
| (I-11) | oxadiargyl |
| (I-11) | oxadiargyl + propanil |
| (I-11) | oxadiazon |
| (I-11) | oxaziclomefone |
| (I-11) | oxyfluorfen |
| (I-11) | pendimethalin |
| (I-11) | pentoxazone |
| (I-11) | pentoxazone + cumyluron |
| (I-11) | piperophos |
| (I-11) | piperophos + 2,4-D |
| (I-11) | pretilachlor |
| (I-11) | pretilachlor + dimethametryn |
| (I-11) | pretilachlor + dymron |
| (I-11) | pretilachlor + dimethametryn + dymron |
| (I-11) | pretilachlor + fenclorim |
| (I-11) | profoxydim |
| (I-11) | propanil |
| (I-11) | propoxycarbazone-sodium |
| (I-11) | pyraclonil |
| (I-11) | pyrazolate |
| (I-11) | pyrazolate + butachlor |
| (I-11) | pyrazolate + pretilachlor |
| (I-11) | pyrazosulfuron-ethyl |
| (I-11) | pyrazosulfuron-ethyl + dymron |
| (I-11) | pyrazosulfuron-ethyl + indanofan |
| (I-11) | pyrazosulfuron-ethyl + etobenzanid |
| (I-11) | pyrazosulfuron-ethyl + esprocarb |
| (I-11) | pyrazosulfuron-ethyl + esprocarb + dimethametryn |
| (I-11) | pyrazosulfuron-ethyl + esprocarb + pretilachlor |
| (I-11) | pyrazosulfuron-ethyl + mefenacet |
| (I-11) | pyrazosulfuron-ethyl + molinate |
| (I-11) | pyrazosulfuron-ethyl + pentoxazone |
| (I-11) | pyrazosulfuron-ethyl + anilofos + dymron |
| (I-11) | pyrazosulfuron-ethyl + benfuresate + dymron |
| (I-11) | pyrazosulfuron-ethyl + butachlor + dymron |
| (I-11) | pyrazosulfuron-ethyl + cafenstrole |
| (I-11) | pyrazosulfuron-ethyl + cafenstrole + cyhalofop-butyl |
| (I-11) | pyrazosulfuron-ethyl + dimepiperate + dymron |
| (I-11) | pyrazosulfuron-ethyl + dithiopyr + esprocarb |
| (I-11) | pyrazosulfuron-ethyl + mefenacet + dymron |
| (I-11) | Pyrazosulfuron-ethyl + oxaziclomefone + dymron |
| (I-11) | pyrazosulfuron-ethyl + pretilachlor |
| (I-11) | pyrazosulfuron-ethyl + pretilachlor + quinclorac |
| (I-11) | pyrazosulfuron-ethyl + thenylchlor |
| (I-11) | pyrazoxyfen |
| (I-11) | pyribenzoxim |
| (I-11) | pyributicarb |
| (I-11) | pyributicarb + pretilachlor |
| (I-11) | pyriftalid |
| (I-11) | pyriminobac-methyl |
| (I-11) | quinclorac |
| (I-11) | quinoclamine |
| (I-11) | simazine |
| (I-11) | simetryn |
| (I-11) | sulcotrione |
| (I-11) | terbuthylazine |
| (I-11) | thenylchlor |
| (I-11) | thifensulfuron-methyl |
| (I-11) | tiocarbazil |
| (I-11) | tritosulfuron |
| (I-21) | acetochlor |
| (I-21) | acetochlor + dichlormid |
| (I-21) | acetochlor + furilazole |
| (I-21) | acetochlor + R-29148 |
| (I-21) | alachlor |
| (I-21) | amicarbazone |
| (I-21) | amidosulfuron |
| (I-21) | anilofos |
| (I-21) | anilofos + 2,4-D |
| (I-21) | anilofos + propanil |
| (I-21) | anilofos + quinoclamine |
| (I-21) | atrazine |
| (I-21) | azimsulfuron |
| (I-21) | azimsulfuron + dymron |
| (I-21) | azimsulfuron + anilofos |
| (I-21) | azimsulfuron + benfuresate |
| (I-21) | azimsulfuron + bensulfuron |
| (I-21) | azimsulfuron + butachlor |
| (I-21) | azimsulfuron + cafenstrole |
| (I-21) | azimsulfuron + cyhalofop-butyl |
| (I-21) | azimsulfuron + dimepiperate |
| (I-21) | azimsulfuron + esprocarb |
| (I-21) | azimsulfuron + indanofan |
| (I-21) | azimsulfuron + mefenacet |
| (I-21) | azimsulfuron + oxaziclomefone |
| (I-21) | azimsulfuron + pretilachlor |
| (I-21) | azimsulfuron + thenylchlor |
| (I-21) | azimsulfuron + anilofos + dymron |
| (I-21) | azimsulfuron + benfuresate + dymron |
| (I-21) | azimsulfuron + bensulfuron + cafenstrole |
| (I-21) | azimsulfuron + bensulfuron + cyhalofop-butyl |
| (I-21) | azimsulfuron + bensulfuron + dymron |
| (I-21) | azimsulfuron + bensulfuron + dimethametryn |
| (I-21) | azimsulfuron + bensulfuron + indanofan |
| (I-21) | azimsulfuron + bensulfuron + pretilachlor |
| (I-21) | azimsulfuron + bensulfuron + thenylchlor |
| (I-21) | azimsulfuron + butachlor + dymron |
| (I-21) | azimsulfuron + cafenstrole + dymron |
| (I-21) | azimsulfuron + cyhalofop-butyl + dymron |
| (I-21) | azimsulfuron + mefenacet + dymron |
| (I-21) | azimsulfuron + oxaziclomefone + dymron |
| (I-21) | azimsulfuron + pretilachlor + dymron |
| (I-21) | benfuresate |
| (I-21) | bensulfuron-methyl |
| (I-21) | bensulfuron-methyl + dymron |
| (I-21) | bensulfuron-methyl + anilofos |
| (I-21) | bensulfuron-methyl + benfuresate |
| (I-21) | bensulfuron-methyl + butachlor |
| (I-21) | bensulfuron-methyl + cafenstrole |
| (I-21) | bensulfuron-methyl + cyhalofop-butyl |
| (I-21) | bensulfuron-methyl + dimepiperate |
| (I-21) | bensulfuron-methyl + dithiopyr |
| (I-21) | bensulfuron-methyl + esprocarb |
| (I-21) | bensulfuron-methyl + indanofan |
| (I-21) | bensulfuron-methyl + mefenacet |
| (I-21) | bensulfuron-methyl + metsulfuron-methyl |
| (I-21) | bensulfuron-methyl + molinate |
| (I-21) | bensulfuron-methyl + oxaziclomefone |
| (I-21) | bensulfuron-methyl + pretilachlor |
| (I-21) | bensulfuron-methyl + pyributicarb |
| (I-21) | bensulfuron-methyl + quinclorac |
| (I-21) | bensulfuron-methyl + thenylchlor |
| (I-21) | bensulfuron-methyl + anilofos + dymron |
| (I-21) | bensulfuron-methyl + benfuresate + dymron |
| (I-21) | bensulfuron-methyl + butachlor + dymron |
| (I-21) | bensulfuron-methyl + benfuresate + dimepiperate |
| (I-21) | bensulfuron-methyl + benfuresate + pretilachlor |
| (I-21) | bensulfuron-methyl + cafenstrole + dymron |
| (I-21) | bensulfuron-methyl + cafenstrole + cyhalofop-butyl |
| (I-21) | bensulfuron-methyl + cyhalofop-butyl + dymron |
| (I-21) | bensulfuron-methyl + cyhalofop-butyl + thenylchlor |
| (I-21) | bensulfuron-methyl + dithiopyr + quinclorac |
| (I-21) | bensulfuron-methyl + mefenacet + dymron |
| (I-21) | bensulfuron-methyl + mefenacet + benthiocarb |
| (I-21) | bensulfuron-methyl + mefenacet + molinate |
| (I-21) | bensulfuron-methyl + oxaziclomefone + dymron |
| (I-21) | bensulfuron-methyl + pretilachlor + dymron |
| (I-21) | bensulfuron-methyl + pyributicarb + dymron |
| (I-21) | bentazone |
| (I-21) | bentazone + quinclorac |
| (I-21) | benthiocarb (thiobencarb) |
| (I-21) | benthiocarb + chlornitrofen |
| (I-21) | benthiocarb + propanil |
| (I-21) | benthiocarb + simetryn |
| (I-21) | benzobicyclon |
| (I-21) | benzofenap |
| (I-21) | benzofenap + thenylchlor + cumyluron |
| (I-21) | bifenox |
| (I-21) | bifenox + pretilachlor |
| (I-21) | bifenox + thenylchlor |
| (I-21) | bispyribac-sodium |
| (I-21) | bispyribac-sodium + benthiocarb |
| (I-21) | bromobutide |
| (I-21) | bromobutide + pyrazoxyfen |
| (I-21) | bromobutide + benzofenap + pyributicarb |
| (I-21) | bromobutide + bifenox + pyrazolate |
| (I-21) | bromobutide + pyrazoxyfen + thenylchlor |
| (I-21) | butachlor |
| (I-21) | butachlor + chlomethoxyfen |
| (I-21) | butachlor + oxadiazon |
| (I-21) | butachlor + propanil |
| (I-21) | butachlor + pyrazolate |
| (I-21) | butamifos |
| (I-21) | butamifos + bromobutide |
| (I-21) | butenachlor |
| (I-21) | cafenstrole |
| (I-21) | cafenstrole + dymron |
| (I-21) | cafenstrole + cyhalofop-butyl + dymron |
| (I-21) | carfentrazone-ethyl |
| (I-21) | chlomethoxyfen |
| (I-21) | chlornitrofen |
| (I-21) | chlornitrofen + dymron |
| (I-21) | cinmethylin |
| (I-21) | cinmethylin + 2,4-D |
| (I-21) | cinosulfuron |
| (I-21) | cinosulfuron + dymron |
| (I-21) | cinosulfuron + anilofos |
| (I-21) | cinosulfuron + benfuresate |
| (I-21) | cinosulfuron + butachlor |
| (I-21) | cinosulfuron + cafenstrole + dymron |
| (I-21) | cinosulfuron + cyhalofop-butyl |
| (I-21) | cinosulfuron + dimepiperate |
| (I-21) | cinosulfuron + esprocarb |
| (I-21) | cinosulfuron + mefenacet |
| (I-21) | cinosulfuron + mefenacet + dymron |
| (I-21) | cinosulfuron + molinate |
| (I-21) | cinosulfuron + oxaziclomefone |
| (I-21) | cinosulfuron + pretilachlor |
| (I-21) | cinosulfuron + pretilachlor + dymron |
| (I-21) | cinosulfuron + pretilachlor + fenclorim |
| (I-21) | cinosulfuron + pretilachlor + quinclorac |
| (I-21) | cinosulfuron + pyriftalid |
| (I-21) | clefoxydim |
| (I-21) | clodinafop-propargyl |
| (I-21) | clodinafop-propargyl + cloquintocet-mexyl |
| (I-21) | clomazone |
| (I-21) | clomazone + propanil |
| (I-21) | clomeprop |
| (I-21) | clomeprop + pretilachlor |
| (I-21) | cumyluron |
| (I-21) | cyanazine |
| (I-21) | cyclosulfamuron |
| (I-21) | cyclosulfamuron + dymron |
| (I-21) | cyclosulfamuron + anilofos |
| (I-21) | cyclosulfamuron + benfuresate |
| (I-21) | cyclosulfamuron + butachlor |
| (I-21) | cyclosulfamuron + cafenstrole + dymron |
| (I-21) | cyclosulfamuron + cyhalofop-butyl |
| (I-21) | cyclosulfamuron + dimepiperate |
| (I-21) | cyclosulfamuron + esprocarb |
| (I-21) | cyclosulfamuron + mefenacet |
| (I-21) | cyclosulfamuron + mefenacet + dymron |
| (I-21) | cyclosulfamuron + oxaziclomefone |
| (I-21) | cyclosulfamuron + pentoxazone |
| (I-21) | cyclosulfamuron + pretilachlor |
| (I-21) | cyclosulfamuron + quinclorac |
| (I-21) | cyhalofop-butyl |
| (I-21) | cyhalofop-butyl + bentazone |
| (I-21) | 2,4-D |
| (I-21) | dichlorprop-P |
| (I-21) | diethatyl-ethyl |
| (I-21) | dimepiperate |
| (I-21) | dimethametryn |
| (I-21) | dimethametryn + piperophos |
| (I-21) | dimethenamid |
| (I-21) | S-dimethenamid |
| (I-21) | dithiopyr |
| (I-21) | dymron |
| (I-21) | esprocarb |
| (I-21) | ethoxysulfuron |
| (I-21) | ethoxysulfuron + dymron |
| (I-21) | ethoxysulfuron + anilofos |
| (I-21) | ethoxysulfuron + anilofos + dymron |
| (I-21) | ethoxysulfuron + benfuresate |
| (I-21) | ethoxysulfuron + anilofos + benfuresate |
| (I-21) | ethoxysulfuron + benfuresate + dymron |
| (I-21) | ethoxysulfuron + butachlor |
| (I-21) | ethoxysulfuron + cafenstrole |
| (I-21) | ethoxysulfuron + cafenstrole + dymron |
| (I-21) | ethoxysulfuron + cyhalofop-butyl |
| (I-21) | ethoxysulfuron + dimepiperate |
| (I-21) | ethoxysulfuron + esprocarb |
| (I-21) | ethoxysulfuron + mefenacet |
| (I-21) | ethoxysulfuron + mefenacet + dymron |
| (I-21) | ethoxysulfuron + oxaziclomefone |
| (I-21) | ethoxysulfuron + pretilachlor + dymron |
| (I-21) | ethoxysulfuron + pretilachlor + pyrazolate |
| (I-21) | etobenzanid |
| (I-21) | fenoxaprop-(P)-ethyl |
| (I-21) | fenoxaprop-(P)-ethyl + fenclorim |
| (I-21) | fenoxaprop-(P)-ethyl + isoxadifen-ethyl |
| (I-21) | fenoxaprop-(P)-ethyl + mefenpyr-diethyl |
| (I-21) | fentrazamide |
| (I-21) | fentrazamide + pentoxazone |
| (I-21) | fentrazamide + bromobutide |
| (I-21) | fentrazamide + benzofenap |
| (I-21) | fentrazamide + clomeprop |
| (I-21) | fentrazamide + dymron |
| (I-21) | fentrazamide + flufenacet |
| (I-21) | fentrazamide + oxaziclomefone |
| (I-21) | fentrazamide + propanil |
| (I-21) | fentrazamide + pyriminobac-methyl |
| (I-21) | fentrazamide + quinoclamine |
| (I-21) | fentrazamide + azimsulfuron |
| (I-21) | fentrazamide + azimsulfuron + dymron |
| (I-21) | fentrazamide + azimsulfuron + bensulfuron-methyl |
| (I-21) | fentrazamide + bensulfuron-methyl |
| (I-21) | fentrazamide + bensulfuron-methyl + dymron |
| (I-21) | fentrazamide + cinosulfuron |
| (I-21) | fentrazamide + cinosulfuron + dymron |
| (I-21) | fentrazamide + cyclosulfamuron |
| (I-21) | fentrazamide + cyclosulfamuron + dymron |
| (I-21) | fentrazamide + ethoxysulfuron |
| (I-21) | fentrazamide + ethoxysulfuron + dymron |
| (I-21) | fentrazamide + imazosulfuron |
| (I-21) | fentrazamide + imazosulfuron + dymron |
| (I-21) | fentrazamide + pyrazosulfuron-ethyl |
| (I-21) | fentrazamide + pyrazosulfuron-ethyl + dymron |
| (I-21) | fluazifop-P-butyl |
| (I-21) | flucarbazone-sodium |
| (I-21) | flucarbazone-sodium + fenclorim |
| (I-21) | flucarbazone-sodium + isoxadifen-ethyl |
| (I-21) | flucarbazone-sodium + mefenpyr-diethyl |
| (I-21) | flufenacet |
| (I-21) | flufenacet + 2,4-D |
| (I-21) | flufenacet + diflufenican |
| (I-21) | flufenacet + metosulam |
| (I-21) | flufenacet + propanil |
| (I-21) | flufenacet + dichlormid |
| (I-21) | flufenacet + furilazole |
| (I-21) | flufenacet + R-29148 |
| (I-21) | flufenacet + fenclorim |
| (I-21) | flufenacet + isoxadifen-ethyl |
| (I-21) | flufenacet + mefenpyr-diethyl |
| (I-21) | flumetsulam |
| (I-21) | halosulfuron-methyl |
| (I-21) | halosulfuron-methyl + cafenstrole + cyhalofop-butyl |
| (I-21) | halosulfuron-methyl + cafenstrole + dymron |
| (I-21) | halosulfuron-methyl + cyhalofop-butyl + dymron |
| (I-21) | haloxyfop-P-methyl |
| (I-21) | HOK-201 |
| (I-21) | imazamox |
| (I-21) | imazaquin |
| (I-21) | imazethapyr |
| (I-21) | imazosulfuron |
| (I-21) | imazosulfuron + dymron |
| (I-21) | imazosulfuron + anilofos |
| (I-21) | imazosulfuron + benfuresate |
| (I-21) | imazosulfuron + butachlor |
| (I-21) | imazosulfuron + cafenstrole + dymron |
| (I-21) | imazosulfuron + cyhalofop-butyl |
| (I-21) | imazosulfuron + dimepiperate |
| (I-21) | imazosulfuron + dimethametryn |
| (I-21) | imazosulfuron + dimethametryn + pretilachlor |
| (I-21) | imazosulfuron + esprocarb + dymron |
| (I-21) | imazosulfuron + etobenzanid + dymron |
| (I-21) | imazosulfuron + mefenacet + dymron |
| (I-21) | imazosulfuron + oxaziclomefone |
| (I-21) | imazosulfuron + pentoxazone + dymron |
| (I-21) | imazosulfuron + pretilachlor + dymron |
| (I-21) | imazosulfuron + pyributicarb + dymron |
| (I-21) | indanofan |
| (I-21) | isoxaflutole |
| (I-21) | MCPA |
| (I-21) | mefenacet |
| (I-21) | mefenacet + molinate |
| (I-21) | mefenacet + quinoclamine |
| (I-21) | mefenacet + bromobutide + naproanilide |
| (I-21) | mesosulfuron |
| (I-21) | mesosulfuron + dymron |
| (I-21) | mesosulfuron + anilofos |
| (I-21) | mesosulfuron + benfuresate |
| (I-21) | mesosulfuron + cafenstrole + dymron |
| (I-21) | mesosulfuron + cyhalofop-butyl |
| (I-21) | mesosulfuron + dimepiperate |
| (I-21) | mesosulfuron + esprocarb |
| (I-21) | mesosulfuron + mefenacet |
| (I-21) | mesosulfuron + mefenacet + dymron |
| (I-21) | mesosulfuron + oxaziclomefone |
| (I-21) | mesosulfuron + pretilachlor |
| (I-21) | mesosulfuron + pyributicarb |
| (I-21) | mesotrione |
| (I-21) | metolachlor |
| (I-21) | metolachlor + benoxacor |
| (I-21) | S-metolachlor |
| (I-21) | S-metolachlor + benoxacor |
| (I-21) | metosulam |
| (I-21) | metsulfuron-methyl |
| (I-21) | metribuzin |
| (I-21) | molinate |
| (I-21) | molinate + propanil |
| (I-21) | molinate + simetryn |
| (I-21) | naproanilide |
| (I-21) | nicosulfuron |
| (I-21) | OK-701 |
| (I-21) | oxadiargyl |
| (I-21) | oxadiargyl + propanil |
| (I-21) | oxadiazon |
| (I-21) | oxaziclomefone |
| (I-21) | oxyfluorfen |
| (I-21) | pendimethalin |
| (I-21) | pentoxazone |
| (I-21) | pentoxazone + cumyluron |
| (I-21) | piperophos |
| (I-21) | piperophos + 2,4-D |
| (I-21) | pretilachlor |
| (I-21) | pretilachlor + dimethametryn |
| (I-21) | pretilachlor + dymron |
| (I-21) | pretilachlor + dimethametryn + dymron |
| (I-21) | pretilachlor + fenclorim |
| (I-21) | profoxydim |
| (I-21) | propanil |
| (I-21) | propoxycarbazone-sodium |
| (I-21) | pyraclonil |
| (I-21) | pyrazolate |
| (I-21) | pyrazolate + butachlor |
| (I-21) | pyrazolate + pretilachlor |
| (I-21) | pyrazosulfuron-ethyl |
| (I-21) | pyrazosulfuron-ethyl + dymron |
| (I-21) | pyrazosulfuron-ethyl + indanofan |
| (I-21) | pyrazosulfuron-ethyl + etobenzanid |
| (I-21) | pyrazosulfuron-ethyl + esprocarb |
| (I-21) | pyrazosulfuron-ethyl + esprocarb + dimethametryn |
| (I-21) | pyrazosulfuron-ethyl + esprocarb + pretilachlor |
| (I-21) | pyrazosulfuron-ethyl + mefenacet |
| (I-21) | pyrazosulfuron-ethyl + molinate |
| (I-21) | pyrazosulfuron-ethyl + pentoxazone |
| (I-21) | pyrazosulfuron-ethyl + anilofos + dymron |
| (I-21) | pyrazosulfuron-ethyl + benfuresate + dymron |
| (I-21) | pyrazosulfuron-ethyl + butachlor + dymron |
| (I-21) | pyrazosulfuron-ethyl + cafenstrole |
| (I-21) | pyrazosulfuron-ethyl + cafenstrole + cyhalofop-butyl |
| (I-21) | pyrazosulfuron-ethyl + dimepiperate + dymron |
| (I-21) | pyrazosulfuron-ethyl + dithiopyr + esprocarb |
| (I-21) | pyrazosulfuron-ethyl + mefenacet + dymron |
| (I-21) | pyrazosulfuron-ethyl + oxaziclomefone + dymron |
| (I-21) | pyrazosulfuron-ethyl + pretilachlor |
| (I-21) | pyrazosulfuron-ethyl + pretilachlor + quinclorac |
| (I-21) | pyrazosulfuron-ethyl + thenylchlor |
| (I-21) | pyrazoxyfen |
| (I-21) | pyribenzoxim |
| (I-21) | pyributicarb |
| (I-21) | pyributicarb + pretilachlor |
| (I-21) | pyriftalid |
| (I-21) | pyriminobac-methyl |
| (I-21) | quinclorac |
| (I-21) | quinoclamine |
| (I-21) | simazine |
| (I-21) | simetryn |
| (I-21) | sulcotrione |
| (I-21) | terbuthylazine |
| (I-21) | thenylchlor |
| (I-21) | thifensulfuron-methyl |
| (I-21) | tiocarbazil |
| (I-21) | tritosulfuron |
| (I-22) | acetochlor |
| (I-22) | acetochlor + dichlormid |
| (I-22) | acetochlor + furilazole |
| (I-22) | acetochlor + R-29148 |
| (I-22) | alachlor |
| (I-22) | amicarbazone |
| (I-22) | amidosulfuron |
| (I-22) | anilofos |
| (I-22) | anilofos + 2,4-D |
| (I-22) | anilofos + propanil |
| (I-22) | anilofos + quinoclamine |
| (I-22) | atrazine |
| (I-22) | azimsulfuron |
| (I-22) | azimsulfuron + dymron |
| (I-22) | azimsulfuron + indanofan |
| (I-22) | azimsulfuron + anilofos |
| (I-22) | azimsulfuron + benfuresate |
| (I-22) | azimsulfuron + butachlor |
| (I-22) | azimsulfuron + cafenstrole |
| (I-22) | azimsulfuron + cyhalofop-butyl |
| (I-22) | azimsulfuron + dimepiperate |
| (I-22) | azimsulfuron + esprocarb |
| (I-22) | azimsulfuron + mefenacet |
| (I-22) | azimsulfuron + oxaziclomefone |
| (I-22) | azimsulfuron + pretilachlor |
| (I-22) | azimsulfuron + thenylchlor |
| (I-22) | azimsulfuron + anilofos + dymron |
| (I-22) | azimsulfuron + benfuresate + dymron |
| (I-22) | azimsulfuron + bensulfuron + cafenstrole |
| (I-22) | azimsulfuron + bensulfuron + cyhalofop-butyl |
| (I-22) | azimsulfuron + bensulfuron + dymron |
| (I-22) | azimsulfuron + bensulfuron + dimethametryn |
| (I-22) | azimsulfuron + bensulfuron + indanofan |
| (I-22) | azimsulfuron + bensulfuron + pretilachlor |
| (I-22) | azimsulfuron + bensulfuron + thenylchlor |
| (I-22) | azimsulfuron + butachlor + dymron |
| (I-22) | azimsulfuron + cafenstrole + dymron |
| (I-22) | azimsulfuron + cyhalofop-butyl + dymron |
| (I-22) | azimsulfuron + mefenacet + dymron |
| (I-22) | azimsulfuron + oxaziclomefone + dymron |
| (I-22) | azimsulfuron + pretilachlor + dymron |
| (I-22) | benfuresate |
| (I-22) | bensulfuron-methyl |
| (I-22) | bensulfuron-methyl + dymron |
| (I-22) | bensulfuron-methyl + anilofos |
| (I-22) | bensulfuron-methyl + benfuresate |
| (I-22) | bensulfuron-methyl + butachlor |
| (I-22) | bensulfuron-methyl + cafenstrole |
| (I-22) | bensulfuron-methyl + cyhalofop-butyl |
| (I-22) | bensulfuron-methyl + dimepiperate |
| (I-22) | bensulfuron-methyl + dithiopyr |
| (I-22) | bensulfuron-methyl + esprocarb |
| (I-22) | bensulfuron-methyl + indanofan |
| (I-22) | bensulfuron-methyl + mefenacet |
| (I-22) | bensulfuron-methyl + metsulfuron-methyl |
| (I-22) | bensulfuron-methyl + molinate |
| (I-22) | bensulfuron-methyl + oxaziclomefone |
| (I-22) | bensulfuron-methyl + pretilachlor |
| (I-22) | bensulfuron-methyl + pyributicarb |
| (I-22) | bensulfuron-methyl + quinclorac |
| (I-22) | bensulfuron-methyl + thenylchlor |
| (I-22) | bensulfuron-methyl + anilofos + dymron |
| (I-22) | bensulfuron-methyl + benfuresate + dymron |
| (I-22) | bensulfuron-methyl + butachlor + dymron |
| (I-22) | bensulfuron-methyl + benfuresate + dimepiperate |
| (I-22) | bensulfuron-methyl + benfuresate + pretilachlor |
| (I-22) | bensulfuron-methyl + cafenstrole + dymron |
| (I-22) | bensulfuron-methyl + cafenstrole + cyhalofop-butyl |
| (I-22) | bensulfuron-methyl + cyhalofop-butyl + dymron |
| (I-22) | bensulfuron-methyl + cyhalofop-butyl + thenylchlor |
| (I-22) | bensulfuron-methyl + mefenacet + benthiocarb |
| (I-22) | bensulfuron-methyl + dithiopyr + quinclorac |
| (I-22) | bensulfuron-methyl + mefenacet + dymron |
| (I-22) | bensulfuron-methyl + mefenacet + molinate |
| (I-22) | bensulfuron-methyl + oxaziclomefone + dymron |
| (I-22) | bensulfuron-methyl + pretilachlor + dymron |
| (I-22) | bensulfuron-methyl + pyributicarb + dymron |
| (I-22) | bentazone |
| (I-22) | bentazone + quinclorac |
| (I-22) | benthiocarb (thiobencarb) |
| (I-22) | benthiocarb + chlornitrofen |
| (I-22) | benthiocarb + propanil |
| (I-22) | benthiocarb + simetryn |
| (I-22) | benzobicyclon |
| (I-22) | benzofenap |
| (I-22) | benzofenap + thenylchlor + cumyluron |
| (I-22) | bifenox |
| (I-22) | bifenox + pretilachlor |
| (I-22) | bifenox + thenylchlor |
| (I-22) | bispyribac-sodium |
| (I-22) | bispyribac-sodium + benthiocarb |
| (I-22) | bromobutide |
| (I-22) | bromobutide + pyrazoxyfen |
| (I-22) | bromobutide + benzofenap + pyributicarb |
| (I-22) | bromobutide + bifenox + pyrazolate |
| (I-22) | bromobutide + pyrazoxyfen + thenylchlor |
| (I-22) | butachlor |
| (I-22) | butachlor + chlomethoxyfen |
| (I-22) | butachlor + oxadiazon |
| (I-22) | butachlor + propanil |
| (I-22) | butachlor + pyrazolate |
| (I-22) | butamifos |
| (I-22) | butamifos + bromobutide |
| (I-22) | butenachlor |
| (I-22) | cafenstrole |
| (I-22) | cafenstrole + dymron |
| (I-22) | cafenstrole + cyhalofop-butyl + dymron |
| (I-22) | carfentrazone-ethyl |
| (I-22) | chlomethoxyfen |
| (I-22) | chlornitrofen |
| (I-22) | chlornitrofen + dymron |
| (I-22) | cinmethylin |
| (I-22) | cinmethylin + 2,4-D |
| (I-22) | cinosulfuron |
| (I-22) | cinosulfuron + dymron |
| (I-22) | cinosulfuron + anilofos |
| (I-22) | cinosulfuron + benfuresate |
| (I-22) | cinosulfuron + butachlor |
| (I-22) | cinosulfuron + cafenstrole + dymron |
| (I-22) | cinosulfuron + cyhalofop-butyl |
| (I-22) | cinosulfuron + dimepiperate |
| (I-22) | cinosulfuron + esprocarb |
| (I-22) | cinosulfuron + mefenacet |
| (I-22) | cinosulfuron + mefenacet + dymron |
| (I-22) | cinosulfuron + molinate |
| (I-22) | cinosulfuron + oxaziclomefone |
| (I-22) | cinosulfuron + pretilachlor |
| (I-22) | cinosulfuron + pretilachlor + dymron |
| (I-22) | cinosulfuron + pretilachlor + fenclorim |
| (I-22) | cinosulfuron + pretilachlor + quinclorac |
| (I-22) | cinosulfuron + pyriftalid |
| (I-22) | clefoxydim |
| (I-22) | clodinafop-propargyl |
| (I-22) | clodinafop-propargyl + cloquintocet-mexyl |
| (I-22) | clomazone |
| (I-22) | clomazone + propanil |
| (I-22) | clomeprop |
| (I-22) | clomeprop + pretilachlor |
| (I-22) | cumyluron |
| (I-22) | cyanazine |
| (I-22) | cyclosulfamuron |
| (I-22) | cyclosulfamuron + dymron |
| (I-22) | cyclosulfamuron + anilofos |
| (I-22) | cyclosulfamuron + benfuresate |
| (I-22) | cyclosulfamuron + butachlor |
| (I-22) | cyclosulfamuron + cafenstrole + dymron |
| (I-22) | cyclosulfamuron + cyhalofop-butyl |
| (I-22) | cyclosulfamuron + dimepiperate |
| (I-22) | cyclosulfamuron + esprocarb |
| (I-22) | cyclosulfamuron + mefenacet |
| (I-22) | cyclosulfamuron + mefenacet + dymron |
| (I-22) | cyclosulfamuron + oxaziclomefone |
| (I-22) | cyclosulfamuron + pentoxazone |
| (I-22) | cyclosulfamuron + pretilachlor |
| (I-22) | cyclosulfamuron + quinclorac |
| (I-22) | cyhalofop-butyl |
| (I-22) | cyhalofop-butyl + bentazone |
| (I-22) | 2,4-D |
| (I-22) | dichlorprop-P |
| (I-22) | diethatyl-ethyl |
| (I-22) | dimepiperate |
| (I-22) | dimethametryn |
| (I-22) | dimethametryn + piperophos |
| (I-22) | dimethenamid |
| (I-22) | S-dimethenamid |
| (I-22) | dithiopyr |
| (I-22) | dymron |
| (I-22) | esprocarb |
| (I-22) | ethoxysulfuron |
| (I-22) | ethoxysulfuron + dymron |
| (I-22) | ethoxysulfuron + anilofos |
| (I-22) | ethoxysulfuron + anilofos + dymron |
| (I-22) | ethoxysulfuron + benfuresate |
| (I-22) | ethoxysulfuron + anilofos + benfuresate |
| (I-22) | ethoxysulfuron + benfuresate + dymron |
| (I-22) | ethoxysulfuron + butachlor |
| (I-22) | ethoxysulfuron + cafenstrole |
| (I-22) | ethoxysulfuron + cafenstrole + dymron |
| (I-22) | ethoxysulfuron + cyhalofop-butyl |
| (I-22) | ethoxysulfuron + dimepiperate |
| (I-22) | ethoxysulfuron + esprocarb |
| (I-22) | ethoxysulfuron + mefenacet |
| (I-22) | ethoxysulfuron + mefenacet + dymron |
| (I-22) | ethoxysulfuron + oxaziclomefone |
| (I-22) | ethoxysulfuron + pretilachlor + dymron |
| (I-22) | ethoxysulfuron + pretilachlor + pyrazolate |
| (I-22) | etobenzanid |
| (I-22) | fenoxaprop-P-ethyl |
| (I-22) | fenoxaprop-(P)-ethyl + fenclorim |
| (I-22) | fenoxaprop-(P)-ethyl + isoxadifen-ethyl |
| (I-22) | fenoxaprop-P-ethyl + mefenpyr-diethyl |
| (I-22) | fentrazamide |
| (I-22) | fentrazamide + pentoxazone |
| (I-22) | fentrazamide + bispyribac-sodium |
| (I-22) | fentrazamide + bromobutide |
| (I-22) | fentrazamide + benzofenap |
| (I-22) | fentrazamide + clomeprop |
| (I-22) | fentrazamide + dymron |
| (I-22) | fentrazamide + flufenacet |
| (I-22) | fentrazamide + oxaziclomefone |
| (I-22) | fentrazamide + propanil |
| (I-22) | fentrazamide + pyribenzoxim |
| (I-22) | fentrazamide + pyriminobac-methyl |
| (I-22) | fentrazamide + quinoclamine |
| (I-22) | fentrazamide + azimsulfuron |
| (I-22) | fentrazamide + azimsulfuron + dymron |
| (I-22) | fentrazamide + azimsulfuron + bensulfuron-methyl |
| (I-22) | fentrazamide + bensulfuron-methyl |
| (I-22) | fentrazamide + bensulfuron-methyl + dymron |
| (I-22) | fentrazamide + cinosulfuron |
| (I-22) | fentrazamide + cinosulfuron + dymron |
| (I-22) | fentrazamide + cyclosulfamuron |
| (I-22) | fentrazamide + cyclosulfamuron + dymron |
| (I-22) | fentrazamide + ethoxysulfuron |
| (I-22) | fentrazamide + ethoxysulfuron + dymron |
| (I-22) | fentrazamide + imazosulfuron |
| (I-22) | fentrazamide + imazosulfuron + dymron |
| (I-22) | fentrazamide + pyrazosulfuron-ethyl |
| (I-22) | fentrazamide + pyrazosulfuron-ethyl + dymron |
| (I-22) | fluazifop-P-butyl |
| (I-22) | flucarbazone-sodium |
| (I-22) | flucarbazone-sodium + fenclorim |
| (I-22) | flucarbazone-sodium + isoxadifen-ethyl |
| (I-22) | flucarbazone-sodium + mefenpyr-diethyl |
| (I-22) | flufenacet |
| (I-22) | flufenacet + 2,4-D |
| (I-22) | flufenacet + diflufenican |
| (I-22) | flufenacet + metosulam |
| (I-22) | flufenacet + propanil |
| (I-22) | flufenacet + dichlormid |
| (I-22) | flufenacet + furilazole |
| (I-22) | flufenacet + R-29148 |
| (I-22) | flufenacet + fenclorim |
| (I-22) | flufenacet + isoxadifen-ethyl |
| (I-22) | flufenacet + mefenpyr-diethyl |
| (I-22) | flumetsulam |
| (I-22) | halosulfuron-methyl |
| (I-22) | halosulfuron-methyl + cafenstrole + cyhalofop-butyl |
| (I-22) | haloxyfop-P-methyl |
| (I-22) | HOK-201 |
| (I-22) | imazamox |
| (I-22) | imazaquin |
| (I-22) | imazethapyr |
| (I-22) | imazosulfuron |
| (I-22) | imazosulfuron + dymron |
| (I-22) | imazosulfuron + anilofos |
| (I-22) | imazosulfuron + benfuresate |
| (I-22) | imazosulfuron + butachlor |
| (I-22) | imazosulfuron + cafenstrole + dymron |
| (I-22) | imazosulfuron + cyhalofop-butyl |
| (I-22) | imazosulfuron + dimepiperate |
| (I-22) | imazosulfuron + dimethametryn |
| (I-22) | imazosulfuron + dimethametryn + pretilachlor |
| (I-22) | imazosulfuron + esprocarb + dymron |
| (I-22) | imazosulfuron + etobenzanid + dymron |
| (I-22) | imazosulfuron + mefenacet + dymron |
| (I-22) | imazosulfuron + oxaziclomefone |
| (I-22) | imazosulfuron + pentoxazone + dymron |
| (I-22) | imazosulfuron + pretilachlor + dymron |
| (I-22) | imazosulfuron + pyributicarb + dymron |
| (I-22) | indanofan |
| (I-22) | isoxaflutole |
| (I-22) | MCPA |
| (I-22) | mefenacet |
| (I-22) | mefenacet + quinoclamine |
| (I-22) | mefenacet + molinate |
| (I-22) | mefenacet + bromobutide + naproanilide |
| (I-22) | mesosulfuron |
| (I-22) | mesosulfuron + dymron |
| (I-22) | mesosulfuron + anilofos |
| (I-22) | mesosulfuron + benfuresate |
| (I-22) | mesosulfuron + cafenstrole + dymron |
| (I-22) | mesosulfuron + cyhalofop-butyl |
| (I-22) | mesosulfuron + dimepiperate |
| (I-22) | mesosulfuron + esprocarb |
| (I-22) | mesosulfuron + mefenacet |
| (I-22) | mesosulfuron + mefenacet + dymron |
| (I-22) | mesosulfuron + oxaziclomefone |
| (I-22) | mesosulfuron + pretilachlor |
| (I-22) | mesosulfuron + pyributicarb |
| (I-22) | mesotrione |
| (I-22) | metolachlor |
| (I-22) | metolachlor + benoxacor |
| (I-22) | S-metolachlor |
| (I-22) | S-metolachlor + benoxacor |
| (I-22) | metosualm |
| (I-22) | metsulfuron-methyl |
| (I-22) | metribuzin |
| (I-22) | molinate |
| (I-22) | molinate + propanil |
| (I-22) | molinate + simetryn |
| (I-22) | naproanilide |
| (I-22) | nicosulfuron |
| (I-22) | OK-701 |
| (I-22) | oxadiargyl |
| (I-22) | oxadiargyl + propanil |
| (I-22) | oxadiazon |
| (I-22) | oxaziclomefone |
| (I-22) | oxyfluorfen |
| (I-22) | pendimethalin |
| (I-22) | pentoxazone |
| (I-22) | pentoxazone + cumyluron |
| (I-22) | piperophos |
| (I-22) | piperophos + 2,4-D |
| (I-22) | pretilachlor |
| (I-22) | pretilachlor + dimethametryn |
| (I-22) | pretilachlor + dymron |
| (I-22) | pretilachlor + dimethametryn + dymron |
| (I-22) | pretilachlor + fenclorim |
| (I-22) | profoxydim |
| (I-22) | propanil |
| (I-22) | propoxycarbazone-sodium |
| (I-22) | pyraclonil |
| (I-22) | pyrazolate |
| (I-22) | pyrazolate + butachlor |
| (I-22) | pyrazolate + pretilachlor |
| (I-22) | pyrazosulfuron-ethyl |
| (I-22) | pyrazosulfuron-ethyl + dymron |
| (I-22) | pyrazosulfuron-ethyl + etobenzanid |
| (I-22) | pyrazosulfuron-ethyl + esprocarb |
| (I-22) | pyrazosulfuron-ethyl + esprocarb + dimethametryn |
| (I-22) | pyrazosulfuron-ethyl + esprocarb + pretilachlor |
| (I-22) | pyrazosulfuron-ethyl + molinate |
| (I-22) | pyrazosulfuron-ethyl + pentoxazone |
| (I-22) | pyrazosulfuron-ethyl + anilofos + dymron |
| (I-22) | pyrazosulfuron-ethyl + benfuresate + dymron |
| (I-22) | pyrazosulfuron-ethyl + butachlor + dymron |
| (I-22) | pyrazosulfuron-ethyl + cafenstrole |
| (I-22) | pyrazosulfuron-ethyl + cafenstrole + cyhalofop-butyl |
| (I-22) | pyrazosulfuron-ethyl + dimepiperate + dymron |
| (I-22) | pyrazosulfuron-ethyl + mefenacet + dymron |
| (I-22) | pyrazosulfuron-ethyl + oxaziclomefone + dymron |
| (I-22) | pyrazosulfuron-ethyl + pretilachlor + dymron |
| (I-22) | pyrazosulfuron-ethyl + pretilachlor + quinclorac |
| (I-22) | pyrazosulfuron-ethyl + thenylchlor |
| (I-22) | pyrazoxyfen |
| (I-22) | pyribenzoxim |
| (I-22) | pyributicarb |
| (I-22) | pyributicarb + pretilachlor |
| (I-22) | pyriftalid |
| (I-22) | pyriminobac-methyl |
| (I-22) | quinclorac |
| (I-22) | quinoclamine |
| (I-22) | simazine |
| (I-22) | simetryn |
| (I-22) | sulcotrione |
| (I-22) | terbuthylazine |
| (I-22) | thenylchlor |
| (I-22) | thifensulfuron-methyl |
| (I-22) | tiocarbazil |
| (I-22) | tritosulfuron |
| (I-31) | acetochlor |
| (I-31) | acetochlor + dichlormid |
| (I-31) | acetochlor + furilazole |
| (I-31) | acetochlor + R-29148 |
| (I-31) | alachlor |
| (I-31) | amicarbazone |
| (I-31) | amidosulfuron |
| (I-31) | anilofos |
| (I-31) | anilofos + 2,4-D |
| (I-31) | anilofos + propanil |
| (I-31) | anilofos + quinoclamine |
| (I-31) | atrazine |
| (I-31) | azimsulfuron |
| (I-31) | azimsulfuron + dymron |
| (I-31) | azimsulfuron + indanofan |
| (I-31) | azimsulfuron + anilofos |
| (I-31) | azimsulfuron + benfuresate |
| (I-31) | azimsulfuron + butachlor |
| (I-31) | azimsulfuron + cafenstrole |
| (I-31) | azimsulfuron + cyhalofop-butyl |
| (I-31) | azimsulfuron + dimepiperate |
| (I-31) | azimsulfuron + esprocarb |
| (I-31) | azimsulfuron + mefenacet |
| (I-31) | azimsulfuron + oxaziclomefone |
| (I-31) | azimsulfuron + pretilachlor |
| (I-31) | azimsulfuron + thenylchlor |
| (I-31) | azimsulfuron + anilofos + dymron |
| (I-31) | azimsulfuron + benfuresate + dymron |
| (I-31) | azimsulfuron + bensulfuron + cafenstrole |
| (I-31) | azimsulfuron + bensulfuron + cyhalofop-butyl |
| (I-31) | azimsulfuron + bensulfuron + dymron |
| (I-31) | azimsulfuron + bensulfuron + dimethametryn |
| (I-31) | azimsulfuron + bensulfuron + indanofan |
| (I-31) | azimsulfuron + bensulfuron + pretilachlor |
| (I-31) | azimsulfuron + bensulfuron + thenylchlor |
| (I-31) | azimsulfuron + butachlor + dymron |
| (I-31) | azimsulfuron + cafenstrole + dymron |
| (I-31) | azimsulfuron + cyhalofop-butyl + dymron |
| (I-31) | azimsulfuron + mefenacet + dymron |
| (I-31) | azimsulfuron + oxaziclomefone + dymron |
| (I-31) | azimsulfuron + pretilachlor + dymron |
| (I-31) | benfuresate |
| (I-31) | bensulfuron-methyl |
| (I-31) | bensulfuron-methyl + dymron |
| (I-31) | bensulfuron-methyl + anilofos |
| (I-31) | bensulfuron-methyl + benfuresate |
| (I-31) | bensulfuron-methyl + butachlor |
| (I-31) | bensulfuron-methyl + cafenstrole |
| (I-31) | bensulfuron-methyl + cyhalofop-butyl |
| (I-31) | bensulfuron-methyl + indanofan |
| (I-31) | bensulfuron-methyl + dimepiperate |
| (I-31) | bensulfuron-methyl + esprocarb |
| (I-31) | bensulfuron-methyl + mefenacet |
| (I-31) | bensulfuron-methyl + molinate |
| (I-31) | bensulfuron-methyl + quinclorac |
| (I-31) | bensulfuron-methyl + anilofos + dymron |
| (I-31) | bensulfuron-methyl + benfuresate + dymron |
| (I-31) | bensulfuron-methyl + butachlor + dymron |
| (I-31) | bensulfuron-methyl + benfuresate + dimepiperate |
| (I-31) | bensulfuron-methyl + benfuresate + pretilachlor |
| (I-31) | bensulfuron-methyl + cafenstrole + dymron |
| (I-31) | bensulfuron-methyl + cyhalofop-butyl + dymron |
| (I-31) | bensulfuron-methyl + cafenstrole + cyhalofop-butyl |
| (I-31) | bensulfuron-methyl + cyhalofop-butyl + thenylchlor |
| (I-31) | bensulfuron-methyl + dithiopyr + quinclorac |
| (I-31) | bensulfuron-methyl + mefenacet + benthiocarb |
| (I-31) | bensulfuron-methyl + mefenacet + dymron |
| (I-31) | bensulfuron-methyl + mefenacet + molinate |
| (I-31) | bensulfuron-methyl + oxaziclomefone + dymron |
| (I-31) | bensulfuron-methyl + pretilachlor + dymron |
| (I-31) | bensulfuron-methyl + pyributicarb + dymron |
| (I-31) | bentazone |
| (I-31) | bentazone + quinclorac |
| (I-31) | benthiocarb (thiobencarb) |
| (I-31) | benthiocarb + chlornitrofen |
| (I-31) | benthiocarb + propanil |
| (I-31) | benthiocarb + simetryn |
| (I-31) | benzobicyclon |
| (I-31) | benzofenap |
| (I-31) | benzofenap + thenylchlor + cumyluron |
| (I-31) | bifenox |
| (I-31) | bifenox + pretilachlor |
| (I-31) | bifenox + thenylchlor |
| (I-31) | bispyribac-sodium |
| (I-31) | bispyribac-sodium + benthiocarb |
| (I-31) | bromobutide |
| (I-31) | bromobutide + pyrazoxyfen |
| (I-31) | bromobutide + benzofenap + pyributicarb |
| (I-31) | bromobutide + bifenox + pyrazolate |
| (I-31) | bromobutide + pyrazoxyfen + thenylchlor |
| (I-31) | butachlor |
| (I-31) | butachlor + chlomethoxyfen |
| (I-31) | butachlor + oxadiazon |
| (I-31) | butachlor + propanil |
| (I-31) | butachlor + pyrazolate |
| (I-31) | butamifos |
| (I-31) | butamifos + bromobutide |
| (I-31) | butenachlor |
| (I-31) | cafenstrole |
| (I-31) | cafenstrole + dymron |
| (I-31) | cafenstrole + cyhalofop-butyl + dymron |
| (I-31) | carfentrazone-ethyl |
| (I-31) | chlomethoxyfen |
| (I-31) | chlornitrofen |
| (I-31) | chlornitrofen + dymron |
| (I-31) | cinmethylin |
| (I-31) | cinmethylin + 2,4-D |
| (I-31) | cinosulfuron |
| (I-31) | cinosulfuron + dymron |
| (I-31) | cinosulfuron + anilofos |
| (I-31) | cinosulfuron + benfuresate |
| (I-31) | cinosulfuron + butachlor |
| (I-31) | cinosulfuron + cafenstrole + dymron |
| (I-31) | cinosulfuron + cyhalofop-butyl |
| (I-31) | cinosulfuron + dimepiperate |
| (I-31) | cinosulfuron + esprocarb |
| (I-31) | cinosulfuron + mefenacet |
| (I-31) | cinosulfuron + mefenacet + dymron |
| (I-31) | cinosulfuron + molinate |
| (I-31) | cinosulfuron + oxaziclomefone |
| (I-31) | cinosulfuron + pretilachlor |
| (I-31) | cinosulfuron + pretilachlor + dymron |
| (I-31) | cinosulfuron + pretilachlor + fenclorim |
| (I-31) | cinosulfuron + pretilachlor + quinclorac |
| (I-31) | cinosulfuron + pyriftalid |
| (I-31) | clefoxydim |
| (I-31) | clodinafop-propargyl |
| (I-31) | clodinafop-propargyl + cloquintocet-mexyl |
| (I-31) | clomazone |
| (I-31) | clomazone + propanil |
| (I-31) | clomeprop |
| (I-31) | clomeprop + pretilachlor |
| (I-31) | cumyluron |
| (I-31) | cyanazine |
| (I-31) | cyclosulfamuron |
| (I-31) | cyclosulfamuron + dymron |
| (I-31) | cyclosulfamuron + anilofos |
| (I-31) | cyclosulfamuron + benfuresate |
| (I-31) | cyclosulfamuron + butachlor |
| (I-31) | cyclosulfamuron + cafenstrole + dymron |
| (I-31) | cyclosulfamuron + cyhalofop-butyl |
| (I-31) | cyclosulfamuron + dimepiperate |
| (I-31) | cyclosulfamuron + esprocarb |
| (I-31) | cyclosulfamuron + mefenacet |
| (I-31) | cyclosulfamuron + mefenacet + dymron |
| (I-31) | cyclosulfamuron + oxaziclomefone |
| (I-31) | cyclosulfamuron + pentoxazone |
| (I-31) | cyclosulfamuron + pretilachlor |
| (I-31) | cyclosulfamuron + quinclorac |
| (I-31) | cyhalofop-butyl |
| (I-31) | cyhalofop-butyl + bentazone |
| (I-31) | 2,4-D |
| (I-31) | dichlorprop-P |
| (I-31) | diethatyl-ethyl |
| (I-31) | dimepiperate |
| (I-31) | dimethametryn |
| (I-31) | dimethametryn + piperophos |
| (I-31) | dimethenamid |
| (I-31) | S-dimethenamid |
| (I-31) | dithiopyr |
| (I-31) | dymron |
| (I-31) | esprocarb |
| (I-31) | ethoxysulfuron |
| (I-31) | ethoxysulfuron + dymron |
| (I-31) | ethoxysulfuron + anilofos |
| (I-31) | ethoxysulfuron + anilofos + dymron |
| (I-31) | ethoxysulfuron + benfuresate |
| (I-31) | ethoxysulfuron + anilofos + benfuresate |
| (I-31) | ethoxysulfuron + benfuresate + dymron |
| (I-31) | ethoxysulfuron + butachlor |
| (I-31) | ethoxysulfuron + cafenstrole |
| (I-31) | ethoxysulfuron + cafenstrole + dymron |
| (I-31) | ethoxysulfuron + cyhalofop-butyl |
| (I-31) | ethoxysulfuron + dimepiperate |
| (I-31) | ethoxysulfuron + esprocarb |
| (I-31) | ethoxysulfuron + mefenacet |
| (I-31) | ethoxysulfuron + mefenacet + dymron |
| (I-31) | ethoxysulfuron + oxaziclomefone |
| (I-31) | ethoxysulfuron + pretilachlor + dymron |
| (I-31) | ethoxysulfuron + pretilachlor + pyrazolate |
| (I-31) | etobenzanid |
| (I-31) | fenoxaprop-P-ethyl |
| (I-31) | fenoxaprop-(P)-ethyl + fenclorim |
| (I-31) | fenoxaprop-(P)-ethyl + isoxadifen-ethyl |
| (I-31) | fenoxaprop-P-ethyl + mefenpyr-diethyl |
| (I-31) | fentrazamide |
| (I-31) | fentrazamide + pentoxazone |
| (I-31) | fentrazamide + bispyribac-sodium |
| (I-31) | fentrazamide + bromobutide |
| (I-31) | fentrazamide + benzofenap |
| (I-31) | fentrazamide + clomeprop |
| (I-31) | fentrazamide + dymron |
| (I-31) | fentrazamide + flufenacet |
| (I-31) | fentrazamide + oxaziclomefone |
| (I-31) | fentrazamide + propanil |
| (I-31) | fentrazamide + pyribenzoxim |
| (I-31) | fentrazamide + pyriminobac-methyl |
| (I-31) | fentrazamide + quinoclamine |
| (I-31) | fentrazamide + azimsulfuron |
| (I-31) | fentrazamide + azimsulfuron + dymron |
| (I-31) | fentrazamide + azimsulfuron + bensulfuron-methyl |
| (I-31) | fentrazamide + bensulfuron-methyl |
| (I-31) | fentrazamide + bensulfuron-methyl + dymron |
| (I-31) | fentrazamide + cinosulfuron |
| (I-31) | fentrazamide + cinosulfuron + dymron |
| (I-31) | fentrazamide + cyclosulfamuron |
| (I-31) | fentrazamide + cyclosulfamuron + dymron |
| (I-31) | fentrazamide + ethoxysulfuron |
| (I-31) | fentrazamide + ethoxysulfuron + dymron |
| (I-31) | fentrazamide + imazosulfuron |
| (I-31) | fentrazamide + imazosulfuron + dymron |
| (I-31) | fentrazamide + pyrazosulfuron-ethyl |
| (I-31) | fentrazamide + pyrazosulfuron-ethyl + dymron |
| (I-31) | fluazifop-P-butyl |
| (I-31) | flucarbazone-sodium |
| (I-31) | flucarbazone-sodium + fenclorim |
| (I-31) | flucarbazone-sodium + isoxadifen-ethyl |
| (I-31) | flucarbazone-sodium + mefenpyr-diethyl |
| (I-31) | flufenacet |
| (I-31) | flufenacet + 2,4-D |
| (I-31) | flufenacet + diflufenican |
| (I-31) | flufenacet + metosulam |
| (I-31) | flufenacet + propanil |
| (I-31) | flufenacet + dichlormid |
| (I-31) | flufenacet + furilazole |
| (I-31) | flufenacet + R-29148 |
| (I-31) | flufenacet + fenclorim |
| (I-31) | flufenacet + isoxadifen-ethyl |
| (I-31) | flufenacet + mefenpyr-diethyl |
| (I-31) | flumetsulam |
| (I-31) | halosulfuron-methyl |
| (I-31) | halosulfuron-methyl + cafenstrole + cyhalofop-butyl |
| (I-31) | haloxyfop-P-methyl |
| (I-31) | HOK-201 |
| (I-31) | imazamox |
| (I-31) | imazaquin |
| (I-31) | imazethapyr |
| (I-31) | imazosulfuron |
| (I-31) | imazosulfuron + dymron |
| (I-31) | imazosulfuron + anilofos |
| (I-31) | imazosulfuron + benfuresate |
| (I-31) | imazosulfuron + butachlor |
| (I-31) | imazosulfuron + cafenstrole + dymron |
| (I-31) | imazosulfuron + cyhalofop-butyl |
| (I-31) | imazosulfuron + dimepiperate |
| (I-31) | imazosulfuron + dimethametryn |
| (I-31) | imazosulfuron + dimethametryn + pretilachlor |
| (I-31) | imazosulfuron + esprocarb + dymron |
| (I-31) | imazosulfuron + etobenzanid + dymron |
| (I-31) | imazosulfuron + mefenacet + dymron |
| (I-31) | imazosulfuron + oxaziclomefone |
| (I-31) | imazosulfuron + pentoxazone + dymron |
| (I-31) | imazosulfuron + pretilachlor + dymron |
| (I-31) | imazosulfuron + pyributicarb + dymron |
| (I-31) | indanofan |
| (I-31) | isoxaflutole |
| (I-31) | MCPA |
| (I-31) | mefenacet |
| (I-31) | mefenacet + quinoclamine |
| (I-31) | mefenacet + molinate |
| (I-31) | mefenacet + bromobutide + naproanilide |
| (I-31) | mesosulfuron |
| (I-31) | mesosulfuron + dymron |
| (I-31) | mesosulfuron + anilofos |
| (I-31) | mesosulfuron + benfuresate |
| (I-31) | mesosulfuron + cafenstrole + dymron |
| (I-31) | mesosulfuron + cyhalofop-butyl |
| (I-31) | mesosulfuron + dimepiperate |
| (I-31) | mesosulfuron + esprocarb |
| (I-31) | mesosulfuron + mefenacet |
| (I-31) | mesosulfuron + mefenacet + dymron |
| (I-31) | mesosulfuron + oxaziclomefone |
| (I-31) | mesosulfuron + pretilachlor |
| (I-31) | mesosulfuron + pyributicarb |
| (I-31) | mesotrione |
| (I-31) | metolachlor |
| (I-31) | metolachlor + benoxacor |
| (I-31) | S-metolachlor |
| (I-31) | S-metolachlor + benoxacor |
| (I-31) | metosulam |
| (I-31) | metsulfuron-methyl |
| (I-31) | metribuzin |
| (I-31) | molinate |
| (I-31) | molinate + propanil |
| (I-31) | molinate + simetryn |
| (I-31) | naproanilide |
| (I-31) | nicosulfuron |
| (I-31) | OK-701 |
| (I-31) | oxadiargyl |
| (I-31) | oxadiargyl + propanil |
| (I-31) | oxadiazon |
| (I-31) | oxaziclomefone |
| (I-31) | oxyfluorfen |
| (I-31) | pendimethalin |
| (I-31) | pentoxazone |
| (I-31) | pentoxazone + cumyluron |
| (I-31) | piperophos |
| (I-31) | piperophos + 2,4-D |
| (I-31) | pretilachlor |
| (I-31) | pretilachlor + dimethametryn |
| (I-31) | pretilachlor + dymron |
| (I-31) | pretilachlor + dimethametryn + dymron |
| (I-31) | pretilachlor + fenclorim |
| (I-31) | profoxydim |
| (I-31) | propanil |
| (I-31) | propoxycarbazone-sodium |
| (I-31) | pyraclonil |
| (I-31) | pyrazolate |
| (I-31) | pyrazolate + butachlor |
| (I-31) | pyrazolate + pretilachlor |
| (I-31) | pyrazosulfuron-ethyl |
| (I-31) | pyrazosulfuron-ethyl + dymron |
| (I-31) | pyrazosulfuron-ethyl + etobenzanid |
| (I-31) | pyrazosulfuron-ethyl + esprocarb |
| (I-31) | pyrazosulfuron-ethyl + esprocarb + dimethametryn |
| (I-31) | pyrazosulfuron-ethyl + esprocarb + pretilachlor |
| (I-31) | pyrazosulfuron-ethyl + indanofan |
| (I-31) | pyrazosulfuron-ethyl + mefenacet |
| (I-31) | pyrazosulfuron-ethyl + molinate |
| (I-31) | pyrazosulfuron-ethyl + pentoxazone |
| (I-31) | pyrazosulfuron-ethyl + anilofos + dymron |
| (I-31) | pyrazosulfuron-ethyl + benfuresate + dymron |
| (I-31) | pyrazosulfuron-ethyl + butachlor + dymron |
| (I-31) | pyrazosulfuron-ethyl + cafenstrole |
| (I-31) | pyrazosulfuron-ethyl + cafenstrole + cyhalofop-butyl |
| (I-31) | pyrazosulfuron-ethyl + dimepiperate + dymron |
| (I-31) | pyrazosulfuron-ethyl + mefenacet + dymron |
| (I-31) | pyrazosulfuron-ethyl + oxaziclomefone + dymron |
| (I-31) | pyrazosulfuron-ethyl + pretilachlor + dymron |
| (I-31) | pyrazosulfuron-ethyl + pretilachlor + quinclorac |
| (I-31) | pyrazosulfuron-ethyl + thenylchlor |
| (I-31) | pyrazoxyfen |
| (I-31) | pyribenzoxim |
| (I-31) | pyributicarb |
| (I-31) | pyributicarb + pretilachlor |
| (I-31) | pyriftalid |
| (I-31) | pyriminobac-methyl |
| (I-31) | quinclorac |
| (I-31) | quinoclamine |
| (I-31) | simazine |
| (I-31) | simetryn |
| (I-31) | sulcotrione |
| (I-31) | terbuthylazine |
| (I-31) | thenylchlor |
| (I-31) | thifensulfuron-methyl |
| (I-31) | tiocarbazil |
| (I-31) | tritosulfuron |
| (I-34) | acetochlor |
| (I-34) | acetochlor + dichlormid |
| (I-34) | acetochlor + furilazole |
| (I-34) | acetochlor + R-29148 |
| (I-34) | alachlor |
| (I-34) | amicarbazone |
| (I-34) | amidosulfuron |
| (I-34) | anilofos |
| (I-34) | anilofos + 2,4-D |
| (I-34) | anilofos + propanil |
| (I-34) | anilofos + quinoclamine |
| (I-34) | atrazine |
| (I-34) | azimsulfuron |
| (I-34) | azimsulfuron + dymron |
| (I-34) | azimsulfuron + indanofan |
| (I-34) | azimsulfuron + anilofos |
| (I-34) | azimsulfuron + benfuresate |
| (I-34) | azimsulfuron + butachlor |
| (I-34) | azimsulfuron + cafenstrole |
| (I-34) | azimsulfuron + cyhalofop-butyl |
| (I-34) | azimsulfuron + dimepiperate |
| (I-34) | azimsulfuron + esprocarb |
| (I-34) | azimsulfuron + mefenacet |
| (I-34) | azimsulfuron + oxaziclomefone |
| (I-34) | azimsulfuron + pretilachlor |
| (I-34) | azimsulfuron + thenylchlor |
| (I-34) | azimsulfuron + anilofos + dymron |
| (I-34) | azimsulfuron + benfuresate + dymron |
| (I-34) | azimsulfuron + bensulfuron + cafenstrole |
| (I-34) | azimsulfuron + bensulfuron + cyhalofop-butyl |
| (I-34) | azimsulfuron + bensulfuron + dymron |
| (I-34) | azimsulfuron + bensulfuron + dimethametryn |
| (I-34) | azimsulfuron + bensulfuron + indanofan |
| (I-34) | azimsulfuron + bensulfuron + pretilachlor |
| (I-34) | azimsulfuron + bensulfuron + thenylchlor |
| (I-34) | azimsulfuron + butachlor + dymron |
| (I-34) | azimsulfuron + cafenstrole + dymron |
| (I-34) | azimsulfuron + cyhalofop-butyl + dymron |
| (I-34) | azimsulfuron + mefenacet + dymron |
| (I-34) | azimsulfuron + oxaziclomefone + dymron |
| (I-34) | azimsulfuron + pretilachlor + dymron |
| (I-34) | benfuresate |
| (I-34) | bensulfuron-methyl |
| (I-34) | bensulfuron-methyl + dymron |
| (I-34) | bensulfuron-methyl + anilofos |
| (I-34) | bensulfuron-methyl + benfuresate |
| (I-34) | bensulfuron-methyl + butachlor |
| (I-34) | bensulfuron-methyl + cafenstrole |
| (I-34) | bensulfuron-methyl + cyhalofop-butyl |
| (I-34) | bensulfuron-methyl + dimepiperate |
| (I-34) | bensulfuron-methyl + dithiopyr |
| (I-34) | bensulfuron-methyl + esprocarb |
| (I-34) | bensulfuron-methyl + indanofan |
| (I-34) | bensulfuron-methyl + mefenacet |
| (I-34) | bensulfuron-methyl + molinate |
| (I-34) | bensulfuron-methyl + oxaziclomefone |
| (I-34) | bensulfuron-methyl + pretilachlor |
| (I-34) | bensulfuron-methyl + pyributicarb |
| (I-34) | bensulfuron-methyl + quinclorac |
| (I-34) | bensulfuron-methyl + thenylchlor |
| (I-34) | bensulfuron-methyl + anilofos + dymron |
| (I-34) | bensulfuron-methyl + benfuresate + dymron |
| (I-34) | bensulfuron-methyl + butachlor + dymron |
| (I-34) | bensulfuron-methyl + cyhalofop-butyl + dymron |
| (I-34) | bensulfuron-methyl + dithiopyr + quinclorac |
| (I-34) | bensulfuron-methyl + mefenacet + benthiocarb |
| (I-34) | bensulfuron-methyl + mefenacet + dymron |
| (I-34) | bensulfuron-methyl + mefenacet + molinate |
| (I-34) | bensulfuron-methyl + oxaziclomefone + dymron |
| (I-34) | bensulfuron-methyl + pretilachlor + dymron |
| (I-34) | bensulfuron-methyl + pyributicarb + dymron |
| (I-34) | bentazone |
| (I-34) | bentazone + quinclorac |
| (I-34) | benthiocarb (thiobencarb) |
| (I-34) | benthiocarb + chlornitrofen |
| (I-34) | benthiocarb + propanil |
| (I-34) | benthiocarb + simetryn |
| (I-34) | benzobicyclon |
| (I-34) | benzofenap |
| (I-34) | benzofenap + thenylchlor + cumyluron |
| (I-34) | bifenox |
| (I-34) | bifenox + pretilachlor |
| (I-34) | bifenox + thenylchlor |
| (I-34) | bispyribac-sodium |
| (I-34) | bispyribac-sodium + benthiocarb |
| (I-34) | bromobutide |
| (I-34) | bromobutide + pyrazoxyfen |
| (I-34) | bromobutide + benzofenap + pyributicarb |
| (I-34) | bromobutide + bifenox + pyrazolate |
| (I-34) | bromobutide + pyrazoxyfen + thenylchlor |
| (I-34) | butachlor |
| (I-34) | butachlor + chlomethoxyfen |
| (I-34) | butachlor + oxadiazon |
| (I-34) | butachlor + propanil |
| (I-34) | butachlor + pyrazolate |
| (I-34) | butamifos |
| (I-34) | butamifos + bromobutide |
| (I-34) | butenachlor |
| (I-34) | cafenstrole |
| (I-34) | cafenstrole + dymron |
| (I-34) | cafenstrole + cyhalofop-butyl + dymron |
| (I-34) | carfentrazone-ethyl |
| (I-34) | chlomethoxyfen |
| (I-34) | chlornitrofen |
| (I-34) | chlornitrofen + dymron |
| (I-34) | cinmethylin |
| (I-34) | cinmethylin + 2,4-D |
| (I-34) | cinosulfuron |
| (I-34) | cinosulfuron + dymron |
| (I-34) | cinosulfuron + anilofos |
| (I-34) | cinosulfuron + benfuresate |
| (I-34) | cinosulfuron + butachlor |
| (I-34) | cinosulfuron + cafenstrole + dymron |
| (I-34) | cinosulfuron + cyhalofop-butyl |
| (I-34) | cinosulfuron + dimepiperate |
| (I-34) | cinosulfuron + esprocarb |
| (I-34) | cinosulfuron + mefenacet |
| (I-34) | cinosulfuron + mefenacet + dymron |
| (I-34) | cinosulfuron + molinate |
| (I-34) | cinosulfuron + oxaziclomefone |
| (I-34) | cinosulfuron + pretilachlor |
| (I-34) | cinosulfuron + pretilachlor + dymron |
| (I-34) | cinosulfuron + pretilachlor + fenclorim |
| (I-34) | cinosulfuron + pretilachlor + quinclorac |
| (I-34) | cinosulfuron + pyriftalid |
| (I-34) | clefoxydim |
| (I-34) | clodinafop-propargyl |
| (I-34) | clodinafop-propargyl + cloquintocet-mexyl |
| (I-34) | clomazone |
| (I-34) | clomazone + propanil |
| (I-34) | clomeprop |
| (I-34) | clomeprop + pretilachlor |
| (I-34) | cumyluron |
| (I-34) | cyanazine |
| (I-34) | cyclosulfamuron |
| (I-34) | cyclosulfamuron + dymron |
| (I-34) | cyclosulfamuron + anilofos |
| (I-34) | cyclosulfamuron + benfuresate |
| (I-34) | cyclosulfamuron + butachlor |
| (I-34) | cyclosulfamuron + cafenstrole + dymron |
| (I-34) | cyclosulfamuron + cyhalofop-butyl |
| (I-34) | cyclosulfamuron + dimepiperate |
| (I-34) | cyclosulfamuron + esprocarb |
| (I-34) | cyclosulfamuron + mefenacet |
| (I-34) | cyclosulfamuron + mefenacet + dymron |
| (I-34) | cyclosulfamuron + oxaziclomefone |
| (I-34) | cyclosulfamuron + pentoxazone |
| (I-34) | cyclosulfamuron + pretilachlor |
| (I-34) | cyclosulfamuron + quinclorac |
| (I-34) | cyhalofop-butyl |
| (I-34) | cyhalofop-butyl + bentazone |
| (I-34) | 2,4-D |
| (I-34) | dichlorprop-P |
| (I-34) | diethatyl-ethyl |
| (I-34) | dimepiperate |
| (I-34) | dimethametryn |
| (I-34) | dimethametryn + piperophos |
| (I-34) | dimethenamid |
| (I-34) | S-dimethenamid |
| (I-34) | dithiopyr |
| (I-34) | dymron |
| (I-34) | esprocarb |
| (I-34) | ethoxysulfuron |
| (I-34) | ethoxysulfuron + dymron |
| (I-34) | ethoxysulfuron + anilofos |
| (I-34) | ethoxysulfuron + anilofos + dymron |
| (I-34) | ethoxysulfuron + benfuresate |
| (I-34) | ethoxysulfuron + anilofos + benfuresate |
| (I-34) | ethoxysulfuron + benfuresate + dymron |
| (I-34) | ethoxysulfuron + butachlor |
| (I-34) | ethoxysulfuron + cafenstrole |
| (I-34) | ethoxysulfuron + cafenstrole + dymron |
| (I-34) | ethoxysulfuron + cyhalofop-butyl |
| (I-34) | ethoxysulfuron + dimepiperate |
| (I-34) | ethoxysulfuron + esprocarb |
| (I-34) | ethoxysulfuron + mefenacet |
| (I-34) | ethoxysulfuron + mefenacet + dymron |
| (I-34) | ethoxysulfuron + oxaziclomefone |
| (I-34) | ethoxysulfuron + pretilachlor + dymron |
| (I-34) | ethoxysulfuron + pretilachlor + pyrazolate |
| (I-34) | etobenzanid |
| (I-34) | fenoxaprop-P-ethyl |
| (I-34) | fenoxaprop-(P)-ethyl + fenclorim |
| (I-34) | fenoxaprop-(P)-ethyl + isoxadifen-ethyl |
| (I-34) | fenoxaprop-P-ethyl + mefenpyr-diethyl |
| (I-34) | fentrazamide |
| (I-34) | fentrazamide + pentoxazone |
| (I-34) | fentrazamide + bispyribac-sodium |
| (I-34) | fentrazamide + bromobutide |
| (I-34) | fentrazamide + benzofenap |
| (I-34) | fentrazamide + clomeprop |
| (I-34) | fentrazamide + dymron |
| (I-34) | fentrazamide + flufenacet |
| (I-34) | fentrazamide + oxaziclomefone |
| (I-34) | fentrazamide + propanil |
| (I-34) | fentrazamide + pyribenzoxim |
| (I-34) | fentrazamide + pyriminobac-methyl |
| (I-34) | fentrazamide + quinoclamine |
| (I-34) | fentrazamide + azimsulfuron |
| (I-34) | fentrazamide + azimsulfuron + dymron |
| (I-34) | fentrazamide + azimsulfuron + bensulfuron-methyl |
| (I-34) | fentrazamide + bensulfuron-methyl |
| (I-34) | fentrazamide + bensulfuron-methyl + dymron |
| (I-34) | fentrazamide + cinosulfuron |
| (I-34) | fentrazamide + cinosulfuron + dymron |
| (I-34) | fentrazamide + cyclosulfamuron |
| (I-34) | fentrazamide + cyclosulfamuron + dymron |
| (I-34) | fentrazamide + ethoxysulfuron |
| (I-34) | fentrazamide + ethoxysulfuron + dymron |
| (I-34) | fentrazamide + imazosulfuron |
| (I-34) | fentrazamide + imazosulfuron + dymron |
| (I-34) | fentrazamide + pyrazosulfuron-ethyl |
| (I-34) | fentrazamide + pyrazosulfuron-ethyl + dymron |
| (I-34) | fluazifop-P-butyl |
| (I-34) | flucarbazone-sodium |
| (I-34) | flucarbazone-sodium + fenclorim |
| (I-34) | flucarbazone-sodium + isoxadifen-ethyl |
| (I-34) | flucarbazone-sodium + mefenpyr-diethyl |
| (I-34) | flufenacet |
| (I-34) | flufenacet + 2,4-D |
| (I-34) | flufenacet + diflufenican |
| (I-34) | flufenacet + metosulam |
| (I-34) | flufenacet + propanil |
| (I-34) | flufenacet + dichlormid |
| (I-34) | flufenacet + furilazole |
| (I-34) | flufenacet + R-29148 |
| (I-34) | flufenacet + fenclorim |
| (I-34) | flufenacet + isoxadifen-ethyl |
| (I-34) | flufenacet + mefenpyr-diethyl |
| (I-34) | flumetsulam |
| (I-34) | halosulfuron-methyl |
| (I-34) | halosulfuron-methyl + cafenstrole + cyhalofop-butyl |
| (I-34) | haloxyfop-P-methyl |
| (I-34) | HOK-201 |
| (I-34) | imazamox |
| (I-34) | imazaquin |
| (I-34) | imazethapyr |
| (I-34) | imazosulfuron |
| (I-34) | imazosulfuron + dymron |
| (I-34) | imazosulfuron + anilofos |
| (I-34) | imazosulfuron + benfuresate |
| (I-34) | imazosulfuron + butachlor |
| (I-34) | imazosulfuron + cafenstrole + dymron |
| (I-34) | imazosulfuron + cyhalofop-butyl |
| (I-34) | imazosulfuron + dimepiperate |
| (I-34) | imazosulfuron + dimethametryn |
| (I-34) | imazosulfuron + dimethametryn + pretilachlor |
| (I-34) | imazosulfuron + esprocarb + dymron |
| (I-34) | imazosulfuron + etobenzanid + dymron |
| (I-34) | imazosulfuron + mefenacet + dymron |
| (I-34) | imazosulfuron + oxaziclomefone |
| (I-34) | imazosulfuron + pentoxazone + dymron |
| (I-34) | imazosulfuron + pretilachlor + dymron |
| (I-34) | imazosulfuron + pyributicarb + dymron |
| (I-34) | indanofan |
| (I-34) | isoxaflutole |
| (I-34) | MCPA |
| (I-34) | mefenacet |
| (I-34) | mefenacet + molinate |
| (I-34) | mefenacet + quinoclamine |
| (I-34) | mefenacet + bromobutide + naproanilide |
| (I-34) | mesosulfuron |
| (I-34) | mesosulfuron + dymron |
| (I-34) | mesosulfuron + anilofos |
| (I-34) | mesosulfuron + benfuresate |
| (I-34) | mesosulfuron + cafenstrole + dymron |
| (I-34) | mesosulfuron + cyhalofop-butyl |
| (I-34) | mesosulfuron + dimepiperate |
| (I-34) | mesosulfuron + esprocarb |
| (I-34) | mesosulfuron + mefenacet |
| (I-34) | mesosulfuron + mefenacet + dymron |
| (I-34) | mesosulfuron + oxaziclomefone |
| (I-34) | mesosulfuron + pretilachlor |
| (I-34) | mesosulfuron + pyributicarb |
| (I-34) | mesotrione |
| (I-34) | metolachlor |
| (I-34) | metolachlor + benoxacor |
| (I-34) | S-metolachlor |
| (I-34) | S-metolachlor + benoxacor |
| (I-34) | metosulam |
| (I-34) | metsulfuron-methyl |
| (I-34) | metribuzin |
| (I-34) | molinate |
| (I-34) | molinate + propanil |
| (I-34) | molinate + simetryn |
| (I-34) | naproanilide |
| (I-34) | nicosulfuron |
| (I-34) | OK-701 |
| (I-34) | oxadiargyl |
| (I-34) | oxadiargyl + propanil |
| (I-34) | oxadiazon |
| (I-34) | oxaziclomefone |
| (I-34) | oxyfluorfen |
| (I-34) | pendimethalin |
| (I-34) | pentoxazone |
| (I-34) | pentoxazone + cumyluron |
| (I-34) | piperophos |
| (I-34) | piperophos + 2,4-D |
| (I-34) | pretilachlor |
| (I-34) | pretilachlor + dimethametryn |
| (I-34) | pretilachlor + dymron |
| (I-34) | pretilachlor + dimethametryn + dymron |
| (I-34) | pretilachlor + fenclorim |
| (I-34) | profoxydim |
| (I-34) | propanil |
| (I-34) | propoxycarbazone-sodium |
| (I-34) | pyraclonil |
| (I-34) | pyrazolate |
| (I-34) | pyrazolate + butachlor |
| (I-34) | pyrazolate + pretilachlor |
| (I-34) | pyrazosulfuron-ethyl |
| (I-34) | pyrazosulfuron-ethyl + dymron |
| (I-34) | pyrazosulfuron-ethyl + etobenzanid |
| (I-34) | pyrazosulfuron-ethyl + esprocarb |
| (I-34) | pyrazosulfuron-ethyl + esprocarb + dimethametryn |
| (I-34) | pyrazosulfuron-ethyl + esprocarb + pretilachlor |
| (I-34) | pyrazosulfuron-ethyl + indanofan |
| (I-34) | pyrazosulfuron-ethyl + mefenacet |
| (I-34) | pyrazosulfuron-ethyl + molinate |
| (I-34) | pyrazosulfuron-ethyl + pentoxazone |
| (I-34) | pyrazosulfuron-ethyl + anilofos + dymron |
| (I-34) | pyrazosulfuron-ethyl + benfuresate + dymron |
| (I-34) | pyrazosulfuron-ethyl + butachlor + dymron |
| (I-34) | pyrazosulfuron-ethyl + cafenstrole |
| (I-34) | pyrazosulfuron-ethyl + cafenstrole + cyhalofop-butyl |
| (I-34) | pyrazosulfuron-ethyl + dimepiperate + dymron |
| (I-34) | pyrazosulfuron-ethyl + mefenacet + dymron |
| (I-34) | pyrazosulfuron-ethyl + oxaziclomefone + dymron |
| (I-34) | pyrazosulfuron-ethyl + pretilachlor + dymron |
| (I-34) | pyrazosulfuron-ethyl + pretilachlor + quinclorac |
| (I-34) | pyrazosulfuron-ethyl + thenylchlor |
| (I-34) | pyrazoxyfen |
| (I-34) | pyribenzoxim |
| (I-34) | pyributicarb |
| (I-34) | pyributicarb + pretilachlor |
| (I-34) | pyriftalid |
| (I-34) | pyriminobac-methyl |
| (I-34) | quinclorac |
| (I-34) | quinoclamine |
| (I-34) | simazine |
| (I-34) | simetryn |
| (I-34) | sulcotrione |
| (I-34) | terbuthylazine |
| (I-34) | thenylchlor |
| (I-34) | thifensulfuron-methyl |
| (I-34) | tiocarbazil |
| (I-34) | tritosulfuron |
| (I-35) | acetochlor |
| (I-35) | acetochlor + dichlormid |
| (I-35) | acetochlor + furilazole |
| (I-35) | acetochlor + R-29148 |
| (I-35) | alachlor |
| (I-35) | amicarbazone |
| (I-35) | amidosulfuron |
| (I-35) | anilofos |
| (I-35) | anilofos + 2,4-D |
| (I-35) | anilofos + propanil |
| (I-35) | anilofos + quinoclamine |
| (I-35) | atrazine |
| (I-35) | azimsulfuron |
| (I-35) | azimsulfuron + dymron |
| (I-35) | azimsulfuron + indanofan |
| (I-35) | azimsulfuron + anilofos |
| (I-35) | azimsulfuron + benfuresate |
| (I-35) | azimsulfuron + butachlor |
| (I-35) | azimsulfuron + cafenstrole |
| (I-35) | azimsulfuron + cyhalofop-butyl |
| (I-35) | azimsulfuron + dimepiperate |
| (I-35) | azimsulfuron + esprocarb |
| (I-35) | azimsulfuron + mefenacet |
| (I-35) | azimsulfuron + oxaziclomefone |
| (I-35) | azimsulfuron + pretilachlor |
| (I-35) | azimsulfuron + thenylchlor |
| (I-35) | azimsulfuron + anilofos + dymron |
| (I-35) | azimsulfuron + benfuresate + dymron |
| (I-35) | azimsulfuron + bensulfuron + cafenstrole |
| (I-35) | azimsulfuron + bensulfuron + cyhalofop-butyl |
| (I-35) | azimsulfuron + bensulfuron + dymron |
| (I-35) | azimsulfuron + bensulfuron + dimethametryn |
| (I-35) | azimsulfuron + bensulfuron + indanofan |
| (I-35) | azimsulfuron + bensulfuron + pretilachlor |
| (I-35) | azimsulfuron + bensulfuron + thenylchlor |
| (I-35) | azimsulfuron + butachlor + dymron |
| (I-35) | azimsulfuron + cafenstrole + dymron |
| (I-35) | azimsulfuron + cyhalofop-butyl + dymron |
| (I-35) | azimsulfuron + mefenacet + dymron |
| (I-35) | azimsulfuron + oxaziclomefone + dymron |
| (I-35) | azimsulfuron + pretilachlor + dymron |
| (I-35) | benfuresate |
| (I-35) | bensulfuron-methyl |
| (I-35) | bensulfuron-methyl + dymron |
| (I-35) | bensulfuron-methyl + anilofos |
| (I-35) | bensulfuron-methyl + benfuresate |
| (I-35) | bensulfuron-methyl + butachlor |
| (I-35) | bensulfuron-methyl + cafenstrole |
| (I-35) | bensulfuron-methyl + cyhalofop-butyl |
| (I-35) | bensulfuron-methyl + dimepiperate |
| (I-35) | bensulfuron-methyl + dithiopyr |
| (I-35) | bensulfuron-methyl + esprocarb |
| (I-35) | bensulfuron-methyl + indanofan |
| (I-35) | bensulfuron-methyl + mefenacet |
| (I-35) | bensulfuron-methyl + metsulfuron-methyl |
| (I-35) | bensulfuron-methyl + molinate |
| (I-35) | bensulfuron-methyl + oxaziclomefone |
| (I-35) | bensulfuron-methyl + pretilachlor |
| (I-35) | bensulfuron-methyl + pyributicarb |
| (I-35) | bensulfuron-methyl + quinclorac |
| (I-35) | bensulfuron-methyl + thenylchlor |
| (I-35) | bensulfuron-methyl + anilofos + dymron |
| (I-35) | bensulfuron-methyl + benfuresate + dymron |
| (I-35) | bensulfuron-methyl + butachlor + dymron |
| (I-35) | bensulfuron-methyl + cyhalofop-butyl + dymron |
| (I-35) | bensulfuron-methyl + dithiopyr + quinclorac |
| (I-35) | bensulfuron-methyl + mefenacet + benthiocarb |
| (I-35) | bensulfuron-methyl + mefenacet + dymron |
| (I-35) | bensulfuron-methyl + mefenacet + molinate |
| (I-35) | bensulfuron-methyl + oxaziclomefone + dymron |
| (I-35) | bensulfuron-methyl + pretilachlor + dymron |
| (I-35) | bensulfuron-methyl + pyributicarb + dymron |
| (I-35) | bentazone |
| (I-35) | bentazone + quinclorac |
| (I-35) | benthiocarb (thiobencarb) |
| (I-35) | benthiocarb + chlornitrofen |
| (I-35) | benthiocarb + propanil |
| (I-35) | benthiocarb + simetryn |
| (I-35) | benzobicyclon |
| (I-35) | benzofenap |
| (I-35) | benzofenap + thenylchlor + cumyluron |
| (I-35) | bifenox |
| (I-35) | bifenox + pretilachlor |
| (I-35) | bifenox + thenylchlor |
| (I-35) | bispyribac-sodium |
| (I-35) | bispyribac-sodium + benthiocarb |
| (I-35) | bromobutide |
| (I-35) | bromobutide + pyrazoxyfen |
| (I-35) | bromobutide + benzofenap + pyributicarb |
| (I-35) | bromobutide + bifenox + pyrazolate |
| (I-35) | bromobutide + pyrazoxyfen + thenylchlor |
| (I-35) | butachlor |
| (I-35) | butachlor + chlomethoxyfen |
| (I-35) | butachlor + oxadiazon |
| (I-35) | butachlor + propanil |
| (I-35) | butachlor + pyrazolate |
| (I-35) | butamifos |
| (I-35) | butamifos + bromobutide |
| (I-35) | butenachlor |
| (I-35) | cafenstrole |
| (I-35) | cafenstrole + dymron |
| (I-35) | cafenstrole + cyhalofop-butyl + dymron |
| (I-35) | carfentrazone-ethyl |
| (I-35) | chlomethoxyfen |
| (I-35) | chlornitrofen |
| (I-35) | chlornitrofen + dymron |
| (I-35) | cinmethylin |
| (I-35) | cinmethylin + 2,4-D |
| (I-35) | cinosulfuron |
| (I-35) | cinosulfuron + dymron |
| (I-35) | cinosulfuron + anilofos |
| (I-35) | cinosulfuron + benfuresate |
| (I-35) | cinosulfuron + butachlor |
| (I-35) | cinosulfuron + cafenstrole + dymron |
| (I-35) | cinosulfuron + cyhalofop-butyl |
| (I-35) | cinosulfuron + dimepiperate |
| (I-35) | cinosulfuron + esprocarb |
| (I-35) | cinosulfuron + mefenacet |
| (I-35) | cinosulfuron + mefenacet + dymron |
| (I-35) | cinosulfuron + molinate |
| (I-35) | cinosulfuron + oxaziclomefone |
| (I-35) | cinosulfuron + pretilachlor |
| (I-35) | cinosulfuron + pretilachlor + dymron |
| (I-35) | cinosulfuron + pretilachlor + fenclorim |
| (I-35) | cinosulfuron + pretilachlor + quinclorac |
| (I-35) | cinosulfuron + pyriftalid |
| (I-35) | clefoxydim |
| (I-35) | clodinafop-propargyl |
| (I-35) | clodinafop-propargyl + cloquintocet-mexyl |
| (I-35) | clomazone |
| (I-35) | clomazone + propanil |
| (I-35) | clomeprop |
| (I-35) | clomeprop + pretilachlor |
| (I-35) | cumyluron |
| (I-35) | cyanazine |
| (I-35) | cyclosulfamuron |
| (I-35) | cyclosulfamuron + dymron |
| (I-35) | cyclosulfamuron + anilofos |
| (I-35) | cyclosulfamuron + benfuresate |
| (I-35) | cyclosulfamuron + butachlor |
| (I-35) | cyclosulfamuron + cafenstrole + dymron |
| (I-35) | cyclosulfamuron + cyhalofop-butyl |
| (I-35) | cyclosulfamuron + dimepiperate |
| (I-35) | cyclosulfamuron + esprocarb |
| (I-35) | cyclosulfamuron + mefenacet |
| (I-35) | cyclosulfamuron + mefenacet + dymron |
| (I-35) | cyclosulfamuron + oxaziclomefone |
| (I-35) | cyclosulfamuron + pentoxazone |
| (I-35) | cyclosulfamuron + pretilachlor |
| (I-35) | cyclosulfamuron + quinclorac |
| (I-35) | cyhalofop-butyl |
| (I-35) | cyhalofop-butyl + bentazone |
| (I-35) | 2,4-D |
| (I-35) | dichlorprop-P |
| (I-35) | diethatyl-ethyl |
| (I-35) | dimepiperate |
| (I-35) | dimethametryn |
| (I-35) | dimethametryn + piperophos |
| (I-35) | dimethenamid |
| (I-35) | S-dimethenamid |
| (I-35) | dithiopyr |
| (I-35) | dymron |
| (I-35) | esprocarb |
| (I-35) | ethoxysulfuron |
| (I-35) | ethoxysulfuron + dymron |
| (I-35) | ethoxysulfuron + anilofos |
| (I-35) | ethoxysulfuron + anilofos + dymron |
| (I-35) | ethoxysulfuron + benfuresate |
| (I-35) | ethoxysulfuron + anilofos + benfuresate |
| (I-35) | ethoxysulfuron + benfuresate + dymron |
| (I-35) | ethoxysulfuron + butachlor |
| (I-35) | ethoxysulfuron + cafenstrole |
| (I-35) | ethoxysulfuron + cafenstrole + dymro |
| (I-35) | ethoxysulfuron + cyhalofop-butyl |
| (I-35) | ethoxysulfuron + dimepiperate |
| (I-35) | ethoxysulfuron + esprocarb |
| (I-35) | ethoxysulfuron + mefenacet |
| (I-35) | ethoxysulfuron + mefenacet + dymron |
| (I-35) | ethoxysulfuron + oxaziclomefone |
| (I-35) | ethoxysulfuron + pretilachlor + dymron |
| (I-35) | ethoxysulfuron + pretilachlor + pyrazolate |
| (I-35) | etobenzanid |
| (I-35) | fenoxaprop-P-ethyl |
| (I-35) | fenoxaprop-(P)-ethyl + fenclorim |
| (I-35) | fenoxaprop-(P)-ethyl + isoxadifen-ethyl |
| (I-35) | fenoxaprop-P-ethyl + mefenpyr-diethyl |
| (I-35) | fentrazamide |
| (I-35) | fentrazamide + pentoxazone |
| (I-35) | fentrazamide + bispyribac-sodium |
| (I-35) | fentrazamide + bromobutide |
| (I-35) | fentrazamide + benzofenap |
| (I-35) | fentrazamide + clomeprop |
| (I-35) | fentrazamide + dymron |
| (I-35) | fentrazamide + flufenacet |
| (I-35) | fentrazamide + oxaziclomefone |
| (I-35) | fentrazamide + propanil |
| (I-35) | fentrazamide + pyribenzoxim |
| (I-35) | fentrazamide + pyriminobac-methyl |
| (I-35) | fentrazamide + quinoclamine |
| (I-35) | fentrazamide + azimsulfuron |
| (I-35) | fentrazamide + azimsulfuron + dymron |
| (I-35) | fentrazamide + azimsulfuron + bensulfuron-methyl |
| (I-35) | fentrazamide + bensulfuron-methyl |
| (I-35) | fentrazamide + bensulfuron-methyl + dymron |
| (I-35) | fentrazamide + cinosulfuron |
| (I-35) | fentrazamide + cinosulfuron + dymron |
| (I-35) | fentrazamide + cyclosulfamuron |
| (I-35) | fentrazamide + cyclosulfamuron + dymron |
| (I-35) | fentrazamide + ethoxysulfuron |
| (I-35) | fentrazamide + ethoxysulfuron + dymron |
| (I-35) | fentrazamide + imazosulfuron |
| (I-35) | fentrazamide + imazosulfuron + dymron |
| (I-35) | fentrazamide + pyrazosulfuron-ethyl |
| (I-35) | fentrazamide + pyrazosulfuron-ethyl + dymron |
| (I-35) | fluazifop-P-butyl |
| (I-35) | flucarbazone-sodium |
| (I-35) | flucarbazone-sodium + fenclorim |
| (I-35) | flucarbazone-sodium + isoxadifen-ethyl |
| (I-35) | flucarbazone-sodium + mefenpyr-diethyl |
| (I-35) | flufenacet |
| (I-35) | flufenacet + 2,4-D |
| (I-35) | flufenacet + diflufenican |
| (I-35) | flufenacet + metosulam |
| (I-35) | flufenacet + propanil |
| (I-35) | flufenacet + dichlormid |
| (I-35) | flufenacet + furilazole |
| (I-35) | flufenacet + R-29148 |
| (I-35) | flufenacet + fenclorim |
| (I-35) | flufenacet + isoxadifen-ethyl |
| (I-35) | flufenacet + mefenpyr-diethyl |
| (I-35) | flumetsulam |
| (I-35) | halosulfuron-methyl |
| (I-35) | halosulfuron-methyl + cafenstrole + cyhalofop-butyl |
| (I-35) | haloxyfop-P-methyl |
| (I-35) | HOK-201 |
| (I-35) | imazamox |
| (I-35) | imazaquin |
| (I-35) | imazethapyr |
| (I-35) | imazosulfuron |
| (I-35) | imazosulfuron + dymron |
| (I-35) | imazosulfuron + anilofos |
| (I-35) | imazosulfuron + benfuresate |
| (I-35) | imazosulfuron + butachlor |
| (I-35) | imazosulfuron + cafenstrole + dymron |
| (I-35) | imazosulfuron + cyhalofop-butyl |
| (I-35) | imazosulfuron + dimepiperate |
| (I-35) | imazosulfuron + dimethametryn |
| (I-35) | imazosulfuron + dimethametryn + pretilachlor |
| (I-35) | imazosulfuron + esprocarb + dymron |
| (I-35) | imazosulfuron + etobenzanid + dymron |
| (I-35) | imazosulfuron + mefenacet + dymron |
| (I-35) | imazosulfuron + oxaziclomefone |
| (I-35) | imazosulfuron + pentoxazone + dymron |
| (I-35) | imazosulfuron + pretilachlor + dymron |
| (I-35) | imazosulfuron + pyributicarb + dymron |
| (I-35) | indanofan |
| (I-35) | isoxaflutole |
| (I-35) | MCPA |
| (I-35) | mefenacet |
| (I-35) | mefenacet + molinate |
| (I-35) | mefenacet + quinoclamine |
| (I-35) | mefenacet + bromobutide + naproanilide |
| (I-35) | mesosulfuron |
| (I-35) | mesosulfuron + anilofos |
| (I-35) | mesosulfuron + benfuresate |
| (I-35) | mesosulfuron + cafenstrole + dymron |
| (I-35) | mesosulfuron + cyhalofop-butyl |
| (I-35) | mesosulfuron + dimepiperate |
| (I-35) | mesosulfuron + esprocarb |
| (I-35) | mesosulfuron + mefenacet |
| (I-35) | mesosulfuron + mefenacet + dymron |
| (I-35) | mesosulfuron + oxaziclomefone |
| (I-35) | mesosulfuron + pretilachlor |
| (I-35) | mesosulfuron + pyributicarb |
| (I-35) | mesotrione |
| (I-35) | metolachlor |
| (I-35) | metolachlor + benoxacor |
| (I-35) | S-metolachlor |
| (I-35) | S-metolachlor + benoxacor |
| (I-35) | metosulam |
| (I-35) | metsulfuron-methyl |
| (I-35) | metribuzin |
| (I-35) | molinate |
| (I-35) | molinate + propanil |
| (I-35) | molinate + simetryn |
| (I-35) | naproanilide |
| (I-35) | nicosulfuron |
| (I-35) | OK-701 |
| (I-35) | oxadiargyl |
| (I-35) | oxadiargyl + propanil |
| (I-35) | oxadiazon |
| (I-35) | oxaziclomefone |
| (I-35) | oxyfluorfen |
| (I-35) | pendimethalin |
| (I-35) | pentoxazone |
| (I-35) | pentoxazone + cumyluron |
| (I-35) | piperophos |
| (I-35) | piperophos + 2,4-D |
| (I-35) | pretilachlor |
| (I-35) | pretilachlor + dimethametryn |
| (I-35) | pretilachlor + dymron |
| (I-35) | pretilachlor + dimethametryn + dymron |
| (I-35) | pretilachlor + fenclorim |
| (I-35) | profoxydim |
| (I-35) | propanil |
| (I-35) | propoxycarbazone-sodium |
| (I-35) | pyraclonil |
| (I-35) | pyrazolate |
| (I-35) | pyrazolate + butachlor |
| (I-35) | pyrazolate + pretilachlor |
| (I-35) | pyrazosulfuron-ethyl |
| (I-35) | pyrazosulfuron-ethyl + dymron |
| (I-35) | pyrazosulfuron-ethyl + etobenzanid |
| (I-35) | pyrazosulfuron-ethyl + esprocarb |
| (I-35) | pyrazosulfuron-ethyl + esprocarb + dimethametryn |
| (I-35) | pyrazosulfuron-ethyl + esprocarb + pretilachlor |
| (I-35) | pyrazosulfuron-ethyl + indanofan |
| (I-35) | pyrazosulfuron-ethyl + mefenacet |
| (I-35) | pyrazosulfuron-ethyl + molinate |
| (I-35) | pyrazosulfuron-ethyl + pentoxazone |
| (I-35) | pyrazosulfuron-ethyl + anilofos + dymron |
| (I-35) | pyrazosulfuron-ethyl + benfuresate + dymron |
| (I-35) | pyrazosulfuron-ethyl + butachlor + dymron |
| (I-35) | pyrazosulfuron-ethyl + cafenstrole |
| (I-35) | pyrazosulfuron-ethyl + cafenstrole + cyhalofop-butyl |
| (I-35) | pyrazosulfuron-ethyl + dimepiperate + dymron |
| (I-35) | pyrazosulfuron-ethyl + mefenacet + dymron |
| (I-35) | pyrazosulfuron-ethyl + oxaziclomefone + dymron |
| (I-35) | pyrazosulfuron-ethyl + pretilachlor + dymron |
| (I-35) | pyrazosulfuron-ethyl + pretilachlor + quinclorac |
| (I-35) | pyrazosulfuron-ethyl + thenylchlor |
| (I-35) | pyrazoxyfen |
| (I-35) | pyribenzoxim |
| (I-35) | pyributicarb |
| (I-35) | pyributicarb + pretilachlor |
| (I-35) | pyriftalid |
| (I-35) | pyriminobac-methyl |
| (I-35) | quinclorac |
| (I-35) | quinoclamine |
| (I-35) | simazine |
| (I-35) | simetryn |
| (I-35) | sulcotrione |
| (I-35) | terbuthylazine |
| (I-35) | thenylchlor |
| (I-35) | thifensulfuron-methyl |
| (I-35) | tiocarbazil |
| (I-35) | tritosulfuron |
| (I-36) | acetochlor |
| (I-36) | acetochlor + dichlormid |
| (I-36) | acetochlor + furilazole |
| (I-36) | acetochlor + R-29148 |
| (I-36) | alachlor |
| (I-36) | amicarbazone |
| (I-36) | amidosulfuron |
| (I-36) | anilofos |
| (I-36) | anilofos + 2,4-D |
| (I-36) | anilofos + propanil |
| (I-36) | anilofos + quinoclamine |
| (I-36) | atrazine |
| (I-36) | azimsulfuron |
| (I-36) | azimsulfuron + dymron |
| (I-36) | azimsulfuron + indanofan |
| (I-36) | azimsulfuron + anilofos |
| (I-36) | azimsulfuron + benfuresate |
| (I-36) | azimsulfuron + butachlor |
| (I-36) | azimsulfuron + cafenstrole |
| (I-36) | azimsulfuron + cyhalofop-butyl |
| (I-36) | azimsulfuron + dimepiperate |
| (I-36) | azimsulfuron + esprocarb |
| (I-36) | azimsulfuron + mefenacet |
| (I-36) | azimsulfuron + oxaziclomefone |
| (I-36) | azimsulfuron + pretilachlor |
| (I-36) | azimsulfuron + thenylchlor |
| (I-36) | azimsulfuron + anilofos + dymron |
| (I-36) | azimsulfuron + benfuresate + dymron |
| (I-36) | azimsulfuron + bensulfuron + cafenstrole |
| (I-36) | azimsulfuron + bensulfuron + cyhalofop-butyl |
| (I-36) | azimsulfuron + bensulfuron + dymron |
| (I-36) | azimsulfuron + bensulfuron + dimethametryn |
| (I-36) | azimsulfuron + bensulfuron + indanofan |
| (I-36) | azimsulfuron + bensulfuron + pretilachlor |
| (I-36) | azimsulfuron + bensulfuron + thenylchlor |
| (I-36) | azimsulfuron + butachlor + dymron |
| (I-36) | azimsulfuron + cafenstrole + dymron |
| (I-36) | azimsulfuron + cyhalofop-butyl + dymron |
| (I-36) | azimsulfuron + mefenacet + dymron |
| (I-36) | azimsulfuron + oxaziclomefone + dymron |
| (I-36) | azimsulfuron + pretilachlor + dymron |
| (I-36) | benfuresate |
| (I-36) | bensulfuron-methyl |
| (I-36) | bensulfuron-methyl + dymron |
| (I-36) | bensulfuron-methyl + anilofos |
| (I-36) | bensulfuron-methyl + benfuresate |
| (I-36) | bensulfuron-methyl + butachlor |
| (I-36) | bensulfuron-methyl + cafenstrole |
| (I-36) | bensulfuron-methyl + cyhalofop-butyl |
| (I-36) | bensulfuron-methyl + dimepiperate |
| (I-36) | bensulfuron-methyl + dithiopyr |
| (I-36) | bensulfuron-methyl + esprocarb |
| (I-36) | bensulfuron-methyl + indanofan |
| (I-36) | bensulfuron-methyl + mefenacet |
| (I-36) | bensulfuron-methyl + metsulfuron-methyl |
| (I-36) | bensulfuron-methyl + molinate |
| (I-36) | bensulfuron-methyl + oxaziclomefone |
| (I-36) | bensulfuron-methyl + pretilachlor |
| (I-36) | bensulfuron-methyl + pyributicarb |
| (I-36) | bensulfuron-methyl + quinclorac |
| (I-36) | bensulfuron + thenylchlor |
| (I-36) | bensulfuron-methyl + anilofos + dymron |
| (I-36) | bensulfuron-methyl + benfuresate + dymron |
| (I-36) | bensulfuron-methyl + butachlor + dymron |
| (I-36) | bensulfuron-methyl + benfuresate + dimepiperate |
| (I-36) | bensulfuron-methyl + benfuresate + pretilachlor |
| (I-36) | bensulfuron-methyl + cafenstrole + dymron |
| (I-36) | bensulfuron-methyl + cafenstrole + cyhalofop-butyl |
| (I-36) | bensulfuron-methyl + cyhalofop-butyl + dymron |
| (I-36) | bensulfuron-methyl + cyhalofop-butyl + thenylchlor |
| (I-36) | bensulfuron-methyl + dithiopyr + quinclorac |
| (I-36) | bensulfuron-methyl + mefenacet + benthiocarb |
| (I-36) | bensulfuron-methyl + mefenacet + dymron |
| (I-36) | bensulfuron-methyl + mefenacet + molinate |
| (I-36) | bensulfuron-methyl + oxaziclomefone + dymron |
| (I-36) | bensulfuron-methyl + pretilachlor + dymron |
| (I-36) | bensulfuron-methyl + pyributicarb + dymron |
| (I-36) | bentazone |
| (I-36) | bentazone + quinclorac |
| (I-36) | benthiocarb (thiobencarb) |
| (I-36) | benthiocarb + chlornitrofen |
| (I-36) | benthiocarb + propanil |
| (I-36) | benthiocarb + simetryn |
| (I-36) | benzobicyclon |
| (I-36) | benzofenap |
| (I-36) | benzofenap + thenylchlor + cumyluron |
| (I-36) | bifenox |
| (I-36) | bifenox + pretilachlor |
| (I-36) | bifenox + thenylchlor |
| (I-36) | bispyribac-sodium |
| (I-36) | bispyribac-sodium + benthiocarb |
| (I-36) | bromobutide |
| (I-36) | bromobutide + pyrazoxyfen |
| (I-36) | bromobutide + benzofenap + pyributicarb |
| (I-36) | bromobutide + bifenox + pyrazolate |
| (I-36) | bromobutide + pyrazoxyfen + thenylchlor |
| (I-36) | butachlor |
| (I-36) | butachlor + chlomethoxyfen |
| (I-36) | butachlor + oxadiazon |
| (I-36) | butachlor + propanil |
| (I-36) | butachlor + pyrazolate |
| (I-36) | butamifos |
| (I-36) | butamifos + bromobutide |
| (I-36) | butenachlor |
| (I-36) | cafenstrole |
| (I-36) | cafenstrole + dymron |
| (I-36) | cafenstrole + cyhalofop-butyl + dymron |
| (I-36) | carfentrazone-ethyl |
| (I-36) | chlomethoxyfen |
| (I-36) | chlornitrofen |
| (I-36) | chlornitrofen + dymron |
| (I-36) | cinmethylin |
| (I-36) | cinmethylin + 2,4-D |
| (I-36) | cinosulfuron |
| (I-36) | cinosulfuron + dymron |
| (I-36) | cinosulfuron + anilofos |
| (I-36) | cinosulfuron + benfuresate |
| (I-36) | cinosulfuron + butachlor |
| (I-36) | cinosulfuron + cafenstrole + dymron |
| (I-36) | cinosulfuron + cyhalofop-butyl |
| (I-36) | cinosulfuron + dimepiperate |
| (I-36) | cinosulfuron + esprocarb |
| (I-36) | cinosulfuron + mefenacet |
| (I-36) | cinosulfuron + mefenacet + dymron |
| (I-36) | cinosulfuron + molinate |
| (I-36) | cinosulfuron + oxaziclomefone |
| (I-36) | cinosulfuron + pretilachlor |
| (I-36) | cinosulfuron + pretilachlor + dymron |
| (I-36) | cinosulfuron + pretilachlor + fenclorim |
| (I-36) | cinosulfuron + pretilachlor + quinclorac |
| (I-36) | cinosulfuron + pyriftalid |
| (I-36) | clefoxydim |
| (I-36) | clodinafop-propargyl |
| (I-36) | clodinafop-propargyl + cloquintocet-mexyl |
| (I-36) | clomazone |
| (I-36) | clomazone + propanil |
| (I-36) | clomeprop |
| (I-36) | clomeprop + pretilachlor |
| (I-36) | cumyluron |
| (I-36) | cyanazine |
| (I-36) | cyclosulfamuron |
| (I-36) | cyclosulfamuron + dymron |
| (I-36) | cyclosulfamuron + anilofos |
| (I-36) | cyclosulfamuron + benfuresate |
| (I-36) | cyclosulfamuron + butachlor |
| (I-36) | cyclosulfamuron + cafenstrole + dymron |
| (I-36) | cyclosulfamuron + cyhalofop-butyl |
| (I-36) | cyclosulfamuron + dimepiperate |
| (I-36) | cyclosulfamuron + esprocarb |
| (I-36) | cyclosulfamuron + mefenacet |
| (I-36) | cyclosulfamuron + mefenacet + dymron |
| (I-36) | cyclosulfamuron + oxaziclomefone |
| (I-36) | cyclosulfamuron + pentoxazone |
| (I-36) | cyclosulfamuron + pretilachlor |
| (I-36) | cyclosulfamuron + quinclorac |
| (I-36) | cyhalofop-butyl |
| (I-36) | cyhalofop-butyl + bentazone |
| (I-36) | 2,4-D |
| (I-36) | dichlorprop-P |
| (I-36) | diethatyl-ethyl |
| (I-36) | dimepiperate |
| (I-36) | dimethametryn |
| (I-36) | dimethametryn + piperophos |
| (I-36) | dimethenamid |
| (I-36) | S-dimethenamid |
| (I-36) | dithiopyr |
| (I-36) | dymron |
| (I-36) | esprocarb |
| (I-36) | ethoxysulfuron |
| (I-36) | ethoxysulfuron + dymron |
| (I-36) | ethoxysulfuron + anilofos |
| (I-36) | ethoxysulfuron + anilofos + dymron |
| (I-36) | ethoxysulfuron + benfuresate |
| (I-36) | ethoxysulfuron + anilofos + benfuresate |
| (I-36) | ethoxysulfuron + benfuresate + dymron |
| (I-36) | ethoxysulfuron + butachlor |
| (I-36) | ethoxysulfuron + cafenstrole |
| (I-36) | ethoxysulfuron + cafenstrole + dymron |
| (I-36) | ethoxysulfuron + cyhalofop-butyl |
| (I-36) | ethoxysulfuron + dimepiperate |
| (I-36) | ethoxysulfuron + esprocarb |
| (I-36) | ethoxysulfuron + mefenacet |
| (I-36) | ethoxysulfuron + mefenacet + dymron |
| (I-36) | ethoxysulfuron + oxaziclomefone |
| (I-36) | ethoxysulfuron + pretilachlor + dymron |
| (I-36) | ethoxysulfuron + pretilachlor + pyrazolate |
| (I-36) | etobenzanid |
| (I-36) | fenoxaprop-P-ethyl |
| (I-36) | fenoxaprop-(P)-ethyl + fenclorim |
| (I-36) | fenoxaprop-(P)-ethyl + isoxadifen-ethyl |
| (I-36) | fenoxaprop-P-ethyl + mefenpyr-diethyl |
| (I-36) | fentrazamide |
| (I-36) | fentrazamide + pentoxazone |
| (I-36) | fentrazamide + bispyribac-sodium |
| (I-36) | fentrazamide + bromobutide |
| (I-36) | fentrazamide + benzofenap |
| (I-36) | fentrazamide + clomeprop |
| (I-36) | fentrazamide + dymron |
| (I-36) | fentrazamide + flufenacet |
| (I-36) | fentrazamide + oxaziclomefone |
| (I-36) | fentrazamide + propanil |
| (I-36) | fentrazamide + pyribenzoxim |
| (I-36) | fentrazamide + pyriminobac-methyl |
| (I-36) | fentrazamide + quinoclamine |
| (I-36) | fentrazaniide + azimsulfuron |
| (I-36) | fentrazamide + azimsulfuron + dymron |
| (I-36) | fentrazamide + azimsulfuron + bensulfuron-methyl |
| (I-36) | fentrazamide + bensulfuron-methyl |
| (I-36) | fentrazamide + bensulfuron-methyl + dymron |
| (I-36) | fentrazamide + cinosulfuron |
| (I-36) | fentrazamide + cinosulfuron + dymron |
| (I-36) | fentrazamide + cyclosulfamuron |
| (I-36) | fentrazamide + cyclosulfamuron + dymron |
| (I-36) | fentrazamide + ethoxysulfuron |
| (I-36) | fentrazamide + ethoxysulfuron + dymron |
| (I-36) | fentrazamide + imazosulfuron |
| (I-36) | fentrazamide + imazosulfuron + dymron |
| (I-36) | fentrazamide + pyrazosulfuron-ethyl |
| (I-36) | fentrazamide + pyrazosulfuron-ethyl + dymron |
| (I-36) | fluazifop-P-butyl |
| (I-36) | flucarbazone-sodium |
| (I-36) | flucarbazone-sodium + fenclorim |
| (I-36) | flucarbazone-sodium + isoxadifen-ethyl |
| (I-36) | flucarbazone-sodium + mefenpyr-diethyl |
| (I-36) | flufenacet |
| (I-36) | flufenacet + 2,4-D |
| (I-36) | flufenacet + diflufenican |
| (I-36) | flufenacet + metosulam |
| (I-36) | flufenacet + propanil |
| (I-36) | flufenacet + dichlormid |
| (I-36) | flufenacet + furilazole |
| (I-36) | flufenacet + R-29148 |
| (I-36) | flufenacet + fenclorim |
| (I-36) | flufenacet + isoxadifen-ethyl |
| (I-36) | flufenacet + mefenpyr-diethyl |
| (I-36) | flumetsulam |
| (I-36) | halosulfuron-methyl |
| (I-36) | halosulfuron-methyl + cafenstrole + cyhalofop-butyl |
| (I-36) | haloxyfop-P-methyl |
| (I-36) | HOK-201 |
| (I-36) | imazamox |
| (I-36) | imazaquin |
| (I-36) | imazethapyr |
| (I-36) | imazosulfuron |
| (I-36) | imazosulfuron + dymron |
| (I-36) | imazosulfuron + anilofos |
| (I-36) | imazosulfuron + benfuresate |
| (I-36) | imazosulfuron + butachlor |
| (I-36) | imazosulfuron + cafenstrole + dymron |
| (I-36) | imazosulfuron + cyhalofop-butyl |
| (I-36) | imazosulfuron + dimepiperate |
| (I-36) | imazosulfuron + dimethametryn |
| (I-36) | imazosulfuron + dimethametryn + pretilachlor |
| (I-36) | imazosulfuron + esprocarb + dymron |
| (I-36) | imazosulfuron + etobenzanid + dymron |
| (I-36) | imazosulfuron + mefenacet + dymron |
| (I-36) | imazosulfuron + oxaziclomefone |
| (I-36) | imazosulfuron + pentoxazone + dymron |
| (I-36) | imazosulfuron + pretilachlor + dymron |
| (I-36) | imazosulfuron + pyributicarb + dymron |
| (I-36) | indanofan |
| (I-36) | isoxaflutole |
| (I-36) | MCPA |
| (I-36) | Mefenacet |
| (I-36) | mefenacet + molinate |
| (I-36) | mefenacet + quinoclamine |
| (I-36) | mefenacet + bromobutide + naproanilide |
| (I-36) | mesosulfuron |
| (I-36) | mesosulfuron + anilofos |
| (I-36) | mesosulfuron + benfuresate |
| (I-36) | mesosulfuron + cafenstrole + dymron |
| (I-36) | mesosulfuron + cyhalofop-butyl |
| (I-36) | mesosulfuron + dimepiperate |
| (I-36) | mesosulfuron + esprocarb |
| (I-36) | mesosulfuron + mefenacet |
| (I-36) | mesosulfuron + mefenacet + dymron |
| (I-36) | mesosulfuron + oxaziclomefone |
| (I-36) | mesosulfuron + pretilachlor |
| (I-36) | mesosulfuron + pyributicarb |
| (I-36) | mesotrione |
| (I-36) | metolachlor |
| (I-36) | metolachlor + benoxacor |
| (I-36) | S-metolachlor |
| (I-36) | S-metolachlor + benoxacor |
| (I-36) | metosulam |
| (I-36) | metsulfuron-methyl |
| (I-36) | metribuzin |
| (I-36) | molinate |
| (I-36) | molinate + propanil |
| (I-36) | molinate + simetryn |
| (I-36) | naproanilide |
| (I-36) | nicosulfuron |
| (I-36) | OK-701 |
| (I-36) | oxadiargyl |
| (I-36) | oxadiargyl + propanil |
| (I-36) | oxadiazon |
| (I-36) | oxaziclomefone |
| (I-36) | oxyfluorfen |
| (I-36) | pendimethalin |
| (I-36) | pentoxazone |
| (I-36) | pentoxazone + cumyluron |
| (I-36) | piperophos |
| (I-36) | piperophos + 2,4-D |
| (I-36) | pretilachlor |
| (I-36) | pretilachlor + dimethametryn |
| (I-36) | pretilachlor + dymron |
| (I-36) | pretilachlor + dimethametryn + dymron |
| (I-36) | pretilachlor + fenclorim |
| (I-36) | profoxydim |
| (I-36) | propanil |
| (I-36) | propoxycarbazone-sodium |
| (I-36) | pyraclonil |
| (I-36) | pyrazolate |
| (I-36) | pyrazolate + butachlor |
| (I-36) | pyrazolate + pretilachlor |
| (I-36) | pyrazosulfuron-ethyl |
| (I-36) | pyrazosulfuron-ethyl + dymron |
| (I-36) | pyrazosulfuron-ethyl + etobenzanid |
| (I-36) | pyrazosulfuron-ethyl + esprocarb |
| (I-36) | pyrazosulfuron-ethyl + esprocarb + dimethametryn |
| (I-36) | pyrazosulfuron-ethyl + esprocarb + pretilachlor |
| (I-36) | pyrazosulfuron-ethyl + indanofan |
| (I-36) | pyrazosulfuron-ethyl + mefenacet |
| (I-36) | pyrazosulfuron-ethyl + molinate |
| (I-36) | pyrazosulfuron-ethyl + pentoxazone |
| (I-36) | pyrazosulfuron-ethyl + anilofos + dymron |
| (I-36) | pyrazosulfuron-ethyl + benfuresate + dymron |
| (I-36) | pyrazosulfuron-ethyl + butachlor + dymron |
| (I-36) | pyrazosulfuron-ethyl + cafenstrole |
| (I-36) | pyrazosulfuron-ethyl + cafenstrole + cyhalofop-butyl |
| (I-36) | pyrazosulfuron-ethyl + dimepiperate + dymron |
| (I-36) | pyrazosulfuron-ethyl + mefenacet + dymron |
| (I-36) | pyrazosulfuron-ethyl + oxaziclomefone + dymron |
| (I-36) | pyrazosulfuron-ethyl + pretilachlor + dymron |
| (I-36) | pyrazosulfuron-ethyl + pretilachlor + quinclorac |
| (I-36) | pyrazosulfuron-ethyl + thenylchlor |
| (I-36) | pyrazoxyfen |
| (I-36) | pyribenzoxim |
| (I-36) | pyributicarb |
| (I-36) | pyributicarb + pretilachlor |
| (I-36) | pyriftalid |
| (I-36) | pyriminobac-methyl |
| (I-36) | quinclorac |
| (I-36) | quinoclamine |
| (I-36) | simazine |
| (I-36) | simetryn |
| (I-36) | sulcotrione |
| (I-36) | terbuthylazine |
| (I-36) | thenylchlor |
| (I-36) | thifensulfuron-methyl |
| (I-36) | tiocarbazil |
| (I-36) | tritosulfuron |
| (I-60) | acetochlor |
| (I-60) | acetochlor + dichlormid |
| (I-60) | acetochlor + furilazole |
| (I-60) | acetochlor + R-29148 |
| (I-60) | alachlor |
| (I-60) | amicarbazone |
| (I-60) | amidosulfuron |
| (I-60) | anilofos |
| (I-60) | anilofos + 2,4-D |
| (I-60) | anilofos + propanil |
| (I-60) | anilofos + quinoclamine |
| (I-60) | atrazine |
| (I-60) | azimsulfuron |
| (I-60) | azimsulfuron + dymron |
| (I-60) | azimsulfuron + indanofan |
| (I-60) | azimsulfuron + anilofos |
| (I-60) | azimsulfuron + benfuresate |
| (I-60) | azimsulfuron + butachlor |
| (I-60) | azimsulfuron + cafenstrole |
| (I-60) | azimsulfuron + cyhalofop-butyl |
| (I-60) | azimsulfuron + dimepiperate |
| (I-60) | azimsulfuron + esprocarb |
| (I-60) | azimsulfuron + mefenacet |
| (I-60) | azimsulfuron + oxaziclomefone |
| (I-60) | azimsulfuron + pretilachlor |
| (I-60) | azimsulfuron + thenylchlor |
| (I-60) | azimsulfuron + anilofos + dymron |
| (I-60) | azimsulfuron + benfuresate + dymron |
| (I-60) | azimsulfuron + bensulfuron + cafenstrole |
| (I-60) | azimsulfuron + bensulfuron + cyhalofop-butyl |
| (I-60) | azimsulfuron + bensulfuron + dymron |
| (I-60) | azimsulfuron + bensulfuron + dimethametryn |
| (I-60) | azimsulfuron + bensulfuron + indanofan |
| (I-60) | azimsulfuron + bensulfuron + pretilachlor |
| (I-60) | azimsulfuron + bensulfuron + thenylchlor |
| (I-60) | azimsulfuron + butachlor + dymron |
| (I-60) | azimsulfuron + cafenstrole + dymron |
| (I-60) | azimsulfuron + cyhalofop-butyl + dymron |
| (I-60) | azimsulfuron + mefenacet + dymron |
| (I-60) | azimsulfuron + oxaziclomefone + dymron |
| (I-60) | azimsulfuron + pretilachlor + dymron |
| (I-60) | benfuresate |
| (I-60) | bensulfuron-methyl |
| (I-60) | bensulfuron-methyl + dymron |
| (I-60) | bensulfuron-methyl + anilofos |
| (I-60) | bensulfuron-methyl + benfuresate |
| (I-60) | bensulfuron-methyl + butachlor |
| (I-60) | bensulfuron-methyl + cafenstrole |
| (I-60) | bensulfuron-methyl + cyhalofop-butyl |
| (I-60) | bensulfuron-methyl + dimepiperate |
| (I-60) | bensulfuron-methyl + dithiopyr |
| (I-60) | bensulfuron-methyl + esprocarb |
| (I-60) | bensulfuron-methyl + indanofan |
| (I-60) | bensulfuron-methyl + mefenacet |
| (I-60) | bensulfuron-methyl + metsulfuron-methyl |
| (I-60) | bensulfuron-methyl + molinate |
| (I-60) | bensulfuron-methyl + oxaziclomefone |
| (I-60) | bensulfuron-methyl + pretilachlor |
| (I-60) | bensulfuron-methyl + pyributicarb |
| (I-60) | bensulfuron-methyl + quinclorac |
| (I-60) | bensulfuron-methyl + thenylchlor |
| (I-60) | bensulfuron-methyl + anilofos + dymron |
| (I-60) | bensulfuron-methyl + benfuresate + dymron |
| (I-60) | bensulfuron-methyl + butachlor + dymron |
| (I-60) | bensulfuron-methyl + benfuresate + dimepiperate |
| (I-60) | bensulfuron-methyl + benfuresate + pretilachlor |
| (I-60) | bensulfuron-methyl + cafenstrole + dymron |
| (I-60) | bensulfuron-methyl + cafenstrole + cyhalofop-butyl |
| (I-60) | bensulfuron-methyl + cyhalofop-butyl + dymron |
| (I-60) | bensulfuron-methyl + cyhalofop-butyl + thenylchlor |
| (I-60) | bensulfuron-methyl + dithiopyr + quinclorac |
| (I-60) | bensulfuron-methyl + mefenacet + benthiocarb |
| (I-60) | bensulfuron-methyl + mefenacet + dymron |
| (I-60) | bensulfuron-methyl + mefenacet + molinate |
| (I-60) | bensulfuron-methyl + oxaziclomefone + dymron |
| (I-60) | bensulfuron-methyl + pretilachlor + dymron |
| (I-60) | bensulfuron-methyl + pyributicarb + dymron |
| (I-60) | bentazone |
| (I-60) | bentazone + quinclorac |
| (I-60) | benthiocarb (thiobencarb) |
| (I-60) | benthiocarb + chlornitrofen |
| (I-60) | benthiocarb + propanil |
| (I-60) | benthiocarb + simetryn |
| (I-60) | benzobicyclon |
| (I-60) | benzofenap |
| (I-60) | benzofenap + thenylchlor + cumyluron |
| (I-60) | bifenox |
| (I-60) | bifenox + pretilachlor |
| (I-60) | bifenox + thenylchlor |
| (I-60) | bispyribac-sodium |
| (I-60) | bispyribac-sodium + benthiocarb |
| (I-60) | bromobutide |
| (I-60) | bromobutide + pyrazoxyfen |
| (I-60) | bromobutide + benzofenap + pyributicarb |
| (I-60) | bromobutide + bifenox + pyrazolate |
| (I-60) | bromobutide + pyrazoxyfen + thenylchlor |
| (I-60) | butachlor |
| (I-60) | butachlor + chlomethoxyfen |
| (I-60) | butachlor + oxadiazon |
| (I-60) | butachlor + propanil |
| (I-60) | butachlor + pyrazolate |
| (I-60) | butamifos |
| (I-60) | butamifos + bromobutide |
| (I-60) | butenachlor |
| (I-60) | cafenstrole |
| (I-60) | cafenstrole + dymron |
| (I-60) | cafenstrole + cyhalofop-butyl + dymron |
| (I-60) | carfentrazone-ethyl |
| (I-60) | chlomethoxyfen |
| (I-60) | chlornitrofen |
| (I-60) | chlornitrofen + dymron |
| (I-60) | cinmethylin |
| (I-60) | cinmethylin + 2,4-D |
| (I-60) | cinosulfuron |
| (I-60) | cinosulfuron + dymron |
| (I-60) | cinosulfuron + anilofos |
| (I-60) | cinosulfuron + benfuresate |
| (I-60) | cinosulfuron + butachlor |
| (I-60) | cinosulfuron + cafenstrole + dymron |
| (I-60) | cinosulfuron + cyhalofop-butyl |
| (I-60) | cinosulfuron + dimepiperate |
| (I-60) | cinosulfuron + esprocarb |
| (I-60) | cinosulfuron + mefenacet |
| (I-60) | cinosulfuron + mefenacet + dymron |
| (I-60) | cinosulfuron + molinate |
| (I-60) | cinosulfuron + oxaziclomefone |
| (I-60) | cinosulfuron + pretilachlor |
| (I-60) | cinosulfuron + pretilachlor + dymron |
| (I-60) | cinosulfuron + pretilachlor + fenclorim |
| (I-60) | cinosulfuron + pretilachlor + quinclorac |
| (I-60) | cinosulfuron + pyriftalid |
| (I-60) | clefoxydim |
| (I-60) | clodinafop-propargyl |
| (I-60) | clodinafop-propargyl + cloquintocet-mexyl |
| (I-60) | clomazone |
| (I-60) | clomazone + propanil |
| (I-60) | clomeprop |
| (I-60) | clomeprop + pretilachlor |
| (I-60) | cumyluron |
| (I-60) | cyanazine |
| (I-60) | cyclosulfamuron |
| (I-60) | cyclosulfamuron + dymron |
| (I-60) | cyclosulfamuron + anilofos |
| (I-60) | cyclosulfamuron + benfuresate |
| (I-60) | cyclosulfamuron + butachlor |
| (I-60) | cyclosulfamuron + cafenstrole + dymron |
| (I-60) | cyclosulfamuron + cyhalofop-butyl |
| (I-60) | cyclosulfamuron + dimepiperate |
| (I-60) | cyclosulfamuron + esprocarb |
| (I-60) | cyclosulfamuron + mefenacet |
| (I-60) | cyclosulfamuron + mefenacet + dymron |
| (I-60) | cyclosulfamuron + oxaziclomefone |
| (I-60) | cyclosulfamuron + pentoxazone |
| (I-60) | cyclosulfamuron + pretilachlor |
| (I-60) | cyclosulfamuron + quinclorac |
| (I-60) | cyhalofop-butyl |
| (I-60) | cyhalofop-butyl + bentazone |
| (I-60) | 2,4-D |
| (I-60) | dichlorprop-P |
| (I-60) | diethatyl-ethyl |
| (I-60) | dimepiperate |
| (I-60) | dimethametryn |
| (I-60) | dimethametryn + piperophos |
| (I-60) | dimethenamid |
| (I-60) | S-dimethenamid |
| (I-60) | dithiopyr |
| (I-60) | dymron |
| (I-60) | esprocarb |
| (I-60) | ethoxysulfuron |
| (I-60) | ethoxysulfuron + dymron |
| (I-60) | ethoxysulfuron + anilofos |
| (I-60) | ethoxysulfuron + anilofos + dymron |
| (I-60) | ethoxysulfuron + benfuresate |
| (I-60) | ethoxysulfuron + anilofos + benfuresate |
| (I-60) | ethoxysulfuron + benfuresate + dymron |
| (I-60) | ethoxysulfuron + butachlor |
| (I-60) | ethoxysulfuron + cafenstrole |
| (I-60) | ethoxysulfuron + cafenstrole + dymron |
| (I-60) | ethoxysulfuron + cyhalofop-butyl |
| (I-60) | ethoxysulfuron + dimepiperate |
| (I-60) | ethoxysulfuron + esprocarb |
| (I-60) | ethoxysulfuron + mefenacet |
| (I-60) | ethoxysulfuron + mefenacet + dymron |
| (I-60) | ethoxysulfuron + oxaziclomefone |
| (I-60) | ethoxysulfuron + pretilachlor + dymron |
| (I-60) | ethoxysulfuron + pretilachlor + pyrazolate |
| (I-60) | etobenzanid |
| (I-60) | fenoxaprop-P-ethyl |
| (I-60) | fenoxaprop-(P)-ethyl + fenclorim |
| (I-60) | fenoxaprop-(P)-ethyl + isoxadifen-ethyl |
| (I-60) | fenoxaprop-P-ethyl + mefenpyr-diethyl |
| (I-60) | fentrazamide |
| (I-60) | fentrazamide + pentoxazone |
| (I-60) | fentrazamide + bispyribac-sodium |
| (I-60) | fentrazamide + bromobutide |
| (I-60) | fentrazamide + benzofenap |
| (I-60) | fentrazamide + clomeprop |
| (I-60) | fentrazamide + dymron |
| (I-60) | fentrazamide + flufenacet |
| (I-60) | fentrazamide + oxaziclomefone |
| (I-60) | fentrazamide + propanil |
| (I-60) | fentrazamide + pyribenzoxim |
| (I-60) | fentrazamide + pyriminobac-methyl |
| (I-60) | fentrazamide + quinoclamine |
| (I-60) | fentrazamide + azimsulfuron |
| (I-60) | fentrazamide + azimsulfuron + dymron |
| (I-60) | fentrazamide + azimsulfuron + bensulfuron-methyl |
| (I-60) | fentrazamide + bensulfuron-methyl |
| (I-60) | fentrazamide + bensulfuron-methyl + dymron |
| (I-60) | fentrazamide + cinosulfuron |
| (I-60) | fentrazamide + cinosulfuron + dymron |
| (I-60) | fentrazamide + cyclosulfamuron |
| (I-60) | fentrazamide + cyclosulfamuron + dymron |
| (I-60) | fentrazamide + ethoxysulfuron |
| (I-60) | fentrazamide + ethoxysulfuron + dymron |
| (I-60) | fentrazamide + imazosulfuron |
| (I-60) | fentrazamide + imazosulfuron + dymron |
| (I-60) | fentrazamide + pyrazosulfuron-ethyl |
| (I-60) | fentrazamide + pyrazosulfuron-ethyl + dymron |
| (I-60) | fluazifop-P-butyl |
| (I-60) | flucarbazone-sodium |
| (I-60) | flucarbazone-sodium + fenclorim |
| (I-60) | flucarbazone-sodium + isoxadifen-ethyl |
| (I-60) | flucarbazone-sodium + mefenpyr-diethyl |
| (I-60) | flufenacet |
| (I-60) | flufenacet + 2,4-D |
| (I-60) | flufenacet + diflufenican |
| (I-60) | flufenacet + metosulam |
| (I-60) | flufenacet + propanil |
| (I-60) | flufenacet + dichlormid |
| (I-60) | flufenacet + furilazole |
| (I-60) | flufenacet + R-29148 |
| (I-60) | flufenacet + fenclorim |
| (I-60) | flufenacet + isoxadifen-ethyl |
| (I-60) | flufenacet + mefenpyr-diethyl |
| (I-60) | flumetsulam |
| (I-60) | halosulfuron-methyl |
| (I-60) | halosulfuron-methyl + cafenstrole + cyhalofop-butyl |
| (I-60) | haloxyfop-P-methyl |
| (I-60) | HOK-201 |
| (I-60) | imazamox |
| (I-60) | imazaquin |
| (I-60) | imazethapyr |
| (I-60) | imazosulfuron |
| (I-60) | imazosulfuron + dymron |
| (I-60) | imazosulfuron + anilofos |
| (I-60) | imazosulfuron + benfuresate |
| (I-60) | imazosulfuron + butachlor |
| (I-60) | imazosulfuron + cafenstrole + dymron |
| (I-60) | imazosulfuron + cyhalofop-butyl |
| (I-60) | imazosulfuron + dimepiperate |
| (I-60) | imazosulfuron + dimethametryn |
| (I-60) | imazosulfuron + dimethametryn + pretilachlor |
| (I-60) | imazosulfuron + esprocarb + dymron |
| (I-60) | imazosulfuron + etobenzanid + dymron |
| (I-60) | imazosulfuron + mefenacet + dymron |
| (I-60) | imazosulfuron + oxaziclomefone |
| (I-60) | imazosulfuron + pentoxazone + dymron |
| (I-60) | imazosulfuron + pretilachlor + dymron |
| (I-60) | imazosulfuron + pyributicarb + dymron |
| (I-60) | indanofan |
| (I-60) | isoxaflutole |
| (I-60) | MCPA |
| (I-60) | mefenacet |
| (I-60) | mefenacet + molinate |
| (I-60) | mefenacet + quinoclamine |
| (I-60) | mefenacet + bromobutide + naproanilide |
| (I-60) | mesosulfuron |
| (I-60) | mesosulfuron + anilofos |
| (I-60) | mesosulfuron + benfuresate |
| (I-60) | mesosulfuron + cafenstrole + dymron |
| (I-60) | mesosulfuron + cyhalofop-butyl |
| (I-60) | mesosulfuron + dimepiperate |
| (I-60) | mesosulfuron + esprocarb |
| (I-60) | mesosulfuron + mefenacet |
| (I-60) | mesosulfuron + mefenacet + dymron |
| (I-60) | mesosulfuron + oxaziclomefone |
| (I-60) | mesosulfuron + pretilachlor |
| (I-60) | mesosulfuron + pyributicarb |
| (I-60) | mesotrione |
| (I-60) | metolachlor |
| (I-60) | metolachlor + benoxacor |
| (I-60) | S-metolachlor |
| (I-60) | S-metolachlor + benoxacor |
| (I-60) | metosulam |
| (I-60) | metsulfuron-methyl |
| (I-60) | metribuzin |
| (I-60) | molinate |
| (I-60) | molinate + propanil |
| (I-60) | molinate + simetryn |
| (I-60) | naproanilide |
| (I-60) | nicosulfuron |
| (I-60) | OK-701 |
| (I-60) | oxadiargyl |
| (I-60) | oxadiargyl + propanil |
| (I-60) | oxadiazon |
| (I-60) | oxaziclomefone |
| (I-60) | oxyfluorfen |
| (I-60) | pendimethalin |
| (I-60) | pentoxazone |
| (I-60) | pentoxazone + cumyluron |
| (I-60) | piperophos |
| (I-60) | piperophos + 2,4-D |
| (I-60) | pretilachlor |
| (I-60) | pretilachlor + dimethametryn |
| (I-60) | pretilachlor + dymron |
| (I-60) | pretilachlor + dimethametryn + dymron |
| (I-60) | pretilachlor + fenclorim |
| (I-60) | profoxydim |
| (I-60) | propanil |
| (I-60) | propoxycarbazone-sodium |
| (I-60) | pyraclonil |
| (I-60) | pyrazolate |
| (I-60) | pyrazolate + butachlor |
| (I-60) | pyrazolate + pretilachlor |
| (I-60) | pyrazosulfuron-ethyl + dymron |
| (I-60) | pyrazosulfuron-ethyl + etobenzanid |
| (I-60) | pyrazosulfuron-ethyl + esprocarb |
| (I-60) | pyrazosulfuron-ethyl + esprocarb + dimethametryn |
| (I-60) | pyrazosulfuron-ethyl + esprocarb + pretilachlor |
| (I-60) | pyrazosulfuron-ethyl + indanofan |
| (I-60) | pyrazosulfuron-ethyl + mefenacet |
| (I-60) | pyrazosulfuron-ethyl + molinate |
| (I-60) | pyrazosulfuron-ethyl + pentoxazone |
| (I-60) | pyrazosulfuron-ethyl + anilofos + dymron |
| (I-60) | pyrazosulfuron-ethyl + benfuresate + dymron |
| (I-60) | pyrazosulfuron-ethyl + butachlor + dymron |
| (I-60) | pyrazosulfuron-ethyl + cafenstrole + dymron |
| (I-60) | pyrazosulfuron-ethyl + cafenstrole + cyhalofop-butyl |
| (I-60) | pyrazosulfuron-ethyl + dimepiperate + dymron |
| (I-60) | pyrazosulfuron-ethyl + mefenacet + dymron |
| (I-60) | pyrazosulfuron-ethyl + oxaziclomefone + dymron |
| (I-60) | pyrazosulfuron-ethyl + pretilachlor + dymron |
| (I-60) | pyrazosulfuron-ethyl + pretilachlor + quinclorac |
| (I-60) | pyrazosulfuron-ethyl + thenylchlor |
| (I-60) | pyrazoxyfen |
| (I-60) | pyribenzoxim |
| (I-60) | pyributicarb |
| (I-60) | pyributicarb + pretilachlor |
| (I-60) | pyriftalid |
| (I-60) | pyriminobac-methyl |
| (I-60) | quinclorac |
| (I-60) | quinoclamine |
| (I-60) | simazine |
| (I-60) | simetryn |
| (I-60) | sulcotrione |
| (I-60) | terbuthylazine |
| (I-60) | thenylchlor |
| (I-60) | thifensulfuron-methyl |
| (I-60) | tiocarbazil |
| (I-60) | tritosulfuron |

Surprisingly, it has now been found that the above-defined active compound combinations of the substituted aryl ketones of the formula (I) and the above-mentioned active compounds of group 2 exhibit a particularly high herbicidal activity combined with very good crop plant compatibility and can be used for the selective control of monocotyledonous and dicotyledonous weeds in a variety of crops, especially in cotton, barley, potatoes, corn, rice, soybeans, sunflower, wheat and sugar cane, in particular in barley, corn, rice and wheat, very particularly in rice, and additionally also for controlling monocotyledonous and dicotyledonous weeds in the semi- and nonselective field.

Surprisingly, the herbicidal activity of the active compound combinations according to the invention, of compounds of the abovementioned groups 1 and 2 exceeds the total of the actions of the individual active compounds considerably.

Thus, not just a complementation of actions but a synergistic effect is present which could not have been predicted. The novel active compound combinations are well tolerated in a variety of crops, also effecting good control of weeds which are otherwise difficult to control. Thus, the novel active compound combinations are a valuable addition to the herbicides.

The synergistic effect of the active compound combinations according to the invention is particularly strongly pronounced in certain concentration ratios. However, the weight ratios of the active compounds in the active compound combinations may be varied within relatively wide ranges. In general, from 0.01 to 1000 parts by weight, preferably from 0.02 to 500 parts by weight and particularly preferably from 0.05 to 100 parts by weight of active compound of group 2 are used per part by weight of active compound of group 1.

The following may be particularly emphasized as mixing components from amongst the active compounds of group 3:

1-methyl-hexyl 5-chloro-quinoline-8-oxy-acetate (cloquintocet-mexyl), ethyl 4,5-dihydro-5,5-diphenyl-3-isoxazolecarboxylate (isoxadifen-ethyl) and diethyl-1-(2,4-6-chloro-phenyl)-4,5-dihydro-5-methyl-1H-pyrazole-3,5-dicarboxylate (mefenpyrdiethyl) particularly suitable to improve tolerance in cereals, and 4-dichloroacetyl-1-oxa-4-aza-spiro[4.5]-decane (AD-67), 1-dichloro-acetyl-hexahydro-3,3,8a-trimethylpyrrolo[1,2-a]-pyrimidin-6(2H)-one (BAS-145138), 4-dichloroacetyl-3,4-dihydro-3-methyl-2H-1,4-benzoxazin (benoxacor), 2,2-dichloro-N,N-di-2-propenyl-acetamide (dichlormid), 3-dichloroacetyl-5-(2-furanyl)-2,2-dimethyl-oxazolidine (furilazole, MON-13900), and 3-dichloroacetyl-2,2,5-trimethyl-oxazolidine (R-29148) particularly suitable to improve tolerance in corn.

It must be considered as surprising that, from amongst a large number of known safeners or antidotes capable of antagonizing the harmful effect of a herbicide on the crop plants, it is precisely the abovementioned compounds of group 3 which are capable of almost completely compensating the harmful effect, on the crop plants, of active compounds of the formula (I) and their salts, if appropriate also in combination with one or more of the abovementioned active compounds of group 2, without adversely affecting the herbicidal efficacy toward the weeds.

Surprisingly, it has furthermore been found that the herbicidally active substance 2,3-dichlorophenoxy-acetic acid (2,4-D) and its derivatives can also play the safener role described above.

Accordingly, another preferred embodiment is a mixture comprising a compound of the formula (I) and/or its salts and 2,4-D and/or its salts, optionally in combination with one or more of the abovementioned active compounds of group 2. Typical derivatives of 2,4-D are, for example, its esters.

Surprisingly, it has also been found that the herbicidally active substances (4-chloro-2-methylphenoxy)acetic acid (MCPA) and (+−)-2-(4-chloro-2-methylphenoxy)propanoic acid (mecoprop) can likewise act as safeners. The compounds mentioned are described in the following patent applications: JP 63 072 605 and GB 00 820 180.

The compounds diethyl 1-(2,4-dichlorophenyl)-4,5-dihydro-5-methyl-1H-pyrazole-3,5-dicarboxylate (mefenpyr-diethyl), 1-methyl-hexyl [(5-chloro-8-quinolinyl)oxy]acetate (cloquintocet-mexyl) and ethyl 1-(2,4-dichlorophenyl)-5-(trichloromethyl)-1H-1,2,4-triazole-3-carboxylate (fenchlorazole-ethyl) are described in the following patent applications: DE-A-39 39 503, EP-A-191 736 and DE-A-35 25 205, respectively. 2,4-D is a known herbicide.

The advantageous effect of the crop plant compatibility of the active compound combinations according to the invention is likewise particularly strongly pronounced at certain concentration ratios. However, the weight ratios of the active compounds in the active combinations can be varied within relatively wide ranges. In general, from 0.001 to 1000 parts by weight, preferably from 0.01 to 100 parts by weight and particularly preferably from 0.1 to 10 parts by weight of one of the crop-plant-compatibility-improving compounds (antidotes/safeners) mentioned above under (c) are used per part by weight of active compound of group 1 or its mixtures with active compounds of group 2.

All plants and plant parts can be treated in accordance with the invention. Plants are to be understood as meaning in the present context all plants and plant populations such as desired and undesired wild plants or crop plants (inclusive of naturally occurring crop plants). Crop plants can be plants which can be obtained by conventional plant breeding and optimization methods or by biotechnological and recombinant methods or by combinations of these methods, inclusive of the transgenic plants and inclusive of the plant varieties protectable or not protectable by plant breeders' rights. Plant parts are to be understood as meaning all aerial and subterranean plant parts and organs of the plants such as shoot, leaf, flower and root, examples which may be mentioned being leaves, needles, stalks, trunks, flowers, fruiting bodies, fruits, and seeds, and also roots, tubers and rhiozomes. The plant parts also include vegetative and generative propagation material, for example cuttings, tubers, rhizomes, seedlings and seeds.

As already mentioned above, it is possible to treat all plants and their parts according to the invention. In a preferred embodiment, wild plant species and plant cultivars, or those obtained by conventional biological breeding, such as crossing or protoplast fusion, and parts thereof, are treated. In a further preferred embodiment, transgenic plants and plant cultivars obtained by genetic engineering, if appropriate in combination with conventional methods (Genetically Modified Organisms), and parts thereof are treated. The term “parts” or “parts of plants” or “plant parts” has been explained above.

Particularly preferably, plants of the plant cultivars which are in each case commercially available or in use are treated according to the invention. Plant cultivars are to be understood as meaning plants having novel properties (“traits”) which can be obtained by conventional breeding, by mutagenesis or by recombinant DNA techniques. These can be varieties, bio- and genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions to be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The preferred transgenic plants or plant cultivars (i.e. those obtained by genetic engineering) which are to be treated according to the invention include all plants which, in the genetic modification, received genetic material which imparted particularly advantageous useful traits to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapevines), and particular emphasis is given to maize, soya beans, potatoes, cotton and oilseed rape. Traits that are emphasized are in particular increased defence of the plants against insects by toxins formed in the plants, in particular those formed by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (hereinbelow referred to as “Bt plants”). Traits that are also particularly emphasized are the increased defence of the plants to fungi, bacteria and viruses by systemic acquired resistance (SAR), systemin, phytoalexins, elicitors and resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for. example maize). Herbicide-resistant plants (plants bred in a conventional manner for herbicide tolerance) which may be mentioned include the varieties sold under the name Clearfield® (for example maize). Of course, these statements also apply to plant cultivars having these or still to be developed genetic traits, which plants will be developed and/or marketed in the future.

The plants listed can be treated according to the invention in a particularly-advantageous manner with the compounds of the general formula I or the active compound mixtures according to the invention. The preferred ranges stated above for the active compounds or mixtures also apply to the treatment of these plants. Particular emphasis is given to the treatment of plants with the compounds or the mixtures specifically mentioned in the present text.

The treatment according to the invention, of the plants and plant parts with the active compounds is carried out directly or by allowing the compounds to act on the surroundings, environment or storage space by the customary treatment methods, for example by immersion, spraying, evaporation, fogging, scattering, painting on and, in the case of propagation material, in particular in the case of seeds, also by applying one or more coats.

Amongst the plants obtained by biotechnological and recombinant methods, or by combining these methods, plants which are emphasized are those which tolerate so-called ALS, 4-HPPD, EPSP and/or PPO inhibitors, such as, for example, Acuron plants.

The active compounds according to the invention can be used, for example, in the following plants:

Dicotyledonous weeds of the genera: Abutilon, Amaranthus, Ambrosia, Anoda, Anthemis, Aphanes, Atriplex, Bellis, Bidens, Capsella, Carduus, Cassia, Centauea, Chenopodium, Cirsium, Convolvulus, Datura, Desmodium, Emex, Erysimum, Euphorbia, Galeopsis, Galinsoga, Galium, Hibiscus, Ipomoea, Kochia, Lamium, lepidium, Lindernia, Matricaria, Mentha, Mercurialis, Mullugo, Myosotis, Papaver, Pharbitis, Plantago, Polygonum, Portulaca, Ranunculus, Raphanus, Rorippa, Rotala, Rumex, Salsola, Senecio, Sesbania, Sida, Sinapis, Solanum, Sonchus, Sphenoclea, Stellaria, Taraxacum, Thlaspi, Trifolium, Urtica, Veronica, Viola, Xanthium.

Dicotyledonous crops of the genera: Arachis, Beta, Brassica, Cucumis, Cucurbita, Helianthus, Daucus, Glycine, Gossypium, Ipomoea, Lactuca, Linum, Lycopersicon, Nicotiana, Phaseolus, Pisum, Solanum, Vicia.

Monocotyledonous weeds of the genera: Aegilops, Agropyron, Agrostis, Alopecurus, Apera, Avena, Brachiaria, Bromus, Cenchms, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagittaria, Scirpus, Setaria, Sorghum.

Monocotyledonous crops of the genera: Allium, Ananas, Asparagus, Avena, Hordeum, Oryza, Panicum, Saccharum, Secale, Sorghum, Triticale, Triticum, Zea.

However, the use of the active compound combinations according to the invention is in no way restricted to these genera, but also extends in the same manner to other plants. The active compound combinations to be used in accordance with the invention can be employed not only in conventional cultivation methods (suitably spaced row crops), in plantation crops (for example grapevines, fruit, citrus) and in industrial plants and railtracks, on paths and squares, but also for stubble treatment and in the minimum tillage method. They are furthermore suitable as desiccants (haulm killing in, for example, potatoes) or as defoliants (for example in cotton). They are furthermore suitable for use on non-crop areas. Other fields of application are nurseries, forests, grassland and the production of ornamentals.

The active compound combinations can be converted into the customary formulations such as solutions, emulsions, wettable powders, suspensions, powders, dusts, pastes, soluble powders, granules, suspo-emulsion concentrates, natural and synthetic materials impregnated with active compound, and microencapsulations in polymeric materials.

These formulations are produced in a known manner, for example by mixing the active compounds with extenders, that is, liquid solvents and/or solid carriers, optionally with the use of surfactants, that is, emulsifiers and/or dispersants and/or foam formers.

If the extender used is water, it is also possible to employ, for example, organic solvents as cosolvents. The following are essentially suitable as liquid solvents: aromatics such as xylene, toluene, or allylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Solid carriers which are suitable are:

for example ammonium salts and ground natural minerals such as kaolins, clays, talc, chalk, quartz, attapulgite, montmoriflonite or diatomaceous earth, and-ground synthetic materials such as highly-dispersed silica, alumina and silicates; suitable solid carriers for granules are for example crushed and fractionated natural rocks such as calcite, marble, pumice, sepiolite and dolomite, or else synthetic granules of inorganic and organic meals, and granules of organic material such as sawdust, coconut shells, corn cobs and tobacco stalks; suitable emulsifiers and/or foam formers are for example nonionic and anionic emulsifiers such as polyoxyethylene fatty acid esters, polyoxyethylene fatty alcohol ethers, for example alkylaryl polyglycol ethers, alkylsulfonates, alkyl sulfates, arylsulfonates, or else protein hydrolyzates; suitable dispersants are for example ligninosulfite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic dyestuffs, such as alizarin dyestuffs, azo, dyestuffs and metal phthalocyanine dyestuffs, and trace nutrients such as salts of iron, manganese, boron, copper, cobalt, molybdenum and zinc.

The formulations generally comprise between 0.1 and 95 percent by weight of active compounds, preferably between 0.5 and 90%.

The active compound combinations according to the invention are generally applied in the form of ready mixes. However, the active compounds contained in the active compound combinations may also be applied in the form of individual formulations which are mixed upon use, that is, in the form of tank mixes.

The novel active compound combinations, as such or in their formulations, may furthermore also be used as a mixture with other known herbicides, again with ready mixes or tank mixes being possible. A mixture with other known active compounds such as fungicides, insecticides, acaricides, nematicides, bird repellents, growth substances, plant nutrients and soil conditioners is also possible. It may furthermore be advantageous for specific applications, in particular for the post-mergence method, to incorporate into the formulations plant-compatible mineral or vegetable oils (for example the commercial product “Rako Binol”) or ammonium salts such as, for example, ammonium sulphate or ammonium thiocyanate, as further additives.

The novel active compound combinations can be used as such, in the form of their formulations or the use forms which can be prepared from these formulations by further dilution, such as ready-to-use solutions, suspensions, emulsions, powders, pastes and granules. Application is effected in the customary manner, for example by pouring, spraying, atomizing, dusting or broadcasting.

The active compound combinations according to the invention can be applied before and after emergence of the plants, that is to say by the pre- and post-emergence method. They may also be incorporated into the soil prior to sowing.

The good herbicidal activity of the novel active compound combinations is demonstrated by the examples below. Whereas there are deficits in the herbicidal action of the individual active compounds, the combinations all have very good action against weeds which exceeds a simple addition of activities.

A synergistic effect in herbicides is always present when the herbicidal action of the active compound combination exceeds the action of the active compounds when applied individually.

The expected action for a given combination of two herbicides can be calculated as follows (cf. COLBY, S. R.: “Calculating synergistic and antagonistic responses of herbicide combinations”, Weeds 15, pages 2022, 1967):
if
x=% damage by herbicide A (active compound of the formula I) at an application rate of p kg/ha
and
Y=% damage by herbicide B (active compound of the formula A) at an application rate of q kg/ha
and
E=the expected damage of herbicides A and B at an application rate of p and q kg/ha,
then
   E=X+Y−(X*Y/100).

If the actual damage exceeds the calculated value, the combination has a superadditive effect, that is to say a synergistic effect.

The expected activity for a given combination of three herbicides can likewise be found in the literature cited above.

### USE EXAMPLES

### Example A/Greenhouse

Test in Transplanted Paddy Rice

| | |
|---|---|
| Solvent: | 5 parts by weight of acetone |
| Emulsifier: | 1 part by weight of benzyloxy polyglycol ether |

To produce a preparation of active compound, 1 part by weight of an active compound combination according to the invention is mixed with the stated amount of solvent and, after addition of the stated amount of emulsifier, diluted with water to the desired concentration.

Vessels for planting (500 cm²) are filled with soil from a rice field. In each case 3 rice plants (cultivar: Nipponbare, 2-3-leaf stage, height: about 15 cm) are planted into the center of the vessels for planting. Seeds of Cyperus, Echinochloa, Lindernia, Rotala and Elatine are sown into the same vessels for planting. The soil in the vessels is kept moist. After two days, each vessel for planting is flooded to a water depth of 2-3 cm.

Five days after the transplanting of the rice plants, the amount of active compound in the preparation described above is applied to the surface of the water in the vessels for planting using a pipette. The water depth in the vessels for planting is kept at 2-3 cm.

3 weeks after the application of active compound, the efficacy is rated in % damage in comparison to the untreated control.

The figures denote
0% no effect/damage (like untreated control)
100% total destruction

Active compounds, application rates and results are shown in Table A1 below.

TABLE A

| | | | | Expected |
|---|---|---|---|---|
| | | | | activity |
| | | | | E according |
| Test | Compound (I) | Compound (II) | Measured | to |
| plants | (g/ha) | (g/ha) | activity E | Colby |
| | I-82 | fentrazamide | | |
| | 75 g/ha | 135 g/ha | (75 + 135) g/ha | |
| ECHSS | 70 | 70 | 100 | 91 |
| CYPDI | 60 | 60 | 95 | 84 |
| ROTIN | 80 | 60 | 100 | 92 |
| | I-22 | fentrazamide | | |
| | 30 g/ha | 135 g/ha | (30 + 135) g/ha | |
| LIDPY | 70 | 60 | 95 | 88 |
| ROTIN | 70 | 60 | 95 | 88 |
| ELTTP | 60 | 60 | 95 | 84 |

### Example B/Greenhouse

The required amount of active compound or formulation is dissolved in a few milliliters (2-3 ml) of the solvent (acetone or DMF), an emulsifier (1 ml) is added, if required, and the mixture is diluted with water to the desired concentration.

Mixtures are prepared by mixing a predetermined dissolved amount of the first active compound with the required amount of the second active compound (and, if desired, with additional active compounds/formulations or other ingredients), and then diluting the mixture with water to the desired concentration.

In pre- and post-emergence experiments, a surfactant (Renex 36) is usually added, at a concentration of 0.1%, to the spray solution.

The amount of active compound or formulation is chosen such that the desired application rate per ha is achieved.

Post-Emergence

Test plants are grown under controlled conditions (temperature and light). Once the plants have reached a height of 5-15 cm, the test compound or the combination of test compounds is applied by spraying such that the particular amounts of active compound desired are applied per unit area. The concentration of the spray liquor is chosen such that the desired amounts of active compound are in each case applied in 500 1 of water/ha.

After the spray application, the vessels containing the plants are stored in a greenhouse under constant conditions with respect to light and temperature.

After about 3 weeks, the degree of damage to the plants is rated in % damage in comparison to the development of the untreated control.

The figures denote:
0%=no damage (like untreated control)
100%=total destruction/damage
a.i.=active ingredient
   Flufenacet Tested as 60 WG
(I-31)/(I-34) tested as active compounds
* values calculated according to Colby

Active compounds, application rates, test plants and results are shown in the tables below.

B-1

| | Appl. rate in | Abutilon theophrasti | Abutilon theophrasti |
|---|---|---|---|
| | g of ai/ha | observed | calculated* |
| Flufenacet | 125 | 0 | |
| (I-31) | 30 | 10 | |
| | 15 | 0 | |
| Flufenacet | 125 + 30 | 100 | 10 |
| (I-31) | 125 + 15 | 50 | 0 |

B-2

| | Appl. rate in | Chenopodium album | Chenopodium album |
|---|---|---|---|
| | g of ai/ha | observed | calculated* |
| Flufenacet | 125 | 0 | |
| (I-31) | 30 | 20 | |
| | 15 | 0 | |
| Flufenacet | 125 + 30 | 100 | 20 |
| (I-31) | 125 + 15 | 90 | 0 |

B-3

| | Appl. rate in | Amaranthus | Amaranthus retroflexus |
|---|---|---|---|
| | g of ai/ha | retroflexus observed | calculated* |
| Flufenacet | 125 | 60 | |
| (I-31) | 30 | 0 | |
| | 15 | 0 | |
| | 8 | 0 | |
| Flufenacet | 125 + 30 | 100 | 60 |
| (I-31) | 125 + 15 | 100 | 60 |
| | 125 + 8 | 100 | 60 |

B-4

| | Appl. rate in | Solanum nigrum | Solanum nigrum |
|---|---|---|---|
| | g of ai/ha | observed | calculated* |
| Flufenacet | 125 | 30 | |
| (I-31) | 30 | 10 | |
| Flufenacet | 125 + 30 | 100 | 37 |
| (I-31) | | | |

B-5

| | Appl. rate in | Digitaria sanguinalis | Digitaria sanguinalis |
|---|---|---|---|
| | g of ai/ha | observed | calculated* |
| Flufenacet | 125 | 70 | |
| (I-34) | 30 | 0 | |
| | 15 | 0 | |
| Flufenacet | 125 + 30 | 90 | 70 |
| (I-34) | 125 + 15 | 90 | 70 |

B-6

| | Appl. rate in | Chenopodium album | Chenopodium album |
|---|---|---|---|
| | g of ai/ha | observed | calculated* |
| Flufenacet | 125 | 0 | |
| (I-34) | 30 | 90 | |
| | 15 | 90 | |
| Flufenacet | 125 + 30 | 100 | 90 |
| (I-34) | 125 + 15 | 100 | 90 |

B-7

| | Appl. rate in | Amaranthus | Amaranthus retroflexus |
|---|---|---|---|
| | g of ai/ha | retroflexus observed | calculated* |
| Flufenacet | 125 | 60 | |
| (I-34) | 30 | 0 | |
| | 15 | 0 | |
| Flufenacet | 125 + 30 | 90 | 60 |
| (I-34) | 125 + 15 | 80 | 60 |

1-12. (canceled)

13: A composition comprising an effective amount of an active compound combination comprising
(a) at least one substituted aryl ketone of the formula (I) 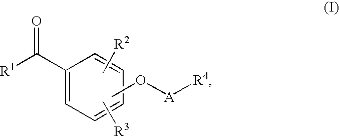
including any tautomeric forms thereof or a salt or an acid or base adduct of a compound of formula (I) including any tautomeric forms thereof,
in which
A represents alkanediyl having 1 to 6 carbon atoms,
R¹ represents one of the groups 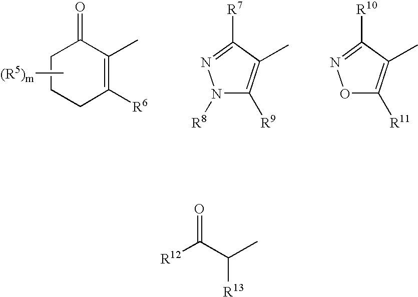
m represents the numbers 0 to 6,
R⁵ represents halogen; represents optionally cyano-, halogen-, or C₁-C₄-alkoxy-substituted alkyl, alkoxycarbonyl, or alkylthio having in each case 1 to 6 carbon atoms in the alkyl groups; represents optionally halogen-, C₁-C₄-alkyl-, or C₁-C₄-alkoxy-substituted phenyl; or when m represents 2, optionally together with a second radical R⁵ represents a carbonyl group (C═O) or alkanediyl having 2 to 6 carbon atoms,
R⁶ represents hydroxyl, formyloxy, or halogen; represents optionally cyano-, halogen-, or C₁-C₄-alkoxy-substituted alkoxy, alkylthio, alkylsulfinyl, alkylsulfonyl, alkylcarbonyloxy, alkoxycarbonyloxy, alkylaminocarbonyloxy, or alkylsulfonyloxy having in each case 1 to 6 carbon atoms in the alkyl groups; represents optionally cyano- or halogen-substituted alkenyloxy or alkynyloxy having in each case 2 to 6 carbon atoms; or represents optionally nitro-, cyano-, halogen-, C₁-C₄-alkyl-, C₁-C₄-halogenoalkyl-, C₁-C₄-alkoxy-, or C₁-C₄-halogenoalkoxy-substituted phenoxy, phenylthio, phenylsulfinyl, phenylsulfonyl, phenylcarbonyloxy, phenylcarbonylalkoxy, phenylsulfonyloxy, phenylalkoxy, phenylalkylthio, phenylalkylsulfinyl, or phenylalkylsulfonyl having optionally 1 to 4 carbon atoms in the alkyl moiety,
R⁷ represents hydrogen, cyano, carbamoyl, thiocarbamoyl, or halogen; represents optionally cyano-, halogen-, or C₁-C₄-alkoxy-substituted alkyl, alkoxy, alkylthio, alkylsulfinyl, alkylsulfonyl, or alkoxycarbonyl having in each case 1 to 6 carbon atoms in the alkyl groups; or represents optionally cyano-, halogen-, or C₁-C₄-alkyl-substituted cycloalkyl having 3 to 6 carbon atoms,
R⁸ represents hydrogen; represents optionally cyano-, halogen-, or C₁-C₄-alkoxy-substituted alkyl having 1 to 6 carbon atoms; represents optionally cyano- or halogen-substituted alkenyl or alkynyl having in each case 2 to 6 carbon atoms; represents optionally cyano-, halogen-, or C₁-C₄-alkyl-substituted cycloalkyl or cycloalkylalkyl having in each case 3 to 6 carbon atoms in the cycloalkyl group and optionally 1 to 4 carbon atoms in the alkyl moiety; or represents optionally nitro-, cyano-, halogen-, C₁-C₄-alkyl-, C₁-C₄-halogenoalkyl-, C₁-C₄-alkoxy-, or C₁-C₄-halogenoalkoxy-substituted phenyl or phenyl-C₁-C₄-alkyl,
R⁹ represents hydroxyl or formyloxy; represents optionally cyano-, halogen-, or C₁-C₄-alkoxy-substituted alkoxy, alkylcarbonyloxy, alkoxycarbonyloxy, alkylaminocarbonyloxy, or alkylsulfonyloxy having in each case 1 to 6 carbon atoms in the alkyl groups; represents optionally cyano- or halogen-substituted alkenyloxy or alkynyloxy having in each case 2 to 6 carbon atoms; represents optionally nitro-, cyano-, halogen-, C₁-C₄-alkyl-, or C₁-C₄-halogenoalkyl-substituted phenylalkoxy, phenylcarbonyloxy, phenylcarbonylalkoxy, or phenylsulfonyloxy having optionally 1 to 4 carbon atoms in the alkyl moiety,
R¹⁰ represents hydrogen, cyano, carbamoyl, thiocarbamoyl, or halogen; or represents optionally cyano-, halogen-, or C₁-C₄-alkoxy-substituted alkyl, alkylcarbonyl, alkoxy, alkoxycarbonyl, alkylthio, alkylsulfinyl, or alkylsulfonyl having in each case 1 to 6 carbon atoms in the alkyl groups,
R¹¹ represents hydrogen; represents optionally cyano-, halogen-, or C₁-C₄-alkoxy-substituted alkyl having 1 to 6 carbon atoms; or represents optionally cyano-, halogen-, or C₁-C₄-alkyl-substituted cycloalkyl having 3 to 6 carbon atoms,
R¹² represents hydrogen; represents optionally cyano-, halogen-, or C₁-C₄-alkoxy-substituted C₁-C₆-alkyl; or represents optionally cyano-, halogen-, or C₁-C₄-alkyl-substituted cycloalkyl having 3 to 8 carbon atoms, and
R¹³ represents hydrogen, cyano, carbamoyl, or halogen; or represents optionally represents optionally cyano-, halogen-, or C₁-C₄-alkoxy-substituted alkyl, alkoxy, alkoxycarbonyl, alkylthio, alkylsulfinyl, or alkylsulfonyl having in each case 1 to 6 carbon atoms in the alkyl groups,
R² represents hydrogen, nitro, cyano, carboxyl, carbamoyl, thiocarbamoyl, or halogen; or represents optionally cyano-, halogen-, or C₁-C₄-alkoxy-, C₁-C₄-alkylthio-, C₁-C₄-alkylsulfinyl-, or C₁-C₄-alkylsulfonyl-substituted alkyl, alkoxy, alkylthio, alkylsulfinyl, alkylsulfonyl, alkylamino, dialkylamino, or dialkylaminosulfonyl having in each case 1 to 6 carbon atoms in the alkyl groups,
R³ represents hydrogen, nitro, cyano, carboxyl, carbamoyl, thiocarbamoyl, or halogen; or represents optionally cyano-, halogen-, or C₁-C₄-alkoxy-, C₁-C₄-alkylthio-, C₁-C₄-alkylsulfinyl-, or C₁-C₄-alkylsulfonyl-substituted alkyl, alkoxy, alkylthio, alkylsulfinyl, alkylsulfonyl, alkylamino, dialkylamino, or dialkylaminosulfonyl having in each case 1 to 6 carbon atoms in the alkyl groups, and
R⁴ represents an optionally substituted 4- to 1 2-membered saturated or unsaturated monocyclic or bicyclic heterocyclic group that contains 1 to 4 heteroatoms, up to 4 of which heteroatoms are nitrogen atoms and alternatively or additionally optionally 1 to 3 oxygen atoms, sulfur atoms, —SO— groups, —SO₂— groups, —CO— groups, and/or —CS— groups,
and
(b) one or more compounds selected from a second group of herbicides consisting of the active compounds 4-(2-chloro-phenyl)-N-cyclohexyl-N-ethyl-4,5-dihydro-5-oxo-1H-tetrazole-1-carboxamide (fentrazamide), N-(4-fluoro-phenyl)-N-i-propyl-2-(5-trifluoromethyl-1,3,4-thiadiazol-2-yl-oxy)-acetamide (flufenacet), 2-chloro-N-(ethoxymethyl)-N-(2-ethyl-6-methyl-phenyl)-acetamide (acetochlor), 5-(2-chloro-4-trifluoromethyl-phenoxy)-2-nitro-benzoic acid sodium salt (acifluorfen-sodium), 2-chloro-6-nitro-3-phenoxy-benzeneamine (aclonifen), 2-chloro-N-(methoxymethyl)-N-(2,6-diethyl-phenyl)-acetamide (alachlor), N-ethyl-N′-i-propyl-6-methylthio-1,3,5-triazine-2,4-diamine (ametryn), 4-amino-N-(1,1-dimethyl-ethyl)-4,5-dihydro-3-(1-methyl-ethyl)-5-oxo-1H-1,2,4-triazole-1-carboxamide (amicarbazone), N-(4,6-dimethoxy-pyrimidin-2-yl)-N′-(N-methyl-N-methylsulfonyl-sulfamoyl)-urea (amidosulfuron), 1H-1,2,4-triazol-3-amine (amitrole), S-[2-[(4-chloro-phenyl)-(1-isopropyl)-amino]-2-oxo-ethyl]O,O-dimethyl phosphorodithioate (anilofos), 6-chloro-4-ethylamino-2-isopropylamino-1,3,5-triazine (atrazin), 2-[2,4-dichloro-5-(2-propynyloxy)-phenyl]-5,6,7,8-tetrahydro-1,2,4-triazolo-[4,3-a]-pyridin-3(2H)-one (azafenidin), N-(4,6-dimethoxy-pyrimidin-2-yl)-N′-[1-methyl-4-(2-methyl-2H-tetrazol-5-yl)-1H-pyrazol-5-ylsulfonyl]-urea (azimsulfuron), N-benzyl-2-(4-fluoro-3-trifluoromethyl-phenoxy)-butanamide (beflubutamid), 4-chloro-2-oxo-3(2H)-benzothiazoleacetic acid (benazolin), N-butyl-N-ethyl-2,6-dinitro-4-trifluoromethyl-benzeneamine (benfluralin), 2,3-dihydro-3,3-dimethyl-5-benzofuranyl-ethanesulfonate (benfuresate), N-(4,6-dimethoxy-pyrimidin-2-yl)-N′-(2-methoxycarbonyl-phenylmethylsulfonyl)-urea (bensulfuron-methyl), S-[(4-chloro-phenyl)-methyl]diethylthiocarbamate (benthiocarb, thiobencarb), methyl 2-[2-[4-(3,6-dihydro-3-methyl-2,6-dioxo-4-trifluoromethyl-1(2H)-pyrimidinylphenoxymethyl]-5-ethyl-phenoxy-propanoate (benzfendizone), 3-(2-chloro-4-methylsulfonyl-benzoyl)-4-phenylthio-bicyclo-[3.2.1]-oct-3-en-2-one (benzobicyclon), 2-[[4-(2,4-dichloro-3-methyl-benzoyl)-1,3-dimethyl-1H-pyrazol-5-yl]-oxy]-1-(4-methyl-phenyl)-ethanone (benzofenap), ethyl N-benzoyl-N-(3,4-dichloro-phenyl)-DL-alaninate (benzoylprop-ethyl), 3-i-propyl-1H-2, 1 ,3-benzothiadiazin-4(3H)-one (bentazon), methyl 5-(2,4-dichloro-phenoxy)-2-nitro-benzoate (bifenox), 2,6-bis-(4,6-dimethoxy-pyrimidin-2-yl-oxy)-benzoic acid sodium salt (bispyribac-sodium), 5-bromo-6-methyl-3-(1-methyl-propyl)-2,4(1 H ,3H)pyrimidinedione (bromacil), 2-bromo-3,3-dimethyl-N-(1-methyl-1-phenyl-ethyl)-butanamide (bromobutide), 3,5-dibromo-4-hydroxy-benzaldehyde O-(2,4-dinitro-phenyl)-oxime (bromofenoxim), 3,5-dibromo-4-hydroxy-benzonitrile (bromoxynil), N-butoxymethyl-2-chloro-N-(2,6-diethyl-phenyl)-acetamide (butachlor), [1,1-dimethyl-2-oxo-2-(2-propenyloxy)]-ethyl 2-chloro-5-(3,6-dihydro-3-methyl-2,6-dioxo-4-trifluoromethyl-1(2H)-pyrimidinyl)-benzoate (butafenacil-allyl), O-ethyl O-(5-methyl-2-nitro-phenyl) N-s-butylphosphoramidothioate (butamifos), (Z)-2-chloro-N-[(2-butenyloxy)-methyl]-N-(2,6-diethyl-phenyl)-acetamide (butenachlor), 2-(1-ethoximino-propyl)-3-hydroxy-5-[2,4,6-trimethyl-3-(1-oxo-butyl)-phenyl]-2-cyclohexen-1-one (butroxydim), S-ethyl-bis-(2-methyl-propyl)-thiocarbamate (butylate), N,N-diethyl-3-(2,4,6-trimethyl-phenylsulfonyl)-1H-1,2,4-triazole-1-carboxamide (cafenstrole), 2-[1-[(3-chloro-2-propenyl)-oxy-imino]-propyl]-3-hydroxy-5-(tetrahydro-2H-pyran-4-yl)-2-cyclohexen-1-one (caloxydim, tepraloxydim), 2-(4-chloro-2-fluoro-5-(2-chloro-2-ethoxycarbonyl-ethyl)-phenyl)-4-difluoromethyl-5-methyl-2,4-dihydro-3H-1,2,4-triazol-3-one (carfentrazone-ethyl), 2,4-dichloro-1-(3-methoxy-4-nitro-phenoxy)-benzene (chlomethoxyfen), 3-amino-2,5-dichloro-benzoic acid (chloramben), N-(4-chloro-6-methoxy-pyrimidin-2-yl)-N′-(2-ethoxycarbonyl-phenylsulfonyl)-urea (chlorimuron-ethyl), 1,3,5-trichloro-2-(4-nitro-phenoxy)-benzene (chlornitrofen), N-(4-methoxy-6-methyl-1,3,5-triazin-2-yl)-N′-(2-chloro-phenylsulfonyl)-urea (chlorsulfuron), N′-(3-chloro-4-methyl-phenyl)-N,N-dimethyl-urea (chlortoluron), ethyl 2-chloro-3-[2-chloro-5-(1,3,4,5,6,7-hexahydro-1,3-dioxo-2H-isoindol-2-yl)-phenyl]-2-propanoate (cinidon-ethyl), exo-1-methyl-4-isopropyl-2-(2-methyl-phenyl-methoxy)-7-oxabicyclo-[2.2.1]-heptane (cinmethylin), N-(4,6-dimethoxy-1,3,5-triazin-2-yl)-N′-(2-(2-methoxy-ethoxy)-phenylsulfonyl)-urea (cinosulfuron), 2-[1-[2-(4-chloro-phenoxy)-propoxyaminobutyl]-5-(tetrahydro-2H-thiopyran-3-yl)-1,3-cyclohexanedione (clefoxydim), (E,E)-(+)-2-[1-[[(3-chloro-2-propenyl)-oxy]-imino]-propyl]-3-hydroxy-2-cyclohexen-1-one (clethodim), (R)-(2-propynyl) 2-[4-(5-chloro-3-fluoro-pyridin-2-yl-oxy)-phenoxy-propanoate (clodinafop-propargyl), 2-[(2-chloro-phenyl)-methyl]-4,4-dimethyl-3-isoxazolidinone (clomazone), 2-(2,4-dichloro-3-methyl-phenoxy)-N-phenyl-propanamide (clomeprop), 3,6-dichloro-pyridine-2-carboxylic acid (clopyralid), methyl 3-chloro-2-[(5-ethoxy-7-fluoro-[1,2,4]triazolo[1,5-c]pyrimidin-2-yl-sulfonyl)-amino]-benzoate (cloransulam-methyl), N-[(2-chloro-phenyl)-methyl]-N′-(1-methyl-1-phenyl-ethyl)-urea (cumyluron), 2-chloro-4-ethylamino-6-(1-cyano-1-methyl-ethylamino)-1,3,5-triazine (cyanazine), N-(4,6-dimethoxy-pyrimidin-2-yl)-N′-(2-cyclopropyl-carbonyl-phenylsulfonyl)-urea (cyclosulfamuron), 2-(1-ethoximinobutyl)-3-hydroxy-5-(tetrahydro-2H-thiopyran-3-yl)-2-cyclohexen-l1-one (cycloxydim), (R)-2-butyl [4-(4-cyano-2-fluoro-phenoxy)-phenoxy]-propanoate (cyhalofop-butyl), 2,4-dichloro-phenoxyacetic acid (2,4-D), 3,6-dichloro-2-methoxy-benzoic acid (dicamba), (R)-2-(2,4-Dichloro-phenoxy)-propanoic acid (dichlorprop-P), methyl 2-[4-(2,4-dichloro-phenoxy)-phenoxy]-propanoate (diclofop-methyl), N-(2,6-dichloro-phenyl)-5-ethoxy-7-fluoro-[1,2,4]-triazolo-[1,5-c]-pyrimidine-2-sulfonamide (diclosulam), ethyl N-(chloroacetyl)-N-2,6-(diethyl-phenyl)-glycin (diethatyl-ethyl), 1,2-dimethyl-3,5-diphenyl-1H-pyrazolium methylsulfate (difenzoquat), N-(2,4-difluoro-phenyl)-2-(3-trifluoro-methyl-phenoxy)-pyridine-3-carboxamide (diflufenican), 2-[1-[(3,5-difluoro-phenyl)-amino-carbonyl-hydrazono]-ethyl]-pyridine-3-carboxylic acid (diflufenzopyr), S-(1-methyl-1-phenyl-ethyl)-1-piperidine carbothioate (dimepiperate), 2-chloro-N-(2,6-dimethyl-phenyl)-N-(2-methoxy-ethyl)-acetamide (dimethachlor), N-(1,2-dimethyl-propyl)-N′-ethyl-6-methylthio-1,3,5-triazine-2,4-diamine (dimethametryn), (S-) 2-chloro-N-(2,4-dimethyl-3-thienyl)-N-(2-methoxy-1-methyl-ethyl)-acetamide (S-) (dimethenamid), 2-amino-4-(1-fluoro-1-methyl-ethyl)-6-(1-methyl-2-(3,5-dimethyl-phenoxy)-ethylamino)-1,3,5-triazine (dimexyflam), N3,N3-diethyl-2,4-dinitro-6-trifluoromethyl-1,3-diamino-benzene (dinitramine), 6,7-dihydro-dipyrido[1,2-a:2′,1′-c]pyrazinediium (diquat), S,S-dimethyl-2-difluoromethyl-4-i-butyl-6-trifluoromethyl-pyridine-3,5-dicarbothioate (dithiopyr), N′-(3,4-dichloro-phenyl)-N,N-dimethyl-urea (diuron), N-(4-methyl-phenyl)-N′-(1-methyl-1-phenyl-ethyl)-urea (dymron, daimuron, dimuron), S-ethyl dipropylthiocarbamate (EPTC), S-(phenylmethyl)-N-ethyl-N-(1,2-dimethyl-propyl)-thiocarbamate (esprocarb), N-ethyl-N-(2-methyl-2-propenyl)-2,6-dinitro-4-trifluoromethyl-benzeneamine (ethalfluralin), (S)-(2-ethoxy-1-methyl-2-oxoethyl) 2-chloro-5-(2-chloro-4-trifluoromethyl-phenoxy)-benzoate (ethoxyfen), N-(4,6-dimethoxy-pyrimidin-2-yl)-N′-(2-ethoxy-phenoxysulfonyl)-urea (ethoxysulfuron), N-(2,3-dichloro-phenyl)-4-ethoxymethoxy-benzamide (etobenzanid), (R)-ethyl-2-[4-(6-chlorobenzoxazol-2-yl-oxy)-phenoxy]-propanoate (fenoxaprop-(P)-ethyl), isopropyl N-benzoyl-N-(3-chloro-4-fluro-phenyl)-DL-alaninate (flamprop-isopropyl), isopropyl N-benzoyl-N-(3-chloro-4-fluro-phenyl)-L-alaninate (flamprop-isopropyl-L), methyl N-benzoyl-N-(3-chloro-4-fluoro-phenoxy)-DL-alaninate (flamprop-methyl), N-(2,6-difluoro-phenyl)-8-fluoro-5-methoxy-[1,2,4]-triazolo-[1,5-c]-pyrimidine-2-sulfonamide (florasulam), butyl (R)-2-[4-(5-trifluoromethyl-pyridin-2-yl-oxy)-phenoxy]-propanoate (fluazifop, -butyl, -P-butyl), i-propyl 5-(4-bromo-1-methyl-5-trifluoromethyl-1H-pyrazol-3-yl)-2-chloro-4-fluoro-benzoate (fluazolate), 4,5-dihydro-3-methoxy-4-methyl-5-oxo-N-[(2-trifluoromethoxy-phenyl)-sulfonyl]-1-H-1,2,4-triazole-1-carboxamide sodium salt (flucarbazone-sodium), ethyl [2-chloro-4-fluoro-5-(5-methyl-6-oxo-4-trifluoromethyl-1(6H)-pyriazinyl)-phenoxy]-acetate (flufenpyr), N-(2,6-difluoro-phenyl)-5-methyl-1,2,4-triazolo[1,5-a]-pyrimidine-2-sulfonamide (flumetsulam), pentyl [2-chloro-4-fluoro-5-(1,3,4,5,6,7-hexahydro-1,3-dioxo-2H-isoindol-2-yl)-phenoxy]-acetate (flumiclorac-pentyl), 2-[7-fluoro-3,4-dihydro-3-oxo-4-(2- propynyl)-2H-1,4-benzoxazin-6-yl]-4,5,6,7-tetrahydro-1H-isoindole-1,3-dione (flumioxazin), 2-[4-chloro-2-fluoro-5-[(1-methyl-2-propynyl)-oxy]-phenyl]-4,5,6,7-tetrahydro-1H-isoindole-1,3(2H)-dione (flumipropyn), 3-chloro-4-chloromethyl-1-(3-trifluoromethyl-phenyl)-2-pyrrolidinone (fluorochloridone), ethoxycarbonylmethyl 5-(2-chloro-4-trifluoromethyl-phenoxy)-2-nitro-benzoate (fluoroglycofen-ethyl), 1-(4-chloro-3-(2,2,3,3,3-pentafluoro-propoxymethyl)-phenyl)-5-phenyl-1H-1,2,4-triazol-3-carboxamide (flupoxam), 1-isopropyl-2-chloro-5-(3,6-dihydro-3-methyl-2,6-dioxo-4-trifluoromethyl-1(2H)-pyrimidyl)-benzoate (flupropacil), N-(4,6-dimethoxy-pyrimidin-2-yl)-N′-(3-methoxycarbonyl-6-trifluoromethyl-pyridin-2-yl-sulfonyl)-urea sodium salt (flupyrsulfuron-methyl-sodium), 9-hydroxy-9H-fluorene-9-carboxylic acid (flurenol), (4-amino-3,5-dichloro-6-fluoro-pyridin-2-yl-oxy)-acetic acid (-2-butoxy-1-methyl-ethyl ester, -1-methyl-heptyl ester) (fluroxypyr, -butoxypropyl, -meptyl), 5-methylamino-2-phenyl-4-(3-trifluoromethyl-phenyl)-3(2H)-furanone (flurtamone), methyl-[(2-chloro-4-fluoro-5-(tetrahydro-3-oxo-1 H,3H-[1,3,4]-thiadiazolo-[3,4-a]-pyridazin-1-ylidene)-amino-phenyl]-thio-acetate (fluthiacet-methyl), 5-(2-chloro-4-trifluoromethyl-phenoxy)-N-methylsulfonyl-2-nitro-benzamide (fomesafen), 2-[[[[(4,6-dimethoxy-2-pyrimidinyl)-amino]-carbonyl]-amino]-sulfonyl]-4-formylamino-N,N-dimethyl-benzamide (foramsulfuron), 2-amino-4-(hydroxymethylphosphinyl)-butanoic acid (-ammonium salt) (glufosinate (-ammonium)), N-phosphonomethyl-glycine (-isopropylammonium salt), (glyphosate, -isopropylammonium), methyl 3-chloro-5-[[[[(4,6-dimethoxy-2-pyrimidinyl)-amino]-carbonyl]-amino]-sulfonyl]-1-methyl-1H-pyrazole-4-carboxylate (halosulfuron-methyl), (R)-2-[4-(3-chloro-5-trifluoromethyl-pyridin-2-yl-oxy)-phenoxy]-propanoic acid (-methyl ester, -2-ethoxy-ethyl ester, -butyl ester) (haloxyfop, -methyl, -P-methyl, -ethoxyethyl, -butyl), 3-cyclohexyl-6-dimethylamino-1-methyl-1,3,5-triazine-2,4(1H,3H)-dione (hexazinone), N-(2,4-difluoro-phenyl-1,5-dihydro-N-i-propyl-5-oxo-1-[(tetrahydro-2H-pyran-2-yl)-methyl]-4H-1,2,4-triazole-4-carboxamide (HOK-201), methyl 2-(4,5-dihydro-4-methyl-4-isopropyl-5-oxo-1H-imidazol-2-yl)-4-methyl-benzoate (imazamethabenz-methyl), 2-(4,5-dihydro-4-methyl-4-isopropyl-5-oxo-1H-imidazol-2-yl)-5-methyl-pyridine-3-carboxylic acid (imazamethapyr), 2-(4,5-dihydro-4-methyl-4-isopropyl-5-oxo-1H-imidazol-2-yl)-5-methoxymethyl-pyridine-3-carboxylic acid (imazamox), 2-(4,5-dihydro-4-methyl-4-isopropyl-5-oxo-1H-imidazol-2-yl)-quinoline-3-carboxylic acid (imazaquin), 2-(4,5-dihydro-4-methyl-4-i-propyl-5-oxo-1H-imidazol-2-yl)-5-ethyl-pyridine-3-carboxylic acid (imazethapyr), N-(4,6-dimethoxy-pyrimidin-2-yl)-N′-(2-chloro-imidazo[1,2-a]-pyridin-3-yl-sulfonyl)-urea (imazosulfuron), 2-[2-(3-chloro-phenyl)-oxiranylmethyl]-2-ethyl-1H-indene-1,3(2H)-dione (indanofan), N-(4-methoxy-6-methyl-1,3,5-triazin-2-yl)-N′-(5-iodo-2-methoxycarbonyl-phenylsulfonyl)-urea sodium salt (iodosulfuron-methyl-sodium), 4-hydroxy-3,5-diiodo-benzonitrile (ioxynil), N,N-dimethyl-N′-(4-isopropyl-phenyl)-urea (isoproturon), N-(3-(1-ethyl-1-methyl-propyl)-isoxazol-5-yl)-2,6-dimethoxy-benzamide (isoxaben), (4-chloro-2-methylsulfonyl-phenyl)-(5-cyclopropyl-isoxazol-4-yl)-methanone (isoxachlortole), (5-cyclopropyl-isoxazol-4-yl)-(2-methylsulfonyl-4-trifluoromethyl-phenyl)-methanone (isoxaflutole), 2-[2-[4-[3,5-dichloro-2-pyridinyl)-oxy]-phenoxy]-1-oxo-propyl]-isoxazolidine (isoxapyrifop), 2-[(2,3-dihydro-5,8-dimethyl-1,1-dioxidospiro[4H-1-benzothiopyran-4,2′-[1,3]-dioxolan]-6-yl)-carbonyl]-1,3-cyclohexanedione potassium salt (ketospiradox), (2-ethoxy-1-methyl-2-oxo-ethyl)-5-(2-chloro-4-trifluoromethyl-phenoxy)-2-nitro-benzoate (lactofen), N′-(3,4-dichloro-phenyl)-N-methoxy-N-methyl-urea (linuron), (4-chloro-2-methyl-phenoxy)-acetic acid (MCPA), 4-(4-chloro-Z-methyl-phenoxy)-butyric acid (MCPB), 2-(4-chloro-2-methyl-phenoxy)-propionic acid (mecoprop), 2-(2-benzothiazolyloxy)-N-methyl-N-phenyl-acetamide (mefenacet), methyl 2-[[[[(4,6-dimethoxy-2-pyrimidinyl)-amino]-carbonyl]-amino]-sulfonyl]-4-[[(methylsulfonyl)-amino]methyl]-benzoate (mesosulfuron), 2-(4-methylsulfonyl-2-nitro-benzoyl)-1,3-cyclohexanedione (mesotrione), 4-amino-3-methyl-6-phenyl-1,2,4-triazin-5(4H)-one (metamitron), 2-chloro-N-(2,6-dimethyl-phenyl)-N-(1H-pyrazol-1-yl-methyl)-acetamide (metazachlor), N′-(4-(3,4-dihydro-2-methoxy-2,4,4-trimethyl-2H-1-benzopyran-7-yl-oxy)-phenyl)-N-methoxy-N-methyl-urea (metobenzuron), N′-(4-bromo-phenyl)-N-methoxy-N-methylurea (metobromuron), (S)-2-chloro-N-(2-ethyl-6-methyl-phenyl)-N-(2-methoxy-1-methyl-ethyl)-acet-amide (metolachlor, S-metolachlor), N-(2,6-dichloro-3-methyl-phenyl)-5,7-dimethoxy-1,2,4-triazolo[1,5-a]-pyrimidine-2-sulfonamide (metosulam), N′-(3-chloro-4-methoxy-phenyl)-N,N-dimethyl-urea (metoxuron), 4-amino-6-tert-butyl-3-methylthio-1,2,4-triazin-5(4H)-one (metribuzin), N-(4-methoxy-6-methyl-1,3,5-triazin-2-yl)-N′-(2-methoxycarbonyl-phenylsulfonyl)-urea (metsulfuron-methyl), S-ethyl hexahydro-1H-azepin-1-carbothioate (molinate), 2-(2-naphthyloxy)-N-phenyl-propanamide (naproanilide), N-butyl-N′-(3,4-dichloro-phenyl)-N-methyl-urea (neburon), N-(4,6-dimethoxy-pyrimidin-2-yl)-N′-(3-dimethylcarbamoyl-pyridin-2-yl-sulfonyl)-urea (nicosulfuron), 4-chloro-5-methylamino-2-(3-trifluoromethyl-phenyl)-3(2H)pyridazinone (norflurazon), 4-(7-chloro-2,4-dimethyl-5-benzofuranyl)-2,4-dihydro-2-methyl-5-trifluoromethyl-3H-1,2,4-triazole-3-thione (OK-701), S-(2-chloro-benzyl) N,N-diethyl-thiocarbamate (orbencarb), 4-dipropylamino-3,5-dinitro-benzenesulfonamide (oryzalin), 3-[2,4-dichloro-5-(2-propynyloxy)-phenyl]-5-(t-butyl)-1,3,4-oxadiazol-2(3H)-one (oxadiargyl), 3-[2,4-dichloro-5-(1-methyl-ethoxy)-phenyl]-5-(t-butyl)-1,3,4-oxadiazol-2(3H)-one (oxadiazon), N-(4,6-dimethyl-pyrimidin-2-yl)-N′-(2-oxetan-3-yl-oxy-carbonyl-phenylsulfonyl)-urea (oxasulfuron), 3-[1-(3,5-dichloro-phenyl)-1-i-propyl]-2,3-dihydro-6-methyl-5-phenyl-4H-1,3-oxazin-4-one (oxaziclomefone), 2-chloro-1-(3-ethoxy-4-nitro-phenoxy)-4-trifluoromethyl-benzene (oxyfluorfen), 1,1′-dimethyl-4,4′-bipyridinium (paraquat), 1-amino-N-(1-ethyl-propyl)-3,4-dimethyl-2,6-dinitro-benzene (pendimethalin), 4-(t-butyl)-N-(1-ethyl-propyl)-2,6-dinitro-benzeneamine (pendralin), 2-(2,2-difluoro-ethoxy)-N-(5,8-dimethoxy-[1,2,4]-triazolo-[1,5-c]-pyrimidin-2-yl)-6-trifluoromethyl-benzene-sulfonamide (penoxsulam), 3-(4-chloro-5-cyclopentyloxy-2-fluoro-phenyl)-5-(1-methyl-ethylidene)-2,4-oxazolidine-dione (pentoxazone), 2-chloro-N-(2-ethoxy-ethyl)-N-(2-methyl-1-phenyl-1-propenyl)-acetamide (pethoxamid), 4-amino-3,5,6-trichloro-pyridine-2-carboxylic acid (picloram), N-(4-fluoro-phenyl)-6-(3-trifluoromethyl-phenoxy)-pyridine-2-carboxamide (picolinafen), S-[2-(2-methyl-1-piperidinyl)-2-oxo-ethyl]O,O-dipropyl phosphorodithioate (piperophos), 2-chloro-N-(2,6-diethyl-phenyl)-N-(2-propoxy-ethyl)-acetamide (pretilachlor), N-(4,6-bis-difluoromethoxy-pyrimidin-2-yl)-N′-(2-methoxycarbonyl-phenylsulfonyl)-urea (primisulfuron-methyl), 1-chloro-N-[2-chloro-4-fluoro-5-[(6S,7aR)-6-fluoro-tetrahydro-1,3-dioxo-1H-pyrrolo[1,2-c]imidazol-2(3H)-yl]-phenyl]-methanesulfonamide (profluazol), 2-[1-[[2-(4-chlorophenoxy)-propoxy]-imino]-butyl]-3-hydroxy-5-(tetrahydro-2H-thiopyran-3-yl)-2-cyclohexene-1-one (profoxydim), 2-chloro-N-isopropyl-N-phenyl-acetamide (propachlor), N-(3,4-dichloro-phenyl)-propanamide (propanil), (R)-[2-[[(1-methyl-ethylidene)-amino]-oxy]-ethyl]2-[4-(6-chloro-2-quinoxalinyloxy)-phenoxy]-propanoate (propaquizafop), 2-chloro-N-(2-ethyl-6-methyl-phenyl)-N-[(1-methyl-ethoxy)-methyl]-acetamide (propisochlor), methyl 2-[[[(4,5-dihydro-4-methyl-5-oxo-3-propoxy-1H-1,2,4-triazol-1-yl)-carbonyl]-amino]-sulfonyl]-benzoate sodium salt (propoxycarbazone-sodium), S-phenylmethyl-N,N-dipropyl-thiocarbamate (prosulfocarb), N-(4-methoxy-6-methyl-1,3,5-triazin-2-yl)-N′-(2-(3,3,3-trifluoro-propyl)-phenylsulfonyl)-urea (prosulfuron), ethyl [2-chloro-5-(4-chloro-5-difluoromethoxy-1-methyl-1H-pyrazol-3-yl)-4-fluoro-phenoxy]-acetate (pyraflufen-ethyl), 1-(3-chloro-4,5,6,7-tetrahydro-pyrazolo[1,5-a]pyridin-2-yl)-5-(methyl-2-propynylamino)-1H-pyrazole-4-carbonitrile (pyraclonil, pyrazogyl), 4-(2,4-dichloro-benzoyl)-1,3-dimethyl-5-(4-methyl-phenylsulfonyloxy)-pyrazole (pyrazolate), 4-(2,4-dichloro-benzoyl)-1,3-dimethyl-5-(phenylcarbonylmethoxy)-pyrazole (pyrazoxyfen), N-(4,6-dimethoxy-pyrimidin-2-yl)-N′-(4-ethoxycarbonyl-1-methyl-pyrazol-5-yl-sulfonyl)-urea (pyrazosulfuron-ethyl), diphenylmethanone O-[2,6-bis-(4,6-dimethoxy-pyrimidin-2-yl-oxy)-benzoyl]-oxime (pyribenzoxim), O-[3-(1,1-dimethyl-ethyl)-phenyl](6-methoxy-2-pyridinyl)-methylthiocarbamate (pyributicarb), 6-chloro-3-phenyl-4-pyridazinol (pyridafol), O-(6-chloro-3-phenyl-pyridazin-4-yl) S-octyl-thiocarbonate (pyridate), 6-chloro-3-phenyl-pyridazin-4-ol (pyridatol), 7-[(4,6-dimethoxy-2-pyrimidinyl)-thio]-3-methyl-1(3H)-isobenzofuranone (pyriftalid), methyl 2-(4,6-dimethoxy-pyrimidin-2-yl-oxy)-benzoate (pyriminobac-methyl), 2-chloro-6-(4,6-dimethoxy-pyrimidin-2-ylthio)-benzoic acid sodium salt (pyrithiobac-sodium), 3,7-dichloro-quinoline-8-carboxylic acid (quinchlorac), 7-chloro-3-methyl-quinoline-8-carboxylic acid (quinmerac), 2-amino-3-chloro-1,4-naphthalene-dione (quinoclamine), 2-[4-(6-chloro-2-quinoxalinyloxy)-phenoxy]-propanoic acid (-ethyl ester, -tetrahydro-2-furanyl-methyl ester) (quizalofop, -ethyl, -P-ethyl, -P-tefuryl), N-(4,6-dimethoxy-pyrimidin-2-yl)-N′-(3-ethylsulfonyl-pyridin-2-yl-sulfonyl)-urea (rimsulfuron), 2-(1-ethoximinobutyl)-5-(2-ethylthiopropyl)-3-hydroxy-2-cyclohexen-1-one (sethoxydim), 6-chloro-2,4-bis-ethylamino-1,3,5-triazine (simazin), 2-(2-chloro-4-methylsulfonyl-benzoyl)-cyclohexane-1,3-dione (sulcotrione), 2-(2,4-dichloro-5-methylsulfonylamino-phenyl)-4-difluoromethyl-5-methyl-2,4-dihydro-3H-1,2,4-triazol-3-one (sulfentrazone), methyl 2-[[[[(4,6-dimethyl-2-pyrimidinyl)-amino]-carbonyl]-amino]-sulfonyl]-benzoate (sulfo-meturon-methyl), N-phosphonomethyl-glycine-trimethylsulfonium (sulfosate), N-(4,6-dimethoxy-pyrimidin-2-yl)-N′-(2-ethylsulfonyl-imidazo[1,2-a]pyridine-3-sulfonamide (sulfosulfuron), 6-chloro-4-ethylamino-2-tert-butylamino-1,3,5-triazine (terbuthylazine), 2-tert-butylamino-4-ethylamino-6-methylthio-1,3,5-triazine (terbutryn), 2-chloro-N-(2,6-dimethyl-phenyl)-N-(3-methoxy-2-thienyl-methyl)-acetamide (thenylchlor), methyl 2-difluoromethyl-5-(4,5-dihydro-thiazol-2-yl)-4-(2-methyl-propyl)-6-trifluoromethyl-pyridine-3-carboxylate (thiazopyr), 6-(6,7-dihydro-6,6-dimethyl-3H,5H-pyrrolo[2,1-c]-1,2,4-thiadiazol-3-ylideneamino)-7-fluoro-4-(2-propynyl)-2H-1 ,4-benzoxazin-3(4H)-one (thidiazimin), N-(4-methoxy-6-methyl-1,3,5-triazin-2-yl)-N′-(2-methoxy-carbonyl-thien-3-yl-sulfonyl)-urea (thifensulfuron-methyl), S-(phenylmethyl)-bis-(1-methyl-propyl)-carbamothioate (tiocarbazil), 2-(ethoximino-propyl)-3-hydroxy-5-(2,4,6-trimethyl-phenyl)-2-cyclohexen-1-one (tralkoxydim), S-(2,3,3-trichloro-2-propenyl) diisopropylcarbamothioate (triallate), N-(4-methoxy-6-methyl-1,3,5-triazin-2-yl)-N′-[2-(2-chloro-ethoxy)-phenylsulfonyl]-urea (triasulfuron), N-methyl-N-(4-methoxy-6-methyl-1,3,5-triazin-2-yl)-N′-(2-methoxycarbonyl-phenylsulfonyl)-urea (tribenuron-methyl), (3,5,6-trichloro)-pyridin-2-yl-oxy-acetic acid (triclopyr), 2-(3,5-dichloro-phenyl)-2-(2,2,2-trichloro-ethyl)-oxirane (tridiphane), N-[[(4,6-dimethoxy-2-pyrimidinyl)-amino]-carbonyl]-3-(2,2,2-trifluoro-ethoxy)-2-pyridinesulfonamide sodium salt (trifloxysulfuron), 1-amino-2,6-dinitro-N,N-dipropyl-4-trifluoromethyl-benzene (trifluralin), N-[4-dimethylamino-6-(2,2,2-trifluoro-ethoxy)-1,3,5-triazin-2-yl]-N′-(2-methoxycarbonyl-phenylsulfonyl)-urea (triflusulfuron-methyl), N-(4-methoxy-6-trifluoromethoxy-1,3,5-triazin-2-yl)-N′-(2-trifluoromethyl-phenyl-sulfonyl)-urea (tritosulfuron), N-[[(4,6-dimethoxy-2-pyrimidinyl)-amino]-carbonyl]-3-(N-methyl-N-methylsulfonyl-amino)-2-pyridinesulfonamide, 4-(4,5-dihydro-4-methyl-5-oxo-3-trifluoromethyl-1H-1,2,4-triazol-1-yl)-2-(ethylsulfonylamino)-5-fluoro-benzenecarbothioamide (HWH4991), 2-chloro-N-[1-(2,6-dichloro-4-difluoromethyl-phenyl)-4-nitro-1H-pyrazol-5-yl]-propanecarboxamide (SLA5599), [2-chloro-3-(4,5-dihydro-3-isoxazolyl)-4-methylsulfonyl-phenyl]-(5-hydrox-1-methyl-1H-pyrazol-4-yl)-methanone, [3-(4,5-dihydro-3-isoxazolyl)-2-methyl-4-methylsulfonyl-phenyl]-(5-hydrox-1-methyl-1H-pyrazol-4-yl)-methanone, [3-[2-chloro-3-[(2,6-dioxo-cyclohexyl)-carbonyl]-6-ethylsulfonyl-phenyl]-5-isoxazolyl]-acetonitrile, 2-[2-chloro-4-methylsulfonyl-3-[(2,2,2-trifluoro-ethoxy)-methyl]-benzoyl]-1,3-cyclohexanedione, and 2-[[5,8-dimethyl-1,1-dioxido-4-(2-pyrimidinyloxy)-3,4-dihydro-2H-thiochromen-6-yl]-carbonyl]-1,3-cyclohexanedione
and/or
(c) one or more compounds selected from a third group of compounds that improve crop plant compatibility consisting of the active compounds 4-dichloroacetyl-1-oxa-4-aza-spiro[4.5]-decane (AD-67), 1-dichloroacetyl-hexahydro-3,3,8a-trimethylpyrrolo[1,2-a]-pyrimidin-6(2H)-one (BAS-145138), 4-dichloroacetyl-3,4-dihydro-3-methyl-2H-1,4-benzoxazine (benoxacor), 1-methyl-hexyl 5-chloro-quinoxalin-8-oxy-acetate (cloquintocet-mexyl, α-(cyanomethoximino)-phenylacetonitrile (cyometrinil), 2,4-dichlorophenoxy acetic acid (2,4-D), 2,2-dichloro-N-(2-oxo-2-(2-propenylamino)-ethyl)-N-(2-propenyl)-acetamide (DKA-24), 2,2-dichloro-N,N-di-2-propenyl acetamide (dichlormid), N-(4-methyl-phenyl)-N′-(1-methyl-1-phenyl-ethyl)-urea (dymron), 4,6-dichloro-2-phenyl-pyrimidine (fenclorim), ethyl 1-(2,4-dichloro-phenyl)-5-trichloro-methyl-1H-1,2,4-triazole-3-carboxylate (fenchlorazol-ethyl), phenylmethyl 2-chloro-4-trifluoromethyl-thiazole-5-carboxylate (flurazole), 4-chloro-N-(1,3-dioxolan-2-yl-methoxy)-α-trifluoro-acetophenone oxime (fluxofenim), 3-dichloroacetyl-5-(2-furanyl)-2,2-dimethyl-oxazolidine (furilazole, MON-13900), ethyl-4,5-dihydro-5,5-diphenyl-3-isoxazolecarboxylate (isoxadifen-ethyl), (4-chloro-2-methyl-phenoxy)-acetic acid (MCPA), (+−)-2-(4-chloro-methylphenoxy)-propionic acid (mecoprop), diethyl 1-(2,4-dichloro-phenyl)-4,5-dihydro-5-methyl-1H-pyrazole-3,5-dicarboxylate (mefenpyr-diethyl), 2-dichloromethyl-2-methyl-1,3-dioxolan (MG-191), 1,8-naphthalic anhydride, α-(1,3-dioxolan-2-yl-methoximino)-phenylacetonitrile (oxabetrinil), 2,2-dichloro-N-(1,3-dioxolan-2-yl-methyl)-N-(2-propenyl)-acetamide (PPG-1292), 3-dichloroacetyl-2,2,5-trimethyl oxazolidine (R-29148), N-cyclopropyl-4-[[(2-methoxy-5-methyl-benzoyl)-amino]-sulfonyl]-benzamide, N-[[(4-methoxyacetylamino)-phenyl]-sulfonyl-2-methoxy-benzamide and N-[[(4-methylaminocarbonylamino)-phenyl]-sulfonyl-2-methoxy-benzamide, 4-(2-chlorobenzoylaminosulfonyl)-N-propylbenzamide, N-(phenylsulfamoyl) benzamide derivatives of the formula (V) 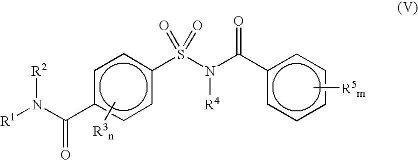
in which
R¹ represents hydrogen, (C₁-C₆)-alkyl, (C₃-C₆)-cycloalkyl, (C₂-C₆)-alkenyl, (C₅-C₆)-cycloalkenyl, phenyl, or 3- to 6-membered heterocyclyl having up to three heteroatoms selected from the group consisting of nitrogen, oxygen, and sulfur, where the radicals R¹ other than hydrogen are optionally substituted by one or more identical or different substituents selected from the group consisting of halogen, (C₁-C₆)-alkoxy, (C₁-C₆)-haloalkoxy, (C₁-C₂)-alkylsulfinyl, (C₁-C₂)-alkylsulfonyl, (C₃-C₆)-cycloalkyl, (C₁-C₄)-alkoxycarbonyl, (C₁-C₄)-alkylcarbonyl, and phenyl and the cyclic radicals are optionally also substituted by (C₁-C₄)-alkyl or (C₁-C₄)-haloalkyl;
R² represents hydrogen, (C₁-C₆)-alkyl, (C₂-C₆)-alkenyl, or (C₂-C₆)-alkynyl, where the radicals R² other than hydrogen are optionally substituted by one or more identical or different substituents selected from the group consisting of halogen, hydroxyl, (C₁-C₄)-alkyl, (C₁-C₄)-alkoxy, and (C₁-C₄)-alkylthio;
R³ represents halogen, (C₁-C₄)-haloalkyl, (C₁-C₄)-haloalkoxy, nitro, (C₁-C₄)-alkyl, (C₁-C₄)-alkoxy, (C₁-C₄)-alkylsulfonyl, (C₁-C₄)-alkoxycarbonyl, or (C₁-C₄)-alkylcarbonyl;
R⁴ represents hydrogen or methyl;
R⁵ represents halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl, or (C₁-C₄)-alkylcarbonyl;
n represents 0, 1, or 2 and
m represents 1 or 2,
or salts thereof, and
2-methoxy-N-[4-(2-methoxybenzoylsulfamoyl)phenyl]acetamide N-acylsulfonamide derivatives of the formula (VI) 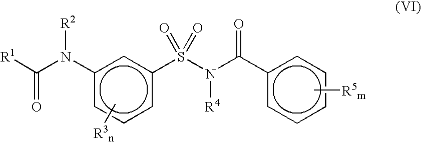
in which
R¹ represents hydrogen, (C₁-C₆)-alkyl, (C₃-C₆)-cycloalkyl, furanyl, or thienyl, where each of the radicals R¹ other than hydrogen is unsubstituted or substituted by one or more substituents selected from the group consisting of halogen, (C₁-C₄)-alkyloxy, halogeno-(C₁-C₆)-alkoxy, and (C₁-C₄)-alkylthio and the cyclic radicals are optionally also substituted by (C₁-C₄)-alkyl or (C₁-C₄)-halogenoalkyl
R² represents hydrogen or methyl;
R³ represents halogen, halogeno-(C₁-C₄)-alkyl, halogeno-(C₁-C₄)-alkoxy, (C₁-C₄)-alkyl, (C₁-C₄)-alkoxy, (C₁-C₄)-alkylsulfonyl, (C₁-C₄)-alkoxycarbonyl, or (C₁-C₄)-alkylcarbonyl,
R⁴ represents hydrogen or methyl,
R³ represents halogen, (C₁-C₄)-alkyl, halogeno-(C₁-C₄)-alkyl, halogeno-(C₁-C₄)-alkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl, or (C₁-C₄)-alkylcarbonyl,
n represents 0, 1, or 2, and
m represents 1 or 2,
or alkali metal salts thereof.

14: A composition according to claim 13 wherein, for the aryl ketone of the formula (I),
m represents the numbers 0, 1, 2, 3, or 4,
A represents alkanediyl having 1 to 3 carbon atoms,
R¹ represents one of the groups 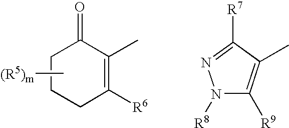
R² represents hydrogen, nitro, cyano, carboxyl, carbamoyl, thiocarbamoyl, fluorine, chlorine, bromine, or iodine; or represents optionally cyano-, fluorine-, chlorine-, bromine-, C₁-C₃-alkoxy-, C₁-C₃-alkylthio-, C₁-C₃-alkylsulfinyl-, or C₁-C₃-alkylsulfonyl-substituted alkyl, alkoxy, alkylthio, alkylsulfinyl, alkylsulfonyl, alkylamino, dialkylamino, or dialkylaminosulfonyl having in each case 1 to 5 carbon atoms in the alkyl groups,
R³ represents hydrogen, nitro, cyano, carboxyl, carbamoyl, thiocarbamoyl, fluorine, chlorine, bromine, or iodine; or represents optionally cyano-, fluorine-, chlorine-, bromine-, C₁-C₃-alkoxy-, C,-C₃-alkylthio-, C₁-C₃-alkylsulfinyl-, or C₁-C₃-alkylsulfonyl-substituted alkyl, alkoxy, alkylthio, alkylsulfinyl, alkylsulfonyl, alkylamino, dialkylamino, or dialkylaminosulfonyl having in each case 1 to 5 carbon atoms in the alkyl groups,
R⁴ represents one of the heterocyclic groups 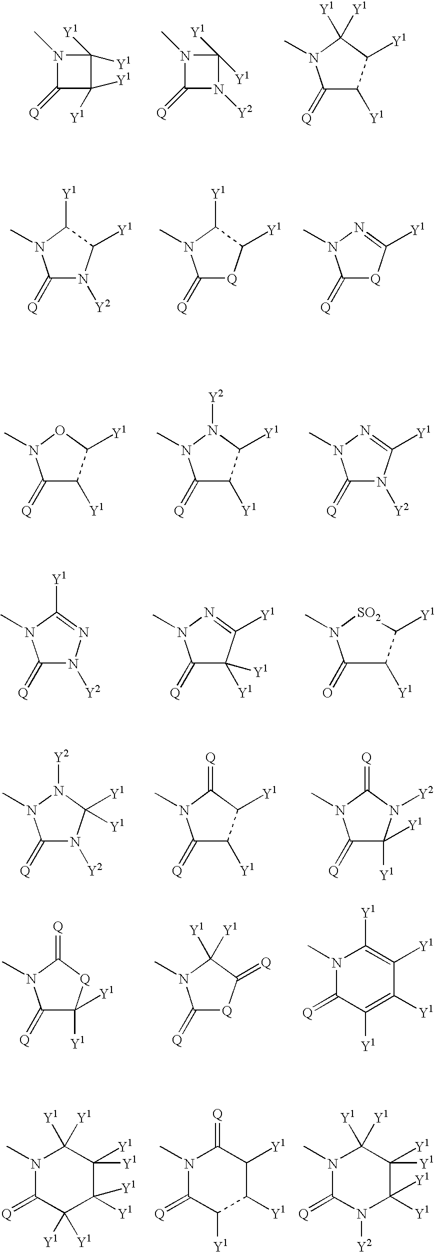 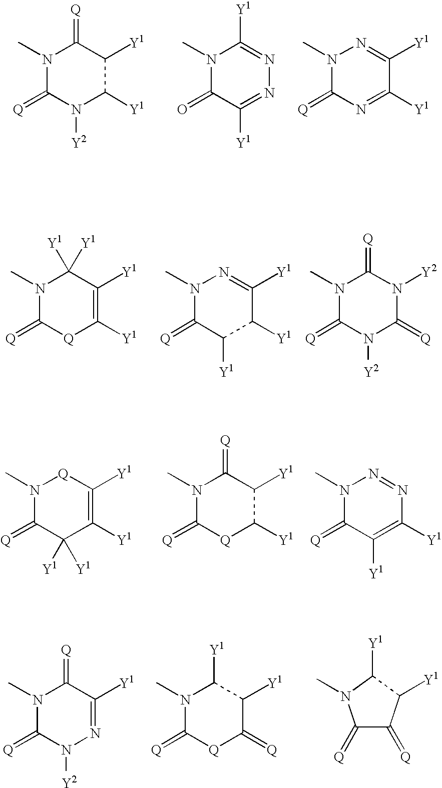 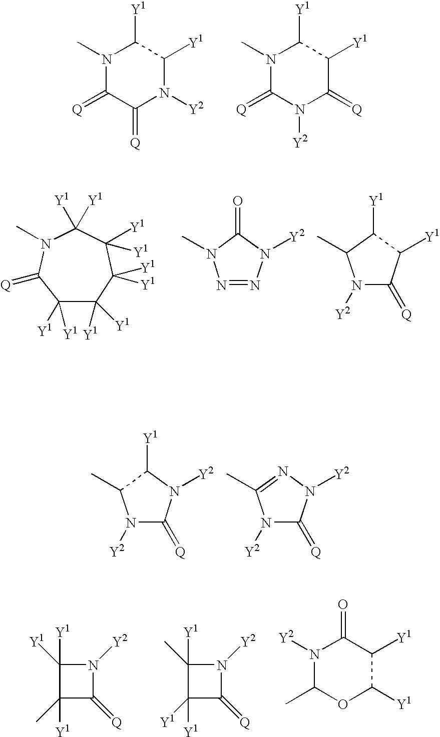
where
the broken bond in each group represents a single bond or a double bond,
Q represents oxygen or sulfur,
Y¹ represents hydrogen, hydroxyl, mercapto, cyano, fluorine, chlorine, bromine, or iodine; represents optionally cyano-, fluorine-, chlorine-, bromine-, C₁-C₃-alkoxy-, C₁-C₃-alkylthio-, C₁-C₃-alkylsulfinyl-, and/or C₁-C₃-alkylsulfonyl-substituted alkyl, alkylcarbonyl, alkoxy, alkoxycarbonyl, alkylthio, alkylsulfinyl, or alkylsulfonyl having in each case up to 5 carbon atoms in the alkyl groups; represents optionally fluorine- or chlorine-substituted alkylamino or dialkylamino having in each case up to 5 carbon atoms in the alkyl groups; represents optionally fluorine-, chlorine-, and/or bromine-substituted alkenyl, alkynyl, alkenyloxy, alkenylthio, or alkenylamino having in each case up to 5 carbon atoms in the alkenyl or alkynyl groups; represents optionally fluorine-, chlorine-, and/or bromine-substituted cycloalkyl, cycloalkyloxy, cycloalkylthio, cycloalkylamino, cycloalkylalkyl, cycloalkylalkoxy, cycloalkyl-alkylthio, or cycloalkylalkylamino having in each case 3 to 6 carbon atoms in the cycloalkyl groups and optionally up to 3 carbon atoms in the alkyl moiety; represents optionally fluorine-, chlorine-, bromine-, iodine-, C₁-C₄-alkyl-, or C₁-C₄-alkoxy-substituted phenyl, phenyloxy, phenylthio, phenylamino, benzyl, benzyloxy, benzylthio, or benzylamino; represents pyrrolidino, piperidino, or morpholino; or when two adjacent Y¹ radicals are located at a double bond, the adjacent radicals Y¹ together optionally also represent a benzo group, and
Y² represents hydrogen, hydroxyl, amino, or alkylideneamino having up to 4 carbon atoms; represents optionally fluorine-, chlorine-, bromine-, or C₁-C₃-alkoxy-substituted alkyl, alkoxy, alkylamino, dialkylamino, or alkanoylamino having in each case up to 5 carbon atoms in the alkyl groups; represents optionally fluorine-, chlorine-, and/or bromine-substituted alkenyl, alkynyl, or alkenyloxy having in each case up to 5 carbon atoms in the alkenyl or alkynyl groups; represents optionally fluorine-, chlorine-, and/or bromine-substituted cycloalkyl, cycloalkylalkyl, or cycloalkylamino having in each case 3 to 6 carbon atoms in the cycloalkyl groups and optionally up to 3 carbon atoms in the alkyl moiety; represents optionally fluorine-, chlorine-, bromine-, iodine-,.
C₁-C₄-alkyl-, and/or C₁-C₄-alkoxy-substituted phenyl or benzyl; or together with an adjacent radical Y¹ or Y² optionally represents halogen- or C₁-C₄-alkyl-substituted alkanediyl having 3 to 5 carbon atoms,
with the proviso that when more than one of the radicals Y¹ and Y² are attached to the same heterocyclic group, the radicals Y¹ and Y² can have identical or different meanings within the scope of the above definitions,
R⁵ represents fluorine, chlorine, or bromine; represents optionally cyano-, fluorine-, chlorine-, or C₁-C₃-alkoxy-substituted alkyl, alkoxycarbonyl, or alkylthio having in each case 1 to 5 carbon atoms in the alkyl groups; represents optionally fluorine-, chlorine-, bromine-, C₁-C₄-alkyl-, or C₁-C₄-alkoxy-substituted phenyl; or when m represents 2, optionally together with a second radical R⁵ represents alkanediyl having 2 to 6 carbon atoms,
R⁶ represents hydroxyl or formyloxy; represents optionally cyano-, fluorine-, chlorine-, or C₁-C₃-alkoxy-substituted alkoxy, alkylthio, alkylsulfinyl, alkylsulfonyl, alkylcarbonyloxy, alkoxycarbonyloxy, alkylaminocarbonyloxy, or alkylsulfonyloxy having in each case 1 to 5 carbon atoms in the alkyl groups;
R⁶ represents optionally cyano-, fluorine-, chlorine-, and/or bromine-substituted alkenyloxy or alkynyloxy having in each case 3 to 5 carbon atoms; represents optionally nitro-, cyano-, fluorine-, chlorine-, bromine-, or (fluorine- and/or chlorine-substituted) C₁-C₄-alkyl- or C₁-C₄-alkoxy-substituted phenoxy, phenylthio, phenylsulfinyl, phenylsulfonyl, phenylcarbonyloxy, phenylcarbonylalkoxy, phenylsulfonyloxy, phenylalkoxy, phenylalkylthio, phenylalkylsulfinyl, or phenylalkylsulfonyl having optionally 1 to 4 carbon atoms in the alkyl moiety,
R⁷ represents hydrogen, cyano, carbamoyl, thiocarbamoyl, fluorine, chlorine, or bromine; represents optionally cyano-, fluorine-, chlorine-, bromine-, or C₁-C₃-alkoxy-substituted alkyl, alkoxy, alkylthio, alkylsulfinyl, alkylsulfonyl, or alkoxycarbonyl having in each case 1 to 5 carbon atoms in the alkyl groups; or represents optionally cyano-, fluorine-, chlorine, bromine-, or C₁-C₃-alkyl-substituted cycloalkyl having 3 to 6 carbon atoms,
R⁸ represents hydrogen; represents optionally cyano-, fluorine-, chlorine-, or C₁-C₃-alkoxy-substituted alkyl having 1 to 5 carbon atoms; represents optionally cyano-, fluorine-, chlorine-, and/or bromine-substituted alkenyl or alkynyl having in each case 3 to 5 carbon atoms; represents optionally cyano-, fluorine-, chlorine-, bromine-, or C₁-C₃-alkyl-substituted cycloalkyl or cycloalkylalkyl having in each case 3 to 6 carbon atoms in the cycloalkyl group and optionally 1 to 3 carbon atoms in the alkyl moiety; or represents optionally nitro-, cyano-, fluorine-, chlorine-, bromine-, iodine-, or (optionally fluorine- and/or chlorine-substituted) C₁-C₄-alkyl- or C₁-C₄-alkoxy-substituted phenyl or phenyl-C₁-C₄-alkyl,
R⁹ represents hydroxyl or formyloxy; represents optionally cyano-, fluorine-, chlorine-, or C₁-C₃-alkoxy-substituted alkoxy, alkylcarbonyloxy, alkoxycarbonyloxy, alkylaminocarbonyloxy, or alkylsulfonyloxy having in each case 1 to 5 carbon atoms in the alkyl groups; represents optionally cyano-, fluorine-, chlorine-, and/or bromine-substituted alkenyloxy or alkynyloxy having in each case 3 to 5 carbon atoms; or represents optionally nitro-, cyano-, fluorine-, chlorine-, bromine-, iodine-, or (optionally fluorine- and/or chlorine-substituted) C₁-C₄-alkyl- or C₁-C₄-alkoxy-substituted phenylalkoxy, phenylcarbonyloxy, phenylcarbonylalkoxy, or phenylsulfonyloxy having optionally 1 to 3 carbon atoms in the alkyl moiety,
R¹⁰ represents hydrogen, cyano, carbamoyl, thiocarbamoyl, fluorine, chlorine, or bromine; or represents optionally cyano-, fluorine-, chlorine-, or C₁-C₃-alkoxy-substituted alkyl, alkylcarbonyl, alkoxy, alkoxycarbonyl, alkylthio, alkylsulfinyl, or alkylsulfonyl having in each case 1 to 5 carbon atoms in the alkyl groups,
R¹¹ represents hydrogen; represents optionally cyano-, fluorine-, chlorine-, or C₁-C₃-alkoxy-substituted alkyl having 1 to 5 carbon atoms; or represents optionally cyano-, fluorine-, chlorine-, bromine-, or C₁-C₃-alkyl-substituted cycloalkyl having 3 to 6 carbon atoms,
R¹² represents hydrogen; represents optionally cyano-, fluorine-, chlorine-, or C₁-C₃-alkoxy-substituted alkyl having 1 to 5 carbon atoms; or represents optionally cyano-, fluorine-, chlorine-, bromine-, or C₁-C₃-alkyl-substituted cycloalkyl having 3 to 6 carbon atoms,
R¹³ represents hydrogen, cyano, carbamoyl, fluorine, chlorine, or bromine; or represents optionally cyano-, fluorine-, chlorine-, or C₁-C₃-alkoxy-substituted alkyl, alkoxy, alkoxycarbonyl, alkylthio, alkylsulfinyl, or alkylsulfonyl having in each case 1 to 5 carbon atoms in the alkyl groups.

15: A composition according to claim 14 wherein R⁴ represents a heterocyclic group having 1 to 3 substituents Y¹ and/or Y².

16: A composition according to claim 13 wherein, for the aryl ketone of the formula (I),
m represents the numbers 0, 1, 2, or 3,
A represents methylene, ethane-1,2-diyl (dimethylene), ethane-1,1-diyl, propane-1,2-diyl, or propane-1,3-diyl (trimethylene),
R² represents hydrogen, nitro, cyano, carboxyl, carbamoyl, thiocarbamoyl, fluorine, chlorine, bromine, or iodine; or represents optionally fluorine-, chlorine-, methoxy-, ethoxy-, n- or i-propoxy-, methylthio-, ethylthio-, n- or i-propylthio-, methylsulfinyl-, ethylsulfinyl-, methylsulfonyl-, or ethylsulfonyl-substituted methyl, ethyl, n- or i-propyl, or n-, i-, s-, or t-butyl; represents optionally fluorine- and/or chlorine-, methoxy-, ethoxy-, or n- or i-propoxy-substituted methoxy, ethoxy, or n- or i-propoxy; represents optionally fluorine- and/or chlorine-substituted methylthio, ethylthio, n- or i-propylthio, methylsulfinyl, ethylsulfinyl, n- or i-propylsulfinyl, methylsulfonyl, ethylsulfonyl, or n- or i-propylsulfonyl; or represents methylamino, ethylamino, n- or i-propylamino, dimethylamino, diethylamino, dimethylaminosulfonyl, or diethylaminosulfonyl,
R³ represents hydrogen, nitro, cyano, carboxyl, carbamoyl, thiocarbamoyl, fluorine, chlorine, or bromine; represents optionally fluorine-, chlorine-, methoxy-, ethoxy-, n- or i-propoxy-, methylthio-, ethylthio-, n- or i-propylthio-, methylsulfinyl-, ethylsulfinyl-, methylsulfonyl-, or ethylsulfonyl-substituted methyl, ethyl, n- or i-propyl, or n-, i-, s-, or t-butyl; represents optionally fluorine- and/or chlorine-, methoxy-, ethoxy-, or n- or i-propoxy-substituted methoxy, ethoxy, or n- or i-propoxy; represents optionally fluorine- and/or chlorine-substituted methylthio, ethylthio, n- or i-propylthio, methylsulfinyl, ethylsulfinyl, n- or i-propylsulfinyl, methylsulfonyl, ethylsulfonyl, or n- or i-propylsulfonyl; or represents methylamino, ethylamino, n- or i-propylamino, dimethylamino, diethylamino, dimethylaminosulfonyl, or diethylaminosulfonyl,
R⁴ represents one of the heterocyclic groups 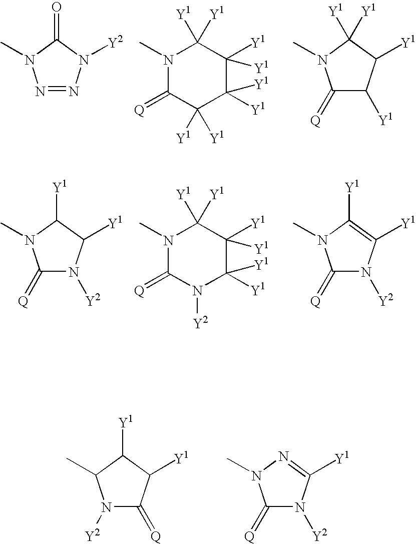
where
Q represents oxygen,
Y¹ represents hydrogen, hydroxyl, mercapto, cyano, fluorine, chlorine, bromine, or iodine; represents optionally fluorine-, chlorine- methoxy-, ethoxy-, n- or i-propoxy-, methylthio-, ethylthio-, n- or i-propylthio-, methylsulfinyl-, ethylsulfinyl-, methylsulfonyl-, or ethylsulfonyl-substituted methyl, ethyl, n- or i-propyl, n-, i-, s-, or t-butyl, methoxy, ethoxy, n- or i-propoxy, n-, i-, s-, or t-butoxy, methylthio, ethylthio, n- or i-propylthio, n-, i-, s-, or t-butylthio, methylsulfinyl, ethylsulfinyl, n- or i-propylsulfinyl, methylsulfonyl, ethylsulfonyl, or n- or i-propylsulfonyl; represents methylamino, ethylamino, n- or i-propylamino, n-, i-, s-, or t-butylamino, dimethylamino, diethylamino, di-n-propylamino, or di-i-propylamino; represents optionally fluorine- and/or chlorine-substituted ethenyl, propenyl, butenyl, ethynyl, propynyl, butynyl, propenyloxy, butenyloxy, propenylthio, butenylthio, propenylamino, or butenylamino; represents optionally fluorine- and/or chlorine-substituted cyclopropyl, cyclobutyl, cyclopentyl, cyclohexyl, cyclopropyloxy, cyclobutyloxy, cyclopentyloxy, cyclohexyloxy, cyclopropylthio, cyclobutylthio, cyclopentylthio, cyclohexylthio, cyclopropylamino, cyclobutylamino, cyclopentylamino, cyclohexylamino, cyclopropylmethyl, cyclobutylmethyl, cyclopentylmethyl, cyclohexylmethyl, cyclopropylmethoxy, cyclobutylmethoxy, cyclopentylmethoxy, cyclohexylmethoxy, cyclopropylmethylthio, cyclobutylmethylthio, cyclopentylmethylthio, cyclohexylmethylthio, cyclopropylmethylamino, cyclobutylmethylamino, cyclopentylmethylamino, or cyclohexylmethylamino,; represents optionally fluorine-, chlorine-, methyl-, ethyl-, n- or i-propyl-, n-, i-, s-, or t-butyl-, methoxy-, ethoxy-, or n- or i-propoxy-substituted phenyl, phenyloxy, phenylthio, phenylamino, benzyl, benzyloxy, benzylthio, or benzylamino; represents pyrrolidino, piperidino, or morpholino; or when two adjacent Y¹ radicals are located at a double bond, the adjacent Y¹ radicals together optionally also represent a benzo group, and
Y² represents hydrogen, hydroxyl, or amino; represents optionally fluorine- and/or chlorine-, methoxy-, or ethoxy-substituted methyl, ethyl, n- or i-propyl, n-, i-, or s-butyl, methoxy, ethoxy, n- or i-propoxy, methylamino, ethylamino, or dimethylamino; represents optionally fluorine- and/or chlorine-substituted ethenyl, propenyl, ethynyl, propynyl, or propenyloxy; represents optionally fluorine- and/or chlorine-substituted cyclopropyl, cyclobutyl, cyclopentyl, cyclohexyl, cyclopropylmethyl, cyclobutylmethyl, cyclopentylmethyl, or cyclohexylmethyl; represents optionally fluorine-, chlorine-, methyl-, ethyl-, n- or i-propyl-, n-, i-, s-, or t-butyl-, methoxy-, ethoxy-, or n- or i-propoxy-substituted phenyl or benzyl; or together with an adjacent radical Y¹ or Y² optionally represents methyl- and/or ethyl-substituted propane-1,3-diyl (trimethylene) or butane-1,4-diyl (tetramethylene),
R⁵ represents fluorine, chlorine, or bromine, represents optionally cyano-, fluorine-, chlorine-, methoxy-, or ethoxy-substituted methyl, ethyl, n- or i-propyl, n-, i-, s-, or t-butyl, methoxycarbonyl, ethoxycarbonyl, n- or i-propoxycarbonyl, methylthio, ethylthio, or n- or i-propylthio; represents optionally fluorine-, chlorine-, methyl-, or methoxy-substituted phenyl; or when m represents 2, optionally together with a second radical R⁵ represents ethane-1,2-diyl (dimethylene), propane-1,3-diyl (trimethylene), or butane-1,4-diyl (tetramethylene),
R⁶ represents hydroxyl or formyloxy; represents optionally cyano-, fluorine-, chlorine-, methoxy-, or ethoxy-substituted methoxy, ethoxy, n- or i-propoxy, methylthio, ethylthio, n- or i-propylthio, methylsulfinyl, ethylsulfinyl, methylsulfonyl, ethylsulfonyl, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, or n- or i-propylsulfonyloxy; represents optionally cyano-, fluorine-, chlorine-, or bromine-substituted propenyloxy, butenyloxy, propynyloxy, or butynyloxy; or represents optionally nitro-, cyano-, fluorine-, chlorine-, bromine-, methyl-, ethyl-, n- or i-propyl-, n-, i-, s-, or t-butyl-, trifluoromethyl-, methoxy-, ethoxy-, n- or i-propoxy-, difluoromethoxy-, or trifluoromethoxy-substituted phenoxy, phenylthio, phenylsulfinyl, phenylsulfonyl, benzoyloxy, benzoylmethoxy, phenylsulfonyloxy, phenylmethoxy, phenylmethylthio, phenylmethylsulfinyl, or phenylmethylsulfonyl,
R⁷ represents hydrogen, cyano, carbamoyl, thiocarbamoyl, fluorine, chlorine, or bromine; represents optionally cyano-, fluorine-, chlorine-, methoxy-, or ethoxy-substituted methyl, ethyl, n- or i-propyl, methoxy, ethoxy, n- or i-propoxy, methylthio, ethylthio, n- or i-propylthio, methylsulfinyl, ethylsulfinyl, methylsulfonyl, ethylsulfonyl, methoxycarbonyl, ethoxycarbonyl, or n- or i-propoxycarbonyl; or represents optionally cyano-, fluorine-, chlorine-, bromine-, methyl-, or ethyl-substituted cyclopropyl, cyclobutyl, cyclopentyl, or cyclohexyl,
R⁸ represents hydrogen; represents optionally cyano-, fluorine-, chlorine-, bromine-, methoxy-, or ethoxy-substituted methyl, ethyl, n- or i-propyl, or n-, i-, s-, or t-butyl; represents optionally cyano-, fluorine-, chlorine-, or bromine-substituted propenyl, butenyl, propynyl, or butynyl; represents optionally cyano-, fluorine-, chlorine-, bromine-, methyl-, or ethyl-substituted cyclopropyl, cyclobutyl, cyclopentyl, cyclohexyl, cyclopropylmethyl, cyclobutylmethyl, cyclopentylmethyl, or cyclohexylmethyl; or represents optionally nitro-, cyano-, fluorine-, chlorine-, bromine- methyl-, ethyl-, n- or i-propyl-, n-, i-, s-, or t-butyl-, trifluoromethyl-, methoxy-, ethoxy-, n- or propoxy-, difluoromethoxy-, or trifluoromethoxy-substituted phenyl or benzyl,
R⁹ represents hydroxyl or formyloxy; represents optionally cyano-, fluorine-, chlorine-, bromine-, methoxy-, ethoxy-, or n- or i-propoxy-substituted methoxy, ethoxy, n- or i-propoxy, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, or n- or i-propylsulfonyloxy; represents optionally cyano-, fluorine-, chlorine-, or bromine-substituted propenyloxy, butenyloxy, propynyloxy, or butynyloxy; or represents optionally nitro-, cyano-, fluorine-, chlorine-, bromine-, methyl-, ethyl-, n- or i-propyl-, n-, i-, s-, or t-butyl-, trifluoromethyl-, methoxy-, ethoxy-, n- or i-propoxy-, difluoromethoxy-, or trifluoromethoxy-substituted phenylmethoxy, benzoyloxy, benzoylmethoxy, or phenylsulfonyloxy,
R¹⁰ represents hydrogen, cyano, carbamoyl, thiocarbamoyl, fluorine, chlorine, or bromine; or represents optionally cyano-, fluorine-, chlorine-, bromine-, methoxy-, or ethoxy-substituted methyl, ethyl, n- or i-propyl, acetyl, propionyl, n- or i-butyroyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl, or ethylsulfonyl,
R¹¹ represents hydrogen; represents optionally cyano-, fluorine-, chlorine-, bromine-, methoxy-, or ethoxy-substituted methyl, ethyl, or n- or i-propyl; or represents optionally cyano-, fluorine-, chlorine-, bromine-, methyl-, or ethyl-substituted cyclopropyl,
R¹² represents hydrogen; represents optionally cyano-, fluorine-, chlorine-, bromine-, methoxy-, or ethoxy-substituted methyl, ethyl, or n- or i-propyl; or represents optionally cyano-, fluorine-, chlorine-, bromine-, methyl-, or ethyl-substituted cyclopropyl, and
R¹³ represents hydrogen, cyano, carbamoyl, fluorine, chlorine, or bromine; or represents optionally cyano-, fluorine-, chlorine-, bromine-, methoxy-, or ethoxy-substituted methyl, ethyl, n- or i-propyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl, or ethylsulfonyl.

17: A composition according to claim 13 wherein, for the aryl ketone of the formula (I),
A represents methylene or dimethylene,
R¹ represents one of the groups 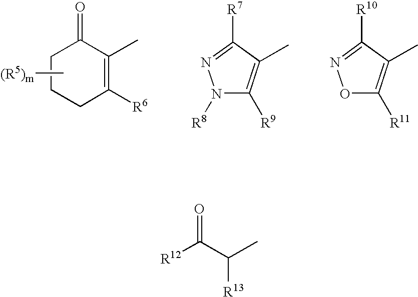
R² represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl, or dimethylaminosulfonyl,
R³ represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl, or dimethylaminosulfonyl,
R⁴ represents the heterocyclic grouping 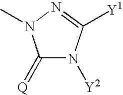
in which
Q represents oxygen or sulfur,
Y¹ represents hydrogen, chlorine, bromine, or iodine; represents optionally fluorine-, chlorine-, methoxy-, ethoxy-, n- or i-propoxy-, methylthio-, ethylthio-, methylsulfinyl-, ethylsulfinyl-, methylsulfonyl-, or ethylsulfonyl-substituted methyl, ethyl, n- or i-propyl, methoxy, ethoxy, n- or i-propoxy, methylthio, ethylthio, n- or i-propylthio, methylsulfinyl, ethylsulfinyl, n- or i-propylsulfinyl, methylsulfonyl, ethylsulfonyl, or n- or i-propylsulfonyl; represents methylamino, ethylamino, n- or i-propylamino, dimethylamino, or diethylamino; represents optionally fluorine- and/or chlorine-substituted ethenyl, propenyl, ethynyl, propynyl, propenyloxy, propenylthio, or propenylamino; represents optionally fluorine- and/or chlorine-substituted cyclopropyl, cyclopropyloxy, cyclopropylamino, cyclopropylmethyl, cyclopropylmethoxy, or cyclopropylmethylamino; or represents optionally fluorine-, chlorine-, methyl-, ethyl-, n- or i-propyl-, methoxy-, ethoxy-, or n- or i-propoxy-substituted phenyl, phenyloxy, phenylthio, phenylamino, benzyl, benzyloxy, benzylthio, or benzylamino, and
Y² represents hydrogen or amino; represents optionally fluorine- and/or chlorine-, methoxy-, or ethoxy-substituted methyl, ethyl, n- or i-propyl, methoxy, ethoxy, n- or i-propoxy, methylamino, ethylamino, or dimethylamino; represents propenyl or propynyl; represents optionally fluorine- and/or chlorine-substituted cyclopropyl, cyclobutyl, or cyclopropylmethyl; represents optionally fluorine-, chlorine-, methyl, ethyl-, n- or i-propyl-, methoxy-, ethoxy-, or n- or i-propoxy-substituted phenyl or benzyl; or together with the radical Y¹ optionally represents methyl- and/or ethyl-substituted propane-1,3-diyl (trimethylene) or butane-1,4-diyl (tetramethylene),
m represents the numbers 0, 1, or 2,
R⁵ represents optionally fluorine- or chlorine-substituted methyl, ethyl, n- or i-propyl, methoxycarbonyl, ethoxycarbonyl, methylthio, ethylthio, or n- or i-propylthio; represents phenyl; or when m represents 2, optionally together with a second radical R⁵ represents ethane-1,2-diyl (dimethylene), propane-1,3-diyl (trimethylene), or butane-1,4-diyl (tetramethylene),
R⁶ represents hydroxyl or formyloxy; represents optionally fluorine-, chlorine-, methoxy-, or ethoxy-substituted methoxy, ethoxy, n- or i-propoxy, methylthio, ethylthio, n- or i-propylthio, methylsulfinyl, ethylsulfinyl, methylsulfonyl, ethylsulfonyl, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, or n- or i-propylsulfonyloxy; represents propenyloxy or propynyloxy; or represents optionally nitro-, cyano-, fluorine-, chlorine-, bromine-, methyl-, ethyl-, n- or i-propyl-, trifluoromethyl, methoxy-, ethoxy-, n- or i-propoxy-, difluoromethoxy-, or trifluoromethoxy-substituted phenoxy, phenylthio, phenylsulfinyl, phenylsulfonyl, benzoyloxy, benzoylmethoxy, phenylsulfonyloxy, phenylmethoxy phenylmethylthio, phenylmethylsulfinyl, or phenylmethylsulfonyl,
R⁷ represents hydrogen, cyano, fluorine, chlorine, or bromine; represents optionally fluorine-, chlorine-, methoxy-, or ethoxy-substituted methyl, ethyl, n- or i-propyl, methoxy, ethoxy, n- or i-propoxy, methylthio, ethylthio, n- or i-propylthio, methylsulfinyl, ethylsulfinyl, n- or i-propylsulfinyl, methylsulfonyl, ethylsulfonyl, n- or i-propylsulfonyl, methoxycarbonyl, ethoxycarbonyl, or n- or i-propoxycarbonyl,
R⁸ represents hydrogen; represents optionally cyano-, fluorine-, chlorine-, methoxy-, or ethoxy-substituted methyl, ethyl, or n- or i-propyl; represents optionally fluorine- or chlorine-substituted propenyl or propynyl; represents optionally fluorine-, chlorine-, bromine-, methyl-, or ethyl-substituted cyclopropyl; or represents optionally fluorine-, chlorine-, bromine-, methyl-, ethyl-, n- or i-propyl-, trifluoromethyl-, methoxy-, ethoxy-, n- or i-propoxy-, difluoromethoxy-, or trifluoromethoxy-substituted phenyl or benzyl,
R⁹ represents hydroxyl or formyloxy; represents optionally cyano-, fluorine-, chlorine-, bromine-, methoxy-, ethoxy-, or n- or i-propoxy-substituted methoxy, ethoxy, n- or i-propoxy, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, or n- or i-propylsulfonyloxy; represents propenyloxy or propynyloxy; or represents optionally nitro-, cyano-, fluorine-, chlorine-, bromine-, methyl-, ethyl-, n- or i-propyl-, trifluoromethyl-, methoxy-, ethoxy-, n- or i-propoxy-, difluoromethoxy-, or trifluoromethoxy-substituted phenylmethoxy, benzoyloxy, benzoylmethoxy, or phenylsulfonyloxy,
R¹⁰ represents hydrogen, cyano, fluorine, chlorine, or bromine; or represents optionally fluorine-, chlorine-, methoxy-, ethoxy-, or n- or i-propoxy-substituted methyl, ethyl, n- or i-propyl, acetyl, propionyl, n- or i-butyroyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl, or ethylsulfonyl,
R¹¹ represents hydrogen; represents optionally fluorine-, chlorine-, bromine-, methoxy-, or ethoxy-substituted methyl, ethyl, or n- or i-propyl; or represents optionally fluorine-, chlorine-, bromine-, methyl-, or ethyl-substituted cyclopropyl,
R¹² represents hydrogen; represents optionally fluorine-, chlorine-, methoxy-, or ethoxy-substituted methyl, ethyl, or n- or i-propyl; or represents optionally fluorine-, chlorine-, bromine-, methyl-, or ethyl-substituted cyclopropyl, and
R¹³ represents hydrogen, cyano, fluorine, chlorine, or bromine; or represents optionally fluorine-, chlorine-, bromine-, methoxy-, or ethoxy-substituted methyl, ethyl, n- or i-propyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, n- or i-propylsulfinyl, methylsulfonyl, ethylsulfonyl, or n- or i-propylsulfonyl.

18: A composition according to claim 13 wherein, for the aryl ketone of the formula (I),
in which
A represents methylene or dimethylene,
R¹ represents one of the groups 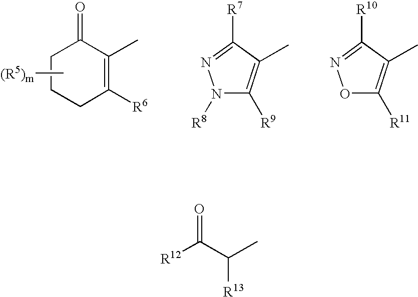
R² represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl, or dimethylaminosulfonyl,
R³ represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl, or dimethylaminosulfonyl, and
R⁴ represents the heterocyclic group 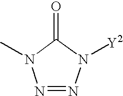
in which
Y² represents hydrogen; represents optionally fluorine- and/or chlorine-, methoxy-, or ethoxy-substituted methyl, ethyl, or n- or i-propyl; represents ethenyl, propenyl, or propynyl; represents optionally fluorine- and/or chlorine-substituted cyclopropyl, cyclobutyl, cyclopentyl, cyclohexyl, cyclopropylmethyl, cyclopentylmethyl, or cyclohexylmethyl; or represents optionally fluorine-, chlorine-, methyl-, ethyl-, n- or i-propyl-, methoxy-, ethoxy-, or n- or i-propoxy-substituted phenyl or benzyl.

19: A composition according to claim 13 wherein, for the aryl ketone of the formula (I),
in which
A represents methylene or dimethylene,
R¹ represents one of the groups 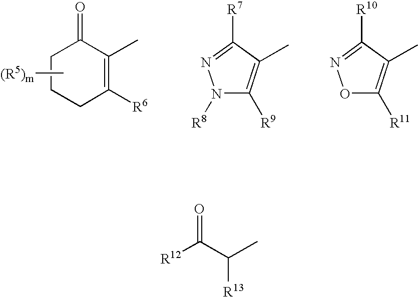
R² represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl, or dimethylaminosulfonyl,
R³ represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl, or dimethylaminosulfonyl, and
R⁴ represents the heterocyclic group 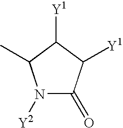
in which
Y¹ represents hydrogen or represents optionally fluorine-, chlorine-, methoxy-, or ethoxy-substituted methyl or ethyl, and
Y² represents hydrogen; represents optionally fluorine- and/or chlorine-, methoxy-, or ethoxy-substituted methyl, ethyl, or n- or i-propyl; represents propenyl or propynyl; represents optionally fluorine- and/or chlorine-substituted cyclopropyl, cyclobutyl, cyclopentyl, cyclohexyl, cyclopropylmethyl, cyclopentylmethyl, or cyclohexylmethyl; or represents optionally fluorine-, chlorine-, methyl-, ethyl-, methoxy-, or ethoxy-substituted phenyl or benzyl.

20: A composition according to claim 13 wherein, for the aryl ketone of the formula (I),
in which
A represents methylene or dimethylene,
R¹ represents one of the groups 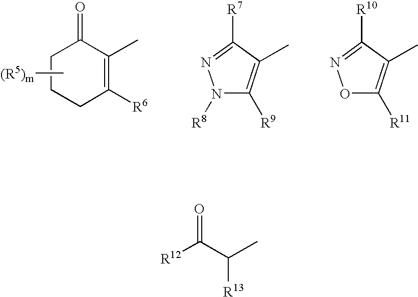
R² represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl, or dimethylaminosulfonyl,
R³ represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl, or dimethylaminosulfonyl, and
R⁴ represents one of the heterocyclic groups 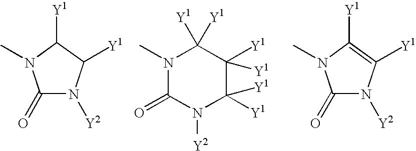
in which
Y¹ represents hydrogen, fluorine, or chlorine; represents optionally fluorine-, chlorine-, methoxy-, or ethoxy-substituted methyl or ethyl, or when two adjacent Y¹ radicals are located at a double bond, the adjacent Y¹ radicals together optionally also represent a benzo group, and
Y² represents hydrogen; represents optionally fluorine- and/or chlorine-, methoxy-, or ethoxy-substituted methyl, ethyl, or n- or i-propyl; represents propenyl or propynyl; represents optionally fluorine- and/or chlorine-substituted cyclopropyl, cyclobutyl, cyclopentyl, cyclohexyl, cyclopropylmethyl, cyclopentylmethyl, or cyclohexylmethyl; represents optionally fluorine-, chlorine-, methyl-, ethyl-, methoxy-, or ethoxy-substituted phenyl or benzyl; or together with the radical Y¹ optionally represents methyl- and/or ethyl-substituted propane-1,3-diyl (trimethylene) or butane-1,4-diyl (tetramethylene),
with the proviso that when more than one of the radicals Y¹ and Y² are attached to the same heterocyclic group, the radicals Y¹ and Y² can have identical or different meanings within the scope of the above definition,

21: A composition according to claim 13 wherein component (b) comprises at least one of the active compounds fentrazamide, flufenacet, acetochlor, alachlor, amicarbazone, amidosulfuron, anilofos, atrazin, azimsulfuron, benfuresate, bensulfuron-methyl, bentazone, benthiocarb (thiobencarb), benzobicyclon, benzofenap, bifenox, bispyribac-sodium, bromobutide, butachlor, butamifos, butenachlor, cafenstrole, carfentrazone-ethyl, chlomethoxyfen, chlornitrofen, cinmethylin, cinosulfuron, clefoxydim, clodinafop-propargyl, clomazone, clomeprop, cumyluron, cyanazine, cyclosulfamuron, cyhalofop-butyl, 2,4-D, dichlorprop-P, diethatyl-ethyl, dimepiperate, dimethametryn, dimethenamid, S-dimethenamid, dithiopyr, dymron (daimuron, dimuron), esprocarb, ethoxysulfuron, etobenzanid, fenoxaprop-(P)-ethyl, fluazifop-P-butyl, flucarbazone-sodium, flumetsulam, halosulfuron-methyl, haloxyfop-P-methyl, HOK-201, imazamox, imazaquin, imazethapyr, imazosulfuron, indanofan, isoxaflutole, MCPA, mefenacet, mesosulfuron, mesotrione, metolachlor, S-metolachlor, metosulam, metsulfuron-methyl, metribuzin, molinate, naproanilide, nicosulfuron, OK-701, oxadiargyl, oxadiazon, oxaziclomefone, oxyfluorfen, pendimethalin, pentoxazone, piperophos, pretilachlor, profoxydim, propanil, propoxycarbazone-sodium, pyraclonil, pyrazolate, pyrazosulfuron-ethyl, pyrazoxyfen, pyribenzoxim, pyributicarb, pyriftalid, pyriminobac-methyl, qinclorac, quinoclamine, simazin, simetryn, sulcotrione, terbuthylazine, thenylchlor, thifensulfuron-methyl, tiocarbazil, or tritosulfuron.

22: A composition according to claim 13 wherein component (c) comprises at least one of the compounds 5-chloro-quinoxalin-8-oxy-acetic acid (1-methyl-hexyl ester) (cloquintocet-mexyl), ethyl 4,5-dihydro-5,5-diphenyl-3-isoxazolecarboxylate (isoxadifen-ethyl) and diethyl-1-(2,4-dichloro-phenyl)-4,5-dihydro-5-methyl-1H-pyrazole-3,5-dicarboxylate (mefenpyr-diethyl), particularly suitable for improving compatibility in cereals, and also 4-dichloroacetyl-1-oxa-4-aza-spiro[4,5]-decane (AD-67), 1-dichloroacetyl-hexahydro-3,3,8a-trimethylpyrrolo[1,2-a]-pyrimidin-6(2H)-one (BAS-145138), 4-dichloroacetyl-3,4-dihydro-3-methyl-2H-1,4-benzoxazine (benoxacor), 2,2-dichloro-N,N-di-2-propenyl-acetamide (dichlormid), 3-dichloroacetyl-5-(2-furanyl)-2,2-dimethyl-oxazolidine (furilazole, MON-13900), 3-dichloroacetyl-2,2,5-trimethyl-oxazolidine (R-29148), and 2,4-D, NCPA, or mecoprop.

23: A method for controlling weeds comprising allowing an effective amount of a composition according to claim 13 to act on one or more undesirable plants and/or their habitat.

24: A process for preparing a herbicidal composition comprising mixing a composition according to claims 13 with one or more surfactants and/or extenders.
